(19) United States
(12) Patent Application Publication
(10) Pub. No.: US 2010/0058220 A1
(43) Pub. Date: Mar. 4, 2010

(54) SYSTEMS, METHODS, AND COMPUTER PROGRAM PRODUCTS FOR THE CREATION, MONETIZATION, DISTRIBUTION, AND CONSUMPTION OF METACONTENT

(76) Inventor: Carl E. Carpenter, Ventura, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/374,235

(22) PCT Filed: May 30, 2007
(86) PCT No.: PCT/US07/12770

§ 371 Date: Nov. 11, 2009

Related U.S. Application Data
(60) Provisional application No. 60/831,860, filed on Jul. 17, 2006.
(60) Provisional application No. 60/844,905, filed on Sep. 16, 2006.

(30) Foreign Application Priority Data
Nov. 29, 2006 (US) PCT/US06/45705

(51) Int. Cl. G06F 3/048

(52) U.S. Cl. 715/772

(57) ABSTRACT

Systems, methods, and computer program products for the creation, distribution, and consumption of metacontent are disclosed. An exemplary metacontent show comprises a playing span, a metacontent track within the playing span, and one or more identifiers to one or more corresponding items of network-accessible information being associated with, or embedded within, the metacontent track. The metacontent track comprises at least one of an audio track, a video track, or both, and can take the form of an audiovisual report narrated by an expert guide. The items of network-accessible information can comprise blog postings, online news articles, other types of Webpages accessible over the Internet or similar network, and even components of other metacontent shows. The identifiers facilitate access to their corresponding items of network-accessible information over the Internet or other network, and can comprise uniform resource locators (URLs), uniform resource identifiers (URIs), and/or identifiers.

### CROSS-REFERENCE TO RELATED APPLICATIONS

This application claims priority from PCT application International Application Number PCT/US2007/012770 filed May 30, 2007, PCT application International Application Number PCT/US2006/045705 filed Nov. 29, 2006, U.S. Provisional Patent Application Ser. No. 60/740,147 filed Nov. 29, 2005; U.S. Provisional Patent Application Ser. No. 60/831,860 filed Jul. 17, 2006; and U.S. Provisional Patent Application Ser. No. 60/844,905 filed Sep. 16, 2006, each of which is hereby incorporated herein by reference in the respective entirety of each.

### FIELD OF THE INVENTIONS

The present inventions relate to the creation, distribution, and consumption of metacontent.

### BACKGROUND OF THE INVENTIONS

Prior to the widespread use of the Internet, most people got their news information from television news broadcasts, radio broadcasts, and print media, such as newspapers and news magazines. Today, many people still receive the bulk of their news content from these traditional sources. Unfortunately, these sources tailor their content for mass consumption, and often limit the ability of news consumers to receive news information on matters they are particularly concerned about, or to receive more detailed information than that which is provided by the traditional sources.

As a reaction to such a one-size-fits-all approach to news dissemination, web-logs (or “blogs”) have risen up as competition to traditional news sources. Individuals (sometimes referred to as “bloggers”) write brief news stories about their respective areas of expertise and include links to relevant content on the World Wide Web (often referred to simply as the “Web”).

Some news aggregation tools have come about to assist news consumers in gathering information of interest. Many blogs are published in a Really Simple Syndication (RSS) format, and there are RSS aggregators available to display headlines and allow browsing of individual blog posts by users. When used by typical users, these news aggregation tools have resulted in the collection of a huge amount of posts and news articles, which tend to overwhelm the typical user. At best, this leaves the typical user with the feeling that he or she has not grasped the true overview of the news of the day, and at worst, it discourages the typical user from seeking out news in this manner.

### SUMMARY OF THE INVENTIONS

As part of making his inventions, the inventor has realized that the above-described typical news consumers and other information consumers need to view their information content in a higher form that maintains an overview perspective of the content while providing dense detail as well, and that there need to be methods, systems, and computer program products that enable the creation, distribution, and consumption of this higher form of information content. Also as part of making his inventions, the inventor has realized that there are individual information consumers who follow respective niches of news and information and who could provide expert guidance to non-expert information consumers on the important news and events in their respective niches for the current time. Moreover, these expert individuals could also explain to non-experts how the current news and events fit into the overall context of the niche's subject area, and give non-experts an overview perspective. However, they are not aware of the needs of the non-expert consumers, and are not aware that they can be of great help to non-experts. Moreover, these potential expert guides have no way to package and distribute their expertise. Thus, also as part of making his inventions, the inventor seeks to tap into the expertise of these potential expert guides to build a higher form of news content, richer and more dense than that which is currently available, with meaningful context and overview, to provide non-expert information consumers with the custom information content that they seek, but without overwhelming them. In addition, the inventor has recognized that the development of the higher content form and the related inventions described below, will enable regular citizens to become citizen journalists reporting on local matters, as well as specialized topics of national and global interest.

One embodiment of the higher form of information content according to the present application is the metacontent show, with “metacontent” meaning “content about content.”The metacontent show comprises a playing span, a metacontent track within the playing span, and one or more identifiers to one or more corresponding items of network-accessible information being associated with, or embedded within, the metacontent track. The metacontent track comprises at least one of an audio track, a video track, or both, and can take the form of an audiovisual report narrated by an expert guide. The items of network-accessible information can comprise blog postings, online news articles, other types of web pages accessible over the Internet or similar network, and even components of other metacontent shows. The identifiers facilitate access to their corresponding items of network-accessible information over the Internet or other network, and can comprise uniform resource locators (URLs), uniform resource identifiers (URIs), and/or identifiers (e.g., parameters) that can be used to access the information in a database attached to a network-accessible server. A metacontent show is preferably presented to a user (e.g., news consumer) with the metacontent track being displayed in a first pane of a video screen, and the contents of the show's items of network-accessible information being displayed to the user in a second pane of the video screen, with the contents of each item being displayed at a corresponding location in the playing span of the show's metacontent track. In this manner, the show's items are presented in a juxtaposed and synchronized manner with the metacontent track, and referred to herein as synchronized links, abbreviated as “sync-links.” With this higher form of information content, an expert guide in a particular information subject area (e.g., news niche) can use the metacontent show to provide a narrated guide of items on recent news, events, articles, websites, blog postings, etc. for non-expert users to view, with the contents of each item being displayed to the non-expert users in brows-able form as it is being discussed by the expert guide. This enables the non-expert user to get a current, expert overview of the subject area, while allowing the non-expert user to pause the narration of the metacontent track and “drill down” on specific areas by activating hyperlinks in the item's contents, leading the user to yet deeper content. This provides the user with an intelligent browsing experience. While the metacontent show has been illustrated with these uses, it may be appreciated that the metacontent show may be used for other uses and applications.

Another invention of the present application seeks to unleash the capabilities of potential expert guides to create and make available metacontent shows to non-expert users, so that non-expert users can obtain meaningful overviews of the news in areas of particular interest in an efficient and organized manner, while enabling them to pursue specific aspects more deeply when desired. Broadly stated, this invention encompasses methods and systems that enable the creation and distribution of metacontent made by a plurality of producers (e.g., expert guides) to a plurality of consumers (e.g., non-expert users). An exemplary method comprises providing access to a website where producers can post metacontent shows, and providing an organization structure of subjects (e.g., topics) and sub-subjects (e.g., subtopics) by which metacontent shows can be posted by producers. The exemplary method further comprises providing the consumers with access to the metacontent shows where the organization structure of subjects and sub-subjects can be viewed in a first pane of a video screen, where the metacontent track of a selected show is presented in a second pane of the video screen, and where each show's item of network-accessible information is presented in a third pane of the video screen when the playing time of the show's metacontent track is at or within the corresponding temporal location of the item. Further exemplary methods of this invention further comprise providing producers with the ability to create webpages on which they can aggregate items and other information, and to refer to these webpages as items in their metacontent shows. Yet further exemplary methods of this invention further comprise presenting metacontent advertisements to the consumers, collecting revenues from the presentation of the advertisements, and distributing portions of the revenues to the producers.

An exemplary system of this invention comprises a database adapted to store metacontent shows in an organized structure of subjects and sub-subjects, a first network-accessible server adapted to receive metacontent shows from a plurality of producers, and a second network-accessible server adapted to make the database's metacontent shows accessible to the consumers with the organization structure of subjects and sub-subjects being viewable in a first pane of a video screen. The metacontent track of a selected show is viewable in a second pane of the video screen, and each show's item of network-accessible information is viewable in a third pane of the video screen when the playing time of the show's metacontent track is at or within the corresponding temporal location of the item. The first and second servers may be the same. Further exemplary systems of this invention further comprise components that enable producers to create webpages on which they can aggregate items and other information, which they can refer to as items in their metacontent shows. Yet further exemplary systems of this invention further comprise components adapted to present advertisements to the consumers, adapted to collect revenues from the presentation of the metacontent advertisements, and adapted to compute the portions of revenues to be distributed to the producers.

In the above inventions and embodiments, the first, second, and third panes may be displayed separately from one another on the video screen, or one or more panes may overlay portions of other panes, where each overlaying pane may have a selected degree of translucency from transparent to completely opaque. The panes may also be programmatically moved relative to one another during the playing of a metacontent track (that is to say, program data may be included with the metacontent show and/or metacontent track that indicates the size, screen position, relative layer position, and translucency of the panes, and the panes may be displayed according to this data). For example, the pane displaying the metacontent track may overlay a portion of the pane showing the network-accessible content with a selected degree of translucency, and may move over the latter pane during the playing of the metacontent track. In addition to programmatic movement of the panes, the user may also move the panes, change their layer position, change their size, and/or change their translucency.

Yet another invention of the present application provides a Metabrowser that can be used by users (e.g., information consumers) to view metacontent shows. The Metabrowser comprises a plurality of software elements, which can be implemented in a variety of forms, and embodied in a variety of computer readable media, including streams of data bytes conveyed over the Internet or other network (e.g., all types of signals and carrier waves). An exemplary embodiment of a metabrowser comprises the following elements: a directory pane, a head pane, and a content pane. The directory pane is adapted to display a plurality of subjects having a plurality of metacontent shows from which the user may select for presentation, and to receive a selection by the user of a metacontent show to view. The head pane is adapted to present the audio and/or video components a selected metacontent show to the user. The content pane is adapted to present to the user the contents of the show's corresponding one or more items of network-accessible information, with the contents of each item being presented when the playing time of the show is at or within the corresponding temporal location of the item. Further embodiments of the Metabrowser comprise further features that provide for further functionality, and are more fully described below.

The head pane, content pane, and directory pane may be displayed separately from one another on the video screen, or one or more panes may overlay portions of other panes, where each overlaying pane may have a selected degree of translucency from transparent to completely opaque. The panes may also be moved relative to one another during the playing of a metacontent track. For example, the head pane may initially overlay a portion of the content pane with a selected degree of translucency, and may then move over other portions of the content pane during the playing of the metacontent track. This enables a metacontent show to provide a seamless visual integration of the head and content panes, and enables a spokesperson in the head pane to move about the content pane to point out aspects of the contents currently displayed in the content pane. As a further example to this, the directory pane may have its subjects and sub-subjects displayed in icon or pictorial form, and may be hidden or partially hidden, located below the content pane or to one side of the content pane.

Yet another invention of the present application provides a Metaproducer that can be used by users (e.g., expert guides, content producers) to create metacontent shows. The Metaproducer comprises a plurality of software elements, which can be implemented in a variety of forms, and embodied in a variety of computer readable media, including streams of data bytes conveyed over the Internet or other network (e.g., all types of signals and carrier waves). An exemplary embodiment of a Metaproducer comprises the following elements: an aggregation pane, a head pane, a content pane, and a plurality of interface controls described below that enable the user to create a new metacontent show and to upload it to a server for viewing by other users. The aggregation pane is adapted to display a plurality of subjects to which the user can post new metacontent shows. These subjects are maintained by a server that is accessible over a network (e.g., Internet) by the user and other users. The head pane is adapted to present the metacontent track associated with the new metacontent show, and the content pane adapted to present the contents of items of network-accessible information. A first interface control, typically associated with the aggregation pane, is adapted to receive user input to add a new metacontent show to a selected subject. A second interface control is adapted to receive user input to associate a textual description (e.g., title) to a new metacontent show, and a third interface control is adapted to receive user input to associate a metacontent track to the new metacontent show. The metacontent track may be uploaded to a database server at this point, or uploaded in a later step. This metacontent track may be produced by the user using his or her own production tools, or tools built into further embodiments of the Metaproducer. A fourth interface control is adapted to receive user input to associate one or more items of network-accessible information with the metacontent track of the new metacontent show. To facilitate the synchronization of the presentation of the items with the metacontent track, an exemplary Metaproducer further comprises an interface control adapted to receive user input to associate a selected item of network-accessible information with a selected location in the metacontent track. The association preferably includes an identifier for each item that facilitates access to the contents of the item over a network. At this point, the created metacontent show may be uploaded to a database server. In further preferred embodiments of the Metaproducer, the aggregation pane is adapted to display a plurality of syndication feeds, each syndication feed comprising a plurality of posts, and each post comprising a textual description and an identifier that facilitates access to the contents of the post over a network. In addition, in these further embodiments, the content pane is further adapted to present the contents of selected posts. These features increase the efficiency of users to locate the content they want aggregated into their metacontent shows. Further preferred embodiments of the Metaproducer comprise further features that provide for further functionality, and are more fully described below.

The head pane, content pane, and aggregation pane may be displayed separately from one another on the video screen, or one or more panes may overlay portions of other panes, where each overlaying pane may have a selected degree of translucency from transparent to completely opaque. The panes may also move or be moved relative to one another during the playing of a metacontent track. During the playing of a metacontent show, the panes may be programmatically moved relative to one another, and may have their size, relative layer position, and translucency programmatically changed. In addition to programmatic movement of the panes, the user may also move the panes, change their layer position, change their size, and/or change their translucency.

The above methods, systems, and browsers enable users to consume metacontent shows, which is to say, to have the intelligent browsing user experience, as well as to create metacontent shows. The aggregate of all metacontent shows, when considered as a whole which can be accessed only by the metabrowser, thereby constitutes an emergent meta-Web, or Metaweb, a directory level situated above the existing Web, from which Web content can be organized and arranged for more meaningful consumption, within a broader context defined by the metacontent track, the subjects and sub-subjects containing the metacontent shows being displayed in the directory pane of the metabrowser. The present inventions can be made available to users on a number of platforms including, but not limited to the Web accessed by personal computer, the Web accessed by television (Internet TV), wireless mobile, and IPTV.

### Embodiment 1

A Metabrowser for presenting metacontent to a user, the metabrowser comprising:

a first instruction set embodied on a computer-readable medium adapted to direct a data processor to present a directory pane on a video screen, the directory pane adapted to display a plurality of subjects having a plurality of metacontent shows from which the user may select for presentation, and to receive a selection by the user of a metacontent show to view, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, each identifier facilitating access to its corresponding item of network-accessible information;

a second instruction set embodied on the computer-readable medium adapted to direct a data processor to present a head pane on the video screen, the head pane adapted to present the metacontent track of a selected metacontent show to the user; and

a third instruction set embodied on the computer-readable medium adapted to direct a data processor to present a content pane on the video screen, the content pane adapted to present to the user the contents of the metacontent show's corresponding one or more items of network-accessible information, the contents of each item being presented when the playing time of the show's metacontent track is at or within the corresponding location of the item; and

wherein one of the above instruction sets is further adapted to direct the data processor to overlay at least a portion of one of the panes over at least a portion of one of the other panes.

### Embodiment 2

The Metabrowser of Embodiment 1 wherein the second instruction set is further adapted to direct the data processor to overlay at least a portion of the head pane over at least a portion of one of the other panes.

### Embodiment 3

The Metabrowser of Embodiment 1 further comprising an instruction set adapted to direct the data processor to change at least one characteristic of at least one pane, a characteristic being one of the position of the pane, the size of the pane, the layer level of the pane relative to other panes, and the translucency of the pane.

### Embodiment 4

The Metabrowser of Embodiment 1 wherein the metacontent show further comprises a set of event commands for configuring characteristics of one or more identified panes during the playing of the show's metacontent track, at least one event command specifying at least one of the position, size, overlay layer level, and translucency of a selected pane, wherein the product further comprises:

a fourth instruction set adapted to direct the data processor to read an event command of the metacontent show and to configure the characteristics of the pane identified by an event command according to the characteristics specified by the event command.

### Embodiment 5

The Metabrowser of Embodiment 4 wherein said fourth instruction set includes:

an instruction set adapted to direct the data processor to create a timer event for sending a message to the pane identified by the event command, wherein the timer event is set to expire at a fixed time duration from its creation, and wherein the time duration is related to the difference between the time point when the event command is to be effected and the time point when the timer event is created, both time points being related to the playing time of the metacontent track;

an instruction set adapted to direct the data processor to send a message to the pane identified by the event command when the timer event expires, the message conveying the configurations of the characteristics provided in the event command.

### Embodiment 6

The Metabrowser of Embodiment 1 wherein the metacontent show further comprises a set of event commands for configuring characteristics of one or more panes during the playing of the show's metacontent track, at least one event command specifying that the metacontent track be paused for a time duration, wherein the product further comprises:

a fourth instruction set adapted to direct the data processor to read an event command of the metacontent show and to pause the playing of the metacontent track of the pane identified by an event command that specifies such a pausing action.

### Embodiment 7

The Metabrowser of Embodiment 6 wherein the at least one event command includes a software object for restarting the paused metacontent track, and wherein the fourth instruction set is further adapted to direct the data processor to execute the software object.

### Embodiment 8

The Metabrowser of Embodiment 1 wherein the metacontent show further comprises a set of event commands for configuring characteristics of one or more panes during the playing of the show's metacontent track, at least one event command specifying that an overlay pane be displayed, the event command including an object providing the contents of the overlay pane, wherein the product further comprises:

a fourth instruction set adapted to direct the data processor to read an event command of the metacontent show and to display an overlay pane when the event command is a command to display an overlay pane, the data processor using the object of the event command for the displayed contents of the overlay pane.

### Embodiment 9

The Metabrowser of Embodiment 8 wherein the at least one event command includes a software object for terminating the display of the overlay pane, and wherein the fourth instruction set is further adapted to direct the data processor to execute the software object.

### Embodiment 10

The Metabrowser of Embodiment 1 further comprising an instruction set adapted to direct the data processor to provide a data object for a focus node in the directory pane, and to receive user input to establish a subscription under the focus node to a particular subject or sub-subject.

### Embodiment 11

The Metabrowser of Embodiment 10 further comprising an instruction set adapted to direct the data processor to receive a user input requesting the presentation of the latest metacontent shows of the focus node, to request and receive one or more listings from one or more databases of new metacontent shows within a preset period of time for subjects and sub-subjects established under the focus node, and to display the one or more listings under the focus node in the directory pane.

### Embodiment 12

The Metabrowser of Embodiment 10 further comprising an instruction set adapted to direct the data processor to present the user with the option of establishing an interest level for a subscription, and to transmit the interest level to the one or more databases.

### Embodiment 13

The Metabrowser of Embodiment 1 further comprising a fourth instruction set adapted to direct the data processor to monitor the playing time of the metacontent track in the head pane, and to load the item identified by each item identifier when the playing time of the metacontent track is at or within the location for the item, or a preset time duration beforehand.

### Embodiment 14

The Metabrowser of Embodiment 1 further comprising a fourth instruction set adapted to direct the data processor to decode the sync-clicks stream from the metacontent track for item and location identifiers to items of network-accessible information, and to load the item identified by each item identifier, the loading being done substantially at the time indicated by the location identifier, or a preset time duration beforehand.

### Embodiment 15

The Metabrowser of Embodiment 1 further comprising at least one of the following instruction sets:

an instruction set adapted to direct the data processor to detect key-frame trigger events for the item identifiers from the metacontent track, and to load the item identified by each item identifier, the loading being done substantially when the trigger event occurs;

an instruction set adapted to direct the data processor to compare the audio track for a match to one or more previously digitized samples of the audio track, each previously digitized sample being provided as a location indictor and being associated with a corresponding item identifier, and when a match to a digitized sample is found, to load the item identified by the corresponding item identifier;

an instruction set adapted to direct the data processor to compare the audio track for a match to one or more amplitude envelopes previously made from the audio track, each amplitude envelope being provided as a location indictor and being associated with a corresponding item identifier, and when a match to a amplitude envelope is found to load the item identified by the corresponding item identifier;

an instruction set adapted to direct the data processor to process the audio track through a voice-recognition engine that generates a stream of text words representative of the narrative words spoken in the audio track, to compare the stream of text words for a match to one or more phrases previously associated with corresponding item identifiers, each phrase being provided as a location indictor, and when a match to a phrase is found to load the item identified by the corresponding item identifier;

an instruction set adapted to direct the data processor to compare the audio track for a match to one or more preset durations of sound tones or silence, each such duration being previously associated with corresponding item identifiers, and when a match to a preset duration is found to load the item identified by the corresponding item identifier.

### Embodiment 16

The Metabrowser of Embodiment 1 further comprising at least one of the following instruction sets:

an instruction set adapted to direct the data processor to detect a click in the content pane, and in response to pause the playing of the metacontent track in the head pane;

an instruction set adapted to direct the data processor to detect an activation of a hyperlink in the content pane, and in response to pause the playing of the metacontent track in the head pane; and

an instruction set adapted to direct the data processor to detect an entry of a new URL in the address box of the content pane, and in response to pause the playing of the metacontent track in the head pane.

### Embodiment 17

The Metabrowser of Embodiment 16 further comprising an instruction set adapted to direct the data processor to detect the clicking of a play button associated with the head pane, and in response, to load, into the content pane, the contents of the item that is to be presented during the current playing time of the metacontent track.

### Embodiment 18

A computer program product to view metacontent shows and to be executed by an Internet Browser being run by a data processor, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, the product comprising the following elements embodied on a computer-readable medium:

(a) an instruction set adapted to direct the data processor to allocate a screen area for a head pane, content pane, and a directory pane, with the Internet browser passing user input in this area to the program product to handle;

(b) an instruction set adapted to direct the data processor to start an instance of a media player to handle the head pane;

(c) a data object holding a directory listing of metacontent shows or an instruction set adapted to direct a data processor to request and receive a directory listing of metacontent shows from one or more network-accessible database servers;

(d) an instruction set adapted to direct the data processor to display the listing in the screen area for directory pane;

(e) an instruction set adapted to direct the data processor to receive user input to play a selected metacontent show, to access a database to obtain a data object for the selected metacontent show, and to direct the media player handling the head pane to access the file for the show's metacontent track and to start playing the track;

(f) an instruction set adapted to direct the data processor to display each of the selected show's items in the content pane at the item's corresponding location in the playing span of the metacontent track; and

(g) an instruction set adapted to direct the data processor to overlay at least a portion of one of the panes over at least a portion of one of the other panes.

### Embodiment 19

The product of Embodiment 18 wherein the data processor is directed to overlay at least a portion of the head pane over at least a portion of one of the other panes.

### Embodiment 20

The product of Embodiment 18 further comprising an instruction set adapted to direct the data processor to change at least one characteristic of at least one pane, a characteristic being one of the position of the pane, the size of the pane, the layer level of the pane relative to other panes, and the translucency of the pane.

### Embodiment 21

The product of Embodiment 18 wherein the metacontent show further comprises a set of event commands for configuring characteristics of one or more identified panes during the playing of the show's metacontent track, at least one event command specifying at least one of the position, size, overlay layer level, and translucency of a selected pane, wherein the product further comprises:

(h) an instruction set adapted to direct the data processor to read an event command of the metacontent show and to configure the characteristics of the pane identified by an event command according to the characteristics specified by the event command.

### Embodiment 22

The product of Embodiment 21 wherein said instruction set (h) includes:

an instruction set adapted to direct the data processor to create a timer event for sending a message to the pane identified by event command, wherein the timer event is set to expire at a fixed time duration from its creation, and wherein the time duration is related to the difference between the time point when event command is to be effected and the time point when the timer event is created, both time points being related to the playing time of the metacontent track;

an instruction set adapted to direct the data processor to send a message to the pane identified by the event command when the timer event expires, the message conveying the configurations of the characteristics provided in the event command.

### Embodiment 23

The product of Embodiment 18 wherein the metacontent show further comprises a set of event commands for configuring characteristics of one or more panes during the playing of the show's metacontent track, at least one event command specifying that the metacontent track be paused for a time duration, wherein the product further comprises:

(h) an instruction set adapted to direct the data processor to read an event command of the metacontent show and to pause the playing of the metacontent track of the pane identified by an event command that specifies such a pausing action.

### Embodiment 24

The product of Embodiment 23 wherein the at least one event command includes a software object for restarting the paused metacontent track, and wherein instruction set (h) is further adapted to direct the data processor to execute the software object.

### Embodiment 25

The product of Embodiment 18 wherein the metacontent show further comprises a set of event commands for configuring characteristics of one or more panes during the playing of the show's metacontent track, at least one event command specifying that an overlay pane be displayed, the event command including an object providing the contents of the overlay pane, wherein the product further comprises:

(h) an instruction set adapted to direct the data processor to read an event command of the metacontent show and to display an overlay pane when the event command is a command to display an overlay pane, the data processor using the object of the event command for the displayed contents of the overlay pane.

### Embodiment 26

The product of Embodiment 25 wherein the at least one event command includes a software object for terminating the display of the overlay pane, and wherein instruction set (h) is further adapted to direct the data processor to execute the software object.

### Embodiment 26A

The product of Embodiment 18 further comprising an instruction set adapted to direct the data processor to receive user input to display a selected subject node in the content pane and to display the contents of the selected subject node in the content pane.

### Embodiment 26B

The product of Embodiment 18 further comprising an instruction set adapted to direct the data processor to receive a user input requesting the latest metacontent shows for a selected subject or sub-subject, to request and receive one or more listings from one or more databases of new metacontent shows within a preset period of time for the selected subjects or sub-subjects, and to display the one or more listings under the selected subjects or sub-subjects in the directory pane.

### Embodiment 27

The product of Embodiment 18 further comprising an instruction set adapted to direct the data processor to provide a data object for a focus node in the directory pane, and to receive user input to establish a subscription under the focus node to a particular subject or sub-subject.

### Embodiment 28

The product of Embodiment 27 further comprising an instruction set adapted to direct the data processor to receive a user input requesting the presentation of the latest metacontent shows of the focus node, to request and receive one or more listings from one or more databases of new metacontent shows within a preset period of time for subjects and sub-subjects established under the focus node, and to display the one or more listings under the focus node in the directory pane.

### Embodiment 29

The product of Embodiment 27 further comprising an instruction set adapted to direct the data processor to present the user with the option of establishing an interest level for a subscription, and to transmit the interest level to the one or more databases.

### Embodiment 30

The product of Embodiment 18 wherein the element (f) of the instruction set adapted to direct the data processor to display each of the selected show's items in the content pane at the item's corresponding location in the playing span of the metacontent track comprises:

an instruction set adapted to direct the data processor to monitor the playing time of the metacontent track in the head pane, and to load the item identified by each item identifier when the playing time of the metacontent track is at or within the location for the item, or a preset time duration beforehand.

### Embodiment 31

The product of Embodiment 18 wherein the element (f) of the instruction set adapted to direct the data processor to display each of the selected show's items in the content pane at the item's corresponding location in the playing span of the metacontent track comprises:

an instruction set adapted to direct the data processor to obtain the current playing time of the metacontent track in the head pane, to compute a time duration between the time point when a selected item is to be displayed and the obtained current playing time, and to load the selected item when the computed time duration has elapsed, or a preset time duration beforehand.

### Embodiment 32

The product of Embodiment 18 wherein the element (f) of the instruction set adapted to direct the data processor to display each of the selected show's items in the content pane at the item's corresponding location in the playing span of the metacontent track comprises:

an instruction set adapted to direct the data processor to decode the sync-clicks stream from the metacontent track for item and location identifiers to items of network-accessible information, and to load the item identified by each item identifier at the time indicated by the location identifier, or a preset time duration beforehand.

### Embodiment 33

The product of Embodiment 18 wherein the element (f) of the instruction set is adapted to direct the data processor to display each of the selected show's items in the content pane at the item's corresponding location in the playing span of the metacontent track comprises at least one of the following instruction sets:

an instruction set adapted to direct the data processor to detect key-frame trigger events for the item identifiers from the metacontent track, and to load the item identified by each item identifier;

an instruction set adapted to direct the data processor to compare the audio track for a match to one or more previously digitized samples of the audio track, each previously digitized sample being provided as a location indictor and being associated with a corresponding item identifier, and when a match to a digitized sample is found, to load the item identified by the corresponding item identifier;

an instruction set adapted to direct the data processor to compare the audio track for a match to one or more amplitude envelopes previously made from the audio track, each amplitude envelope being provided as a location indictor and being associated with a corresponding item identifier, and when a match to a amplitude envelope is found to load the item identified by the corresponding item identifier;

an instruction set adapted to direct the data processor to process the audio track through a voice-recognition engine that generates a stream of text words representative of the narrative words spoken in the audio track, to compare the stream of text words for a match to one or more phrases previously associated with corresponding item identifiers, each phrase being provided as a location indictor, and when a match to a phrase is found to load the item identified by the corresponding item identifier;

an instruction set adapted to direct the data processor to compare the audio track for a match to one or more preset durations of sound tones or silence, each such duration being previously associated with corresponding item identifiers, and when a match to a preset duration is found to load the item identified by the corresponding item identifier.

### Embodiment 34

The product of Embodiment 18 further comprising at least one of the following instruction sets:

an instruction set adapted to direct the data processor to detect a click in the content pane, and in response to pause the playing of the metacontent track in the head pane;

an instruction set adapted to direct the data processor to detect an activation of a hyperlink in the content pane, and in response to pause the playing of the metacontent track in the head pane; and

an instruction set adapted to direct the data processor to detect an entry of a new URL in the address box of the content pane, and in response to pause the playing of the metacontent track in the head pane.

### Embodiment 35

The product of Embodiment 34 further comprising an instruction set adapted to the direct the data processor to detect the clicking of a play button associated with the head pane, and in response, to load, into the content pane, the contents of the item that is to be presented during the current playing time of the metacontent track.

### Embodiment 36

A method of presenting metacontent to a user, the method comprising:

(a) presenting to the user a plurality of subjects each having a plurality of metacontent shows from which the user may select for presentation, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information;

(b) receiving a request from the user to select a metacontent show for presentation;

(c) presenting to the user the metacontent track of the selected metacontent show in a head pane disposed in an area of a video screen; and

(d) presenting to the user the contents of the metacontent show's corresponding one or more items of network-accessible information in a content pane disposed in an area of the video screen, the contents of each item being presented when the playing time of the show's metacontent track is at or within the corresponding location of the item; and

wherein at least one of steps (c)-(d) overlays at least a portion of its pane over at least a portion of the other pane.

### Embodiment 37

The method of Embodiment 36 wherein at least a portion of the head pane overlays at least a portion of one of the other panes.

### Embodiment 38

The method of Embodiment 36 wherein to at least one characteristic of at least one pane is changed during the presentation of a metacontent show, a characteristic being one of the position of the pane, the size of the pane, the layer level of the pane relative to other panes, and the translucency of the pane.

### Embodiment 39

The method of Embodiment 36 further comprising displaying an overlay pane during a metacontent show for a period of time.

### Embodiment 40

The method of Embodiment 36 further comprising displaying a representation of the contents of a selected subject in the content pane in response to a user input.

### Embodiment 41

The method of Embodiment 36 wherein a plurality of subjects are updated to include new metacontent shows, and wherein step (a) includes the step of presenting the metacontent shows of a selected subject with the newest shows shown first.

### Embodiment 42

The method of Embodiment 36 wherein each of a plurality of subjects has one or more sub-subjects, wherein each sub-subject is adapted to store shows and further sub-subjects, and wherein step (a) includes the step of presenting the user the option to view the shows and sub-subjects of a selected subject or sub-subject and presenting the shows and sub-subjects of a selected subject or a selected sub-subject.

### Embodiment 43

The Method Embodiment 36 further comprising at least one of the following steps:

pausing the playing of the metacontent track in the head pane in response to a click of the mouse in the content pane;

pausing the playing of the metacontent track in the head pane in response to an activation of a hyperlink in the content pane;

pausing the playing of the metacontent track in the head pane in response to an entry of a new URL in an address box of the content pane.

### Embodiment 44

The Metabrowser of Embodiment 43 further comprising reloading into the content pane the item that is to be presented during the current playing time of the metacontent track when a play button associated with the head pane is clicked.

### Embodiment 45

The method of Embodiment 36 further comprising providing the user with the ability to rate a metacontent show and to transmit the rating to a server.

### Embodiment 46

A computer program product to be installed in a computer for controlling the computer to perform the process of presenting metacontent to a user, the process comprising:

(a) presenting a directory pane on a video screen, the directory pane adapted to display a plurality of subjects having a plurality of metacontent shows from which the user may select for presentation, and to receive a selection by the user of a metacontent show to view, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, each identifier facilitating access to its corresponding item of network-accessible information;

(b) presenting a head pane on the video screen, the head pane adapted to present the metacontent track of a selected metacontent show to the user; and

(c) presenting a content pane on the video screen, the content pane adapted to present to the user the contents of the metacontent show's corresponding one or more items of network-accessible information, the contents of each item being presented when the playing time of the show's metacontent track is at or within the corresponding location of the item; and

(d) overlaying at least a portion of its pane over at least a portion of one of the other panes.

### Embodiment 47

A computer program product to be installed in an Internet browser running on a computer for controlling the computer to perform the process of presenting metacontent shows to a user, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, the process comprising:

(a) directing the Internet browser to allocate a screen area for a head pane and a directory pane, with the Internet browser passing user input in this area to the program product to handle;

(b) directing the data processor to start an instance of a media player to handle the head pane;

(c) providing a data object holding a directory listing of metacontent shows or directing the data processor to request and receive a directory listing of metacontent shows from one or more network-accessible database servers;

(d) displaying the listing in the screen area for directory pane;

(e) receiving user input to play a selected metacontent show, accessing a database to obtain a data object for the selected metacontent show, sending a message to the media player handling the head pane instructing it to access the file for the show's metacontent track and start playing the track;

(f) displaying each of the selected show's items in the content pane at the item's corresponding location in the playing span of the metacontent track; and

(g) overlaying at least a portion of its pane over at least a portion of one of the other panes.

### Embodiment 48

A metaproducer for enabling a user to create metacontent shows, the metaproducer comprising the following components embodied on a computer-readable medium:

(a) an instruction set adapted to direct a data processor to present an aggregation pane on a video screen, the aggregation pane adapted to display a plurality of subjects to which the user can add new metacontent shows, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information;

(b) an instruction set adapted to direct the data processor to present a head pane on the video screen, the head pane adapted to present the metacontent track associated with the new metacontent show;

(c) an instruction set adapted to direct the data processor to present a content pane on the video screen, the content pane adapted to present the contents of items of network-accessible information;

(d) an instruction set adapted to direct a data processor to receive user input to add a new metacontent show to a selected subject;

(e) an instruction set adapted to direct a data processor to receive user input to associate a textual description to the new metacontent show;

(f) an instruction set adapted to direct a data processor to receive user input to associate a metacontent track to the new metacontent show;

(g) an instruction set adapted to direct a data processor to receive user input of one or more corresponding items of network-accessible information that are to be associated to the new metacontent show, the association including an identifier for each item that facilitates access to the contents of the item over a network;

(h) an instruction set adapted to direct a data processor to receive user input to associate a selected item of network-accessible information of the new metacontent show with a selected location in the metacontent track; and

(i) an instruction set adapted to direct a data processor to receive user input to associate one or more event commands to the new metacontent show, at least one event command providing a value for at least one characteristic of a pane that will be used to display the new metacontent show when it is played, the at least one characteristic being one of the position of the pane, the size of the pane, the layer level of the pane relative to other panes, and the translucency of the pane.

### Embodiment 49

The metaproducer of Embodiment 48 wherein instruction set (i) is further adapted to direct a data process or receive a user input to associate to the new metacontent show an event command for pausing the playing of the metacontent track at a selected time point in the playing of the metacontent track.

### Embodiment 50

The metaproducer of Embodiment 49 wherein instruction set (i) is further adapted to direct a data process to receive a user input for at least one of: (1) a time duration for the pause event command, and (2) a software restart object specifying the conditions on which the playing of the metatcontent track is to be restarted.

### Embodiment 51

The metaproducer of Embodiment 48 wherein instruction set (i) is further adapted to direct a data process or receive a user input to associate to the new metacontent show an event command for displaying an overlay pane during a selected playing time of the metacontent show, and to receive a software object specifying the contents of the overlay pane.

### Embodiment 52

The metaproducer of Embodiment 48 further comprising: (j) an interface control adapted to direct the data processor to receive user input to transmit a new metacontent show to a database server and an instruction set to transmit the new metacontent show to the database server.

### Embodiment 53

The metaproducer of Embodiment 48 further comprising:

an instruction set adapted to direct the data processor to receive user input to establish access to a feed of a selected information source;

an instruction set adapted to direct the data processor to receive listings of posts of the established feeds from one or more network-accessible servers, each listing including at least the title of the post and a network identifier to the post, and to display the feeds and post listings in the screen area for aggregation pane;

an instruction set adapted to direct the data processor to receive user input to load a selected post of a feed in the content pane, and to send a message to the instruction set of the content pane instructing it to load the selected post, the message including a network identifier for the selected post.

### Embodiment 54

The metaproducer of Embodiment 48 further comprising an instruction set adapted to direct the data processor to provide a data object for a text narrative of the new metacontent show, and

an instruction set adapted to direct the data processor to receive user input to edit the narrative in the content pane, and to send a message to the Internet browser instructing it to load an editor to work on the data object for the narrative.

### Embodiment 55

The metaproducer of Embodiment 48 wherein the interface control (h) is further adapted to send a request message to the media player of head pane to obtain the representation of the current playing time of the track.

### Embodiment 56

The metaproducer of Embodiment 48 wherein the interface control (h) is further adapted to receive user input to use a selected portion of text in the narrative to set a selected location in the metacontent track for the selected item.

### Embodiment 57

The metaproducer of Embodiment 48 wherein the interface control (h) is further adapted to present a dialog box to the user to obtain text of a name of a file that has data representative of a portion of the audio track by which to set a selected location in the metacontent track for the selected item.

### Embodiment 58

The metaproducer of Embodiment 48 wherein the interface control (h) is further adapted to present a dialog box to the user to obtain a selection of a preset sound or a present duration of silence by which to set a selected location in the metacontent track for the selected item.

### Embodiment 59

The metaproducer of Embodiment 48 further comprising instruction sets adapted to direct the data processor to receive user input to play the new metacontent show, to send a message to the media player of the head pane instructing the media player to access the file for the new show's metacontent track and start playing the track, and to display each of the selected show's items in the content pane at the item's corresponding location in the playing span of the metacontent track.

### Embodiment 60

The metaproducer of Embodiment 48 wherein the interface control (h) comprises a video recorder and editor component displayed in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 61

The metaproducer of Embodiment 60 wherein the interface control (h) further comprises a sync-links data object to store the time locations of sync-linked items, and an instruction set adapted to direct the data processor to receive user input to add a URL to the sync-link's track at a selected location, and to update the sync-link data object to include the item and its location.

### Embodiment 62

The metaproducer of Embodiment 60 wherein the interface control (h) further comprises an instruction set adapted to direct the data processor to receive user input to set the end presentation time of a sync-link already on the sync-links track, and to update the location of the item's location in the sync-link data object.

### Embodiment 63

The metaproducer of Embodiment 60 wherein the interface control (h) enables the user to move sections of the metacontent track by moving representations of the sync-linked items.

### Embodiment 64

The metaproducer of Embodiment 63 wherein the interface control (h) further comprises an instruction set adapted to direct the data processor to receive user input to move a selected sync-link displayed on the sync-link track to a new location, to obtain the start and end points of the selected sync-link from the sync-links data object, to direct the video recorder/editor software to copy the video between the start and end points to a temporary buffer, to direct the video recorder/editor software to delete the video between the start and end points if the new location is before the start point, to direct the video recorder/editor software to copy the contents of the temporary buffer into the audio and video tracks at the new location, and to direct the video recorder/editor software to delete the video between the start and end points if the new location is after the end point, and to update the location of the sync-link in the track's data object and the sync-links data object.

### Embodiment 65

The metaproducer of Embodiment 60 further comprising an event command data object to store the event commands for a new metacontent show, and wherein the interface control (h) further comprises:

an instruction set that directs a data processor to include a graphical representation of the event-commands track integrated with the time bar, and an event command holding area; and

an instruction set that directs a data processor to display a visual representation of each event command in the event command data object on the pane for the video recorder and editor component, wherein event commands that do not have a time point are displayed in the holding area, and wherein event commands that do have a time point are displayed in relation to the event command track.

### Embodiment 66

The metaproducer of Embodiment 65, wherein the interface control (h) further comprises:

an instruction set that directs a data processor to receive a user input to move the visual representation of an event command on the pane for the video recorder and editor component, and to update the time value of the moved event command, and to update the visual representation.

### Embodiment 67

The metaproducer of Embodiment 65, wherein the interface control (h) further comprises:

an instruction set that directs a data processor to receive a user selection of visual representation of an event command on the pane for the video recorder and editor component, and thereafter receive user input to modify the properties of the selected event command.

### Embodiment 68

A computer program product to enable creation of metacontent shows and to be executed by an Internet Browser being run by a data processor, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, the product comprising the following components embodied on a computer-readable medium:

(a) an instruction set adapted to direct the data processor to allocate a screen area for a head pane and a directory pane, with the Internet browser passing user input in this area to the program product to handle;

(b) an instruction set adapted to direct the data processor to start an instance of a media player to handle the head pane;

(c) a data object holding a directory listing of metacontent shows or an instruction set adapted to direct a data processor to request and receive a directory listing of metacontent shows from one or more network-accessible database servers;

(d) an instruction set adapted to direct the data processor to display the listing in the screen area for directory pane;

(e) an interface control adapted to direct the data processor to receive user input to add a new metacontent show to a selected subject;

(f) an interface control adapted to direct the data processor to receive user input to associate a textual description to a new metacontent show;

(g) an interface control adapted to direct the data processor to receive user input to associate a metacontent track with the new metacontent show;

(h) an interface control adapted to direct the data processor to receive user input of one or more corresponding items of network-accessible information that are to be associated with the new metacontent show, the association including an identifier for each item that facilitates access to the contents of the item over a network;

(i) an interface control adapted to direct the data processor to receive user input to associate a selected item of network-accessible information of the new metacontent show with a selected location in the metacontent track; and

(j) an instruction set adapted to direct a data processor to receive user input to associate one or more event commands to the new metacontent show, at least one event command providing a value for at least one characteristic of a pane that will be used to display the new metacontent show when it is played, the at least one characteristic being one of the position of the pane, the size of the pane, the layer level of the pane relative to other panes, and the translucency of the pane.

### Embodiment 69

The product of Embodiment 68 wherein instruction set (j) is further adapted to direct a data process or receive a user input to associate to the new metacontent show an event command for pausing the playing of the metacontent track at a selected time point in the playing of the metacontent track.

### Embodiment 70

The product of Embodiment 69 wherein instruction set (j) is further adapted to direct a data process to receive a user input for at least one of: (1) a time duration for the pause event command, and (2) a software restart object specifying the conditions on which the playing of the metatcontent track is to be restarted.

### Embodiment 71

The product of Embodiment 68 wherein instruction set (j) is further adapted to direct a data process or receive a user input to associate to the new metacontent show an event command for displaying an overlay pane during a selected playing time of the metacontent show, and to receive a software object specifying the contents of the overlay pane.

### Embodiment 72

The computer program product of Embodiment 68 further comprising:

(k) an interface control adapted to direct the data processor to receive user input to transmit a new metacontent show to a database server and an instruction set to transmit the new metacontent show to the database server.

### Embodiment 73

The computer program product of Embodiment 68 further comprising:

an instruction set adapted to direct the data processor to receive user input to establish access to a feed of a selected information source;

an instruction set adapted to direct the data processor to receive listings of posts of the established feeds from one or more network-accessible servers, each listing including at least the title of the post and a network identifier to the post, and to display the feeds and post listings in the screen area for aggregation pane;

an instruction set adapted to direct the data processor to receive user input to load a selected post of a feed in the content pane, and to send a message to the instruction set of the content pane instructing it to load the selected post, the message including a network identifier for the selected post.

### Embodiment 74

The product of Embodiment 68 further comprising an instruction set adapted to direct the data processor to provide a data object for a text narrative of the new metacontent show, and

an instruction set adapted to direct the data processor to receive user input to edit the narrative in the content pane, and to send a message to the Internet browser instructing it to load an editor to work on the data object for the narrative.

### Embodiment 75

The product of Embodiment 68 wherein the interface control (i) is further adapted to send a request message to the media player of head pane to obtain the representation of the current playing time of the track.

### Embodiment 76

The product of Embodiment 68 wherein the interface control (i) is further adapted to present a dialog box to the user to obtain text of a phrase of the audio track by which to set a selected location in the metacontent track for the selected item.

### Embodiment 77

The product of Embodiment 68 wherein the interface control (i) is further adapted to present a dialog box to the user to obtain text of a name of a file that has data representative of a portion of the audio track by which to set a selected location in the metacontent track for the selected item.

### Embodiment 78

The product of Embodiment 68 wherein the interface control (i) is further adapted to present a dialog box to the user to obtain a selection of a preset sound or a present duration of silence by which to set a selected location in the metacontent track for the selected item.

### Embodiment 79

The product of Embodiment 68 further comprising instruction sets adapted to direct the data processor to receive user input to play the new metacontent show, to send a message to the media player of the head pane instructing the media player to access the file for the new show's metacontent track and start playing the track, and to display each of the selected show's items in the content pane at the item's corresponding location in the playing span of the metacontent track.

### Embodiment 80

The product of Embodiment 68 wherein the interface control (i) comprises a video recorder and editor component displayed in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 81

The product of Embodiment 80 wherein the interface control (i) further comprises a sync-links data object to store the time locations of sync-linked items, and an instruction set adapted to direct the data processor to receive user input to add a URL to the sync-link's track at a selected location, and to update the sync-link data object to include the item and its location.

### Embodiment 82

The product of Embodiment 81 wherein the interface control (i) further comprises an instruction set adapted to direct the data processor to receive user input to set the end presentation time of a sync-link already on the sync-links track, and to update the location of the item's location in the sync-link data object.

### Embodiment 83

The product of Embodiment 81 wherein the interface control (i) enables the user to move sections of the metacontent track by moving representations of the sync-linked items.

### Embodiment 84

The product of Embodiment 83 wherein the interface control (I) further comprises an instruction set adapted to direct the data processor to receive user input to move a selected sync-link displayed on the sync-link track to a new location, to obtain the start and end points of the selected sync-link from the sync-links data object, to direct the video recorder/editor software to copy the video between the start and end points to a temporary buffer, to direct the video recorder/editor software to delete the video between the start and end points if the new location is before the start point, to direct the video recorder/editor software to copy the contents of the temporary buffer into the audio and video tracks at the new location, and to direct the video recorder/editor software to delete the video between the start and end points if the new location is after the end point, and to update the location of the sync-link in the track's data object and the sync-links data object.

### Embodiment 85

The product of Embodiment 80 further comprising an event command data object to store the event commands for a new metacontent show, and wherein the interface control (i) further comprises:

an instruction set that directs a data processor to include a graphical representation of the event-commands track integrated with the time bar, and an event command holding area; and

an instruction set that directs a data processor to display a visual representation of each event command in the event command data object on the pane for the video recorder and editor component, wherein event commands that do not have a time point are displayed on the holding area, and wherein event commands that do have a time point are displayed in relation to the event command track.

### Embodiment 86

The product of Embodiment 85, wherein the interface control (i) further comprises:

an instruction set that directs a data processor to receive a user input to move the visual representation of an event command on the pane for the video recorder and editor component, and to update the time value of the moved event command, and to update the visual representation.

### Embodiment 87

The product of Embodiment 85, wherein the interface control (i) further comprises:

an instruction set that directs a data processor to receive a user selection of visual representation of an event command on the pane for the video recorder and editor component, and thereafter receive user input to modify the properties of the selected event command.

### Embodiment 88

A method of enabling a user to create metacontent shows, the method comprising:

(a) presenting an aggregation pane on a video screen, the aggregation pane adapted to display a plurality of subjects to which the user can add new metacontent shows, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information;

(b) providing a head pane on the video screen, the head pane adapted to present the metacontent track associated with the new metacontent show;

(c) providing a content pane on the video screen, the content pane adapted to present the contents of items of network-accessible information;

(d) enabling the user to add a new metacontent show to a selected subject;

(e) enabling the user input to associate a textual description to a new metacontent show;

(f) enabling the user input to associate a metacontent track to the new metacontent show;

(g) enabling the user to associate one or more corresponding items of network-accessible information to the new metacontent show, the association including an identifier for each item that facilitates access to the contents of the item over a network;

(h) enabling the user to associate a selected item of network-accessible information of the new metacontent show with a selected location in the metacontent track; and

(i) enabling the user to associate one or more event commands to the new metacontent show, at least one event command providing a value for at least one characteristic of a pane that will be used to display the new metacontent show when it is played, the at least one characteristic being one of the position of the pane, the size of the pane, the layer level of the pane relative to other panes, and the translucency of the pane.

### Embodiment 89

The method of Embodiment 88 further comprising: providing the user with the ability to associate to the new metacontent show an event command for pausing the playing of the metacontent track at a selected time point in the playing of the metacontent track.

### Embodiment 90

The method of Embodiment 89 further comprising: providing the user with the ability to provide at least one of: (1) a time duration for the pause event command, and (2) a software restart object specifying the conditions on which the playing of the metatcontent track is to be restarted.

### Embodiment 91

The method of Embodiment 88 further comprising: providing the user with the ability to associate to the new metacontent show an event command for displaying an overlay pane during a selected playing time of the metacontent show, and to receive a software object specifying the contents of the overlay pane.

### Embodiment 92

The method of Embodiment 88 further comprising:

providing the user with a listing of one or more feeds from one or more network-accessible servers in the aggregation pane;

providing the user with the ability to select a post from a feed to view;

displaying a post selected by the user in the content pane.

### Embodiment 93

The method of Embodiment 88 further comprising: providing the user with the ability to compose a text narrative for the new metacontent show in the content pane.

### Embodiment 94

The method of Embodiment 88 wherein the step (h) of enabling the user to associate a selected item of network-accessible information of the new metacontent show with a selected location in the metacontent track enables the user to select the location based on the current playing time of the media player.

### Embodiment 95

The method of Embodiment 88 wherein the step (h) of enabling the user to associate a selected item of network-accessible information of the new metacontent show with a selected location in the metacontent track enables the user to select the location based on the text of a phrase of the audio track.

### Embodiment 96

The method of Embodiment 88 wherein the step (h) of enabling the user to associate a selected item of network-accessible information of the new metacontent show with a selected location in the metacontent track enables the user to select the location based on data representative of a portion of the audio track.

### Embodiment 97

The method of Embodiment 88 wherein the step (h) of enabling the user to associate a selected item of network-accessible information of the new metacontent show with a selected location in the metacontent track enables the user to select the location based on a preset sound or a present duration of silence.

### Embodiment 98

The method of Embodiment 88 further comprising a step of enabling the user to view the new metacontent show with the metacontent track played in the head pane and the contents of the show's sync-link items being displayed in the content pane.

### Embodiment 99

The method of Embodiment 88 further comprising displaying to the user a video recorder and editor component in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 100

The method of Embodiment 99 further comprising enabling the user to add a URL to the sync-link's track at a selected location.

### Embodiment 101

The method of Embodiment 100 further comprising enabling the user to set the end presentation time of a sync-link already on the sync-links track.

### Embodiment 102

The method of Embodiment 100 further comprising enabling the user to move sections of the metacontent track by moving representations of the sync-linked items.

### Embodiment 103

The method of Embodiment 99 displaying, with the video recorder and editor component, a event-commands track integrated with the time bar, and an event command holding area; and

displaying a visual representation of the event commands associated with the new metacontent show, wherein event commands that do not have a time point are displayed on the holding area, and wherein event commands that do have a time point are displayed in relation to the event command track.

### Embodiment 104

The method of Embodiment 103, providing the user with the ability to move the visual representation of an event command on the pane for the video recorder and editor component, with the time value of the moved event command being updated.

### Embodiment 105

The method of Embodiment 103, providing the user with the ability to select the visual representation of an event command on the pane for the video recorder and editor component, and to thereafter modify the properties of the selected event command.

### Embodiment 106

A MetaAdvertiser for enabling a user to create metacontent advertisements, the MetaAdvertiser comprising the following components embodied on a computer-readable medium:

(a) an instruction set adapted to direct a data processor to present a production pane on a video screen, the production pane adapted to display an advertisement node to which the user can add new metacontent advertisements, each metacontent advertisement comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information;

(b) an instruction set adapted to direct the data processor to present a head pane on the video screen, the head pane adapted to present the metacontent track associated with the new metacontent advertisement;

(c) an instruction set adapted to direct the data processor to present a content pane on the video screen, the content pane adapted to present the contents of items of network-accessible information;

(d) an instruction set adapted to direct the data processor to receive user input to add a new metacontent advertisement to the advertisement node;

(e) an instruction set adapted to direct the data processor to receive user input to associate a textual description to a new metacontent advertisement;

(f) an instruction set adapted to direct the data processor to receive user input to associate a metacontent track to the new metacontent advertisement;

(g) an instruction set adapted to direct the data processor to receive user input of one or more corresponding items of network-accessible information that are to be associated to new metacontent advertisement, the association including an identifier for each item that facilitates access to the contents of the item over a network;

(h) an instruction set adapted to direct the data processor to receive user input to associate a selected item of network-accessible information of the new metacontent advertisement with a selected location in the metacontent track; and

(i) an instruction set adapted to direct a data processor to receive user input to associate one or more event commands to the new metacontent advertisement, at least one event command providing a value for at least one characteristic of a pane that will be used to display the new metacontent advertisement when it is played, the at least one characteristic being one of the position of the pane, the size of the pane, the layer level of the pane relative to other panes, and the translucency of the pane.

### Embodiment 107

The MetaAdvertiser of Embodiment 106 wherein instruction set (i) is further adapted to direct a data process or receive a user input to associate to the new metacontent advertisement an event command for pausing the playing of the metacontent track at a selected time point in the playing of the metacontent track.

### Embodiment 108

The MetaAdvertiser of Embodiment 107 wherein instruction set (i) is further adapted to direct a data process to receive a user input for at least one of: (1) a time duration for the pause event command, and (2) a software restart object specifying the conditions on which the playing of the metatcontent track is to be restarted.

### Embodiment 109

The MetaAdvertiser of Embodiment 106 wherein instruction set (i) is further adapted to direct a data process or receive a user input to associate to the new metacontent advertisement an event command for displaying an overlay pane during a selected playing time of the metacontent advertisement, and to receive a software object specifying the contents of the overlay pane.

### Embodiment 110

The MetaAdvertiser of Embodiment 106 wherein the interface control (h) comprises a video recorder and editor component displayed in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 111

The MetaAdvertiser of Embodiment 110 further comprising an event command data object to store the event commands for a new metacontent advertisement, and wherein the interface control (h) further comprises:

an instruction set that directs a data processor to include a graphical representation of an event-commands track integrated with the time bar, and an event command holding area; and

an instruction set that directs a data processor to display a visual representation of each event command in the event command data object on the pane for the video recorder and editor component, wherein event commands that do not have a time point are displayed on the holding area, and wherein event commands that do have a time point are displayed in relation to the event command track.

### Embodiment 112

The MetaAdvertiser of Embodiment 111, wherein the interface control (h) further comprises:

an instruction set that directs a data processor to receive a user input to move the visual representation of an event command on the pane for the video recorder and editor component, and to update the time value of the moved event command, and to update the visual representation.

### Embodiment 113

The MetaAdvertiser of Embodiment 111, wherein the interface control (h) further comprises:

an instruction set that directs a data processor to receive a user selection of visual representation of an event command on the pane for the video recorder and editor component, and thereafter receive user input to modify the properties of the selected event command.

### Embodiment 114

A computer program product to enable a user to create metacontent advertisements and to be executed by an Internet Browser being run by a data processor, each metacontent advertisement comprising a playing span and a metacontent track, the metacontent track comprising at least one of an audio track, a video track, or both, one or more identifiers to one or more corresponding items of network-accessible information being associated or embedded within the metacontent advertisement, each item to be displayed to the user at a corresponding location in the playing span of the metacontent track, the product comprising the following components embodied on a computer-readable medium:

(a) an instruction set adapted to direct the data processor to allocate a screen area to set up a head pane and a production pane, with the Internet browser passing user input in this area to the program product to handle;

(b) an instruction set adapted to direct the data processor to start an instance of a media player to handle the head pane;

(c) a data object holding a directory listing of the user's metacontent advertisements present on a server or an instruction set adapted to direct the data processor to request and receive a directory listing of the user's metacontent advertisements from one or more network-accessible database servers;

(d) an instruction set adapted to direct the data processor to display the listing in the screen area for production pane;

(e) an interface control adapted to direct the data processor to receive user input to add a new metacontent advertisement to the listing of the user's metacontent advertisements;

(f) an interface control adapted to direct the data processor to receive user input to associate a textual description to a new metacontent advertisement;

(g) an interface control adapted to direct the data processor to receive user input to associate a metacontent track with the new metacontent advertisement;

(h) an interface control adapted to direct the data processor to receive user input of one or more corresponding items of network-accessible information that are to be associated with the new metacontent advertisement, the association including an identifier for each item that facilitates access to the contents of the item over a network;

(i) an interface control adapted to direct the data processor to receive user input to associate a selected item of network-accessible information of the new metacontent advertisement with a selected location in the metacontent track; and

(j) an instruction set adapted to direct a data processor to receive user input to associate one or more event commands to the new metacontent advertisement, at least one event command providing a value for at least one characteristic of a pane that will be used to display the new metacontent advertisement when it is played, the at least one characteristic being one of the position of the pane, the size of the pane, the layer level of the pane relative to other panes, and the translucency of the pane.

### Embodiment 115

The product of Embodiment 114 wherein instruction set (j) is further adapted to direct a data process or receive a user input to associate to the new metacontent advertisement an event command for pausing the playing of the metacontent track at a selected time point in the playing of the metacontent track.

### Embodiment 116

The product of Embodiment 115 wherein instruction set (j) is further adapted to direct a data process to receive a user input for at least one of: (1) a time duration for the pause event command, and (2) a software restart object specifying the conditions on which the playing of the metatcontent track is to be restarted.

### Embodiment 117

The product of Embodiment 114 wherein instruction set (j) is further adapted to direct a data process or receive a user input to associate to the new metacontent advertisement an event command for displaying an overlay pane during a selected playing time of the metacontent advertisement, and to receive a software object specifying the contents of the overlay pane.

### Embodiment 118

The product of Embodiment 114 wherein the interface control (i) comprises a video recorder and editor component displayed in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 119

The product of Embodiment 118 further comprising an event command data object to store the event commands for a new metacontent advertisement, and wherein the interface control (i) further comprises:

an instruction set that directs a data processor to include a graphical representation of the event-commands track integrated with the time bar, and an event command holding area; and

an instruction set that directs a data processor to display a visual representation of each event command in the event command data object on the pane for the video recorder and editor component, wherein event commands that do not have a time point are displayed on the holding area, and wherein event commands that do have a time point are displayed in relation to the event command track.

### Embodiment 120

The product of Embodiment 119, wherein the interface control (i) further comprises:

an instruction set that directs a data processor to receive a user input to move the visual representation of an event command on the pane for the video recorder and editor component, and to update the time value of the moved event command, and to update the visual representation.

### Embodiment 121

The product of Embodiment 119, wherein the interface control (i) further comprises:

an instruction set that directs a data processor to receive a user selection of visual representation of an event command on the pane for the video recorder and editor component, and thereafter receive user input to modify the properties of the selected event command.

### Embodiment 122

A method for enabling a user to create metacontent advertisements, the method comprising:

(a) providing a production pane on a video screen, the production pane adapted to display an advertisement node to which the user can add new metacontent advertisements, each metacontent advertisement comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information;

(b) presenting a head pane on the video screen, the head pane adapted to present the metacontent track associated with the new metacontent advertisement;

(c) presenting a content pane on the video screen, the content pane adapted to present the contents of items of network-accessible information;

(d) enabling the user to add a new metacontent advertisement to the advertisement node;

(e) enabling the user to associate a textual description to a new metacontent advertisement;

(f) enabling the user to associate a metacontent track to the new metacontent advertisement;

(g) enabling the user the associate one or more corresponding items of network-accessible information to new metacontent advertisement, the association including an identifier for each item that facilitates access to the contents of the item over a network;

(h) enabling the user to associate a selected item of network-accessible information of the new metacontent advertisement with a selected location in the metacontent track; and

(i) enabling the user to associate one or more event commands to the new metacontent advertisement, at least one event command providing a value for at least one characteristic of a pane that will be used to display the new metacontent advertisement when it is played, the at least one characteristic being one of the position of the pane, the size of the pane, the layer level of the pane relative to other panes, and the translucency of the pane.

### Embodiment 123

The method of Embodiment 122 further comprising: providing the user with the ability to associate to the new metacontent advertisement an event command for pausing the playing of the metacontent track at a selected time point in the playing of the metacontent track.

### Embodiment 124

The method of Embodiment 123 further comprising: providing the user with the ability to provide at least one of: (1) a time duration for the pause event command, and (2) a software restart object specifying the conditions on which the playing of the metatcontent track is to be restarted.

### Embodiment 125

The method of Embodiment 122 further comprising: providing the user with the ability to associate to the new metacontent advertisement an event command for displaying an overlay pane during a selected playing time of the metacontent advertisement, and to receive a software object specifying the contents of the overlay pane.

### Embodiment 126

The method of Embodiment 122 further comprising displaying to the user a video recorder and editor component in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 127

The method of Embodiment 126 displaying, with the video recorder and editor component, a event-commands track integrated with the time bar, and an event command holding area; and

displaying a visual representation of the event commands associated with the new metacontent advertisement, wherein event commands that do not have a time point are displayed on the holding area, and wherein event commands that do have a time point are displayed in relation to the event command track.

### Embodiment 128

The method of Embodiment 127, providing the user with the ability to move the visual representation of an event command on the pane for the video recorder and editor component, with the time value of the moved event command being updated.

### Embodiment 129

The method of Embodiment 127, providing the user with the ability to select the visual representation of an event command on the pane for the video recorder and editor component, and to thereafter modify the properties of the selected event command.

### Embodiment 130

A Metaspeaker for enabling a user to at least create sample advertisements for an advertiser to view, the MetaSpeaker comprising the following components embodied on a computer-readable medium:

(a) an instruction set adapted to direct a data processor to present an audition pane on a video screen, the audition pane adapted to display an sample node to which the user can add new sample metacontent advertisements, each metacontent advertisement comprising a metacontent track, and each track comprising a playing span, and at least one of an audio track, a video track, or both;

(b) an instruction set adapted to direct the data processor to present a head pane on the video screen, the head pane adapted to present audition tracks and the metacontent track of sample advertisements;

(c) an instruction set adapted to direct a data processor to receive user input to add a new sample metacontent advertisement to the samples node;

(d) an instruction set adapted to direct a data processor to receive user input to associate a textual description to a new sample metacontent advertisement;

(e) an instruction set adapted to direct a data processor to receive user input to associate a metacontent track to the new sample metacontent advertisement;

(f) an instruction set adapted to direct a data processor to receive user input of one or more corresponding items of network-accessible information that are to be associated to new sample metacontent advertisement, the association including an identifier for each item that facilitates access to the contents of the item over a network; and

(g) an instruction set adapted to direct a data processor to receive user input to associate a selected item of network-accessible information of the new metacontent advertisement with a selected location in the metacontent track; and

(h) an instruction set adapted to direct a data processor to receive user input to associate one or more event commands to the sample metacontent advertisement, at least one event command providing a value for at least one characteristic of a pane that will be used to display the sample metacontent advertisement when it is played, the at least one characteristic being one of the position of the pane, the size of the pane, the layer level of the pane relative to other panes, and the translucency of the pane.

### Embodiment 131

The Metaspeaker of Embodiment 130 wherein instruction set (h) is further adapted to direct a data process or receive a user input to associate to the sample metacontent advertisement an event command for pausing the playing of the metacontent track at a selected time point in the playing of the metacontent track.

### Embodiment 132

The Metaspeaker of Embodiment 131 wherein instruction set (h) is further adapted to direct a data process to receive a user input for at least one of: (1) a time duration for the pause event command, and (2) a software restart object specifying the conditions on which the playing of the metatcontent track is to be restarted.

### Embodiment 133

The Metaspeaker of Embodiment 130 wherein instruction set (h) is further adapted to direct a data process or receive a user input to associate to the sample metacontent advertisement an event command for displaying an overlay pane during a selected playing time of the metacontent show, and to receive a software object specifying the contents of the overlay pane.

### Embodiment 134

The Metaspeaker of Embodiment 130 wherein the interface control (g) comprises a video recorder and editor component displayed in a pane of the video screen, the component enabling the user to create a metacontent track and to record audio and video data into the audio and video tracks of the metacontent track, the video recorder and editor having a time track for inputting sync-links and allowing them to be moved around in the time track, with a time bar to show the currently playing time of the metacontent track on the time track.

### Embodiment 135

The Metaspeaker of Embodiment 134 further comprising an event command data object to store the event commands for a sample metacontent advertisement, and wherein the interface control (g) further comprises:

an instruction set that directs a data processor to include a graphical representation of the event-commands track integrated with the time bar, and an event command holding area; and

an instruction set that directs a data processor to display a visual representation of each event command in the event command data object on the pane for the video recorder and editor component, wherein event commands that do not have a time point are displayed on the holding area, and wherein event commands that do have a time point are displayed in relation to the event command track.

### Embodiment 136

The Metaspeaker of Embodiment 135, wherein the interface control (g) further comprises:

an instruction set that directs a data processor to receive a user input to move the visual representation of an event command on the pane for the video recorder and editor component, and to update the time value of the moved event command, and to update the visual representation.

### Embodiment 137

The Metaspeaker of Embodiment 135, wherein the interface control (g) further comprises:

an instruction set that directs a data processor to receive a user selection of visual representation of an event command on the pane for the video recorder and editor component, and thereafter receive user input to modify the properties of the selected event command.

### Embodiment 138

A computer program product to enable a user to at least create an audition track and sample advertisements for an advertiser to view, the product to be executed by an Internet Browser being run by a data processor, each audition track comprising a playing span, and at least one of an audio track, a video track, or both, the product comprising the following components embodied on a computer-readable medium:

(a) an instruction set adapted to direct the Internet browser to allocate a screen area to set up a head pane and a audition pane, with the Internet browser passing user input in this area to the program product to handle;

(b) an instruction set adapted to direct the data processor to start an instance of a media player in the area of the head pane;

(c) a data object holding a listing of auditions or an instruction set adapted to direct the data processor to request and receive a listing of the user's auditions from one or more network-accessible database servers;

(d) an instruction set adapted to direct the data processor to display the listing in the screen area for audition pane;

(e) an interface control adapted to direct the data processor to receive user input to add a new audition to the listing of auditions;

(f) an interface control adapted to direct the data processor to receive user input to associate a textual description to a new audition;

(g) an interface control adapted to direct the data processor to receive user input to associate an audition track with the new audition;

(h) an instruction set adapted to direct the data processor to receive user input to publish the new audition to a database server with a right to view being grated to an advertiser.

### Embodiment 139

The Metaspeaker of Embodiment 138 further comprising:

(i) an instruction set adapted to direct a data processor to receive user input to add a new sample metacontent advertisement to a samples node;

(j) an instruction set adapted to direct a data processor to receive user input to associate a textual description to a new sample metacontent advertisement;

(k) an instruction set adapted to direct a data processor to receive user input to associate an metacontent track to the new sample metacontent advertisement;

(l) an instruction set adapted to direct a data processor to receive user input of one or more corresponding items of network-accessible information that are to be associated to new sample metacontent advertisement, the association including an identifier for each item that facilitates access to the contents of the item over a network; and

(m) an instruction set adapted to direct a data processor to receive user input to associate a selected item of network-accessible information of the new metacontent advertisement with a selected location in the metacontent track.

### Embodiment 140

A method for enabling a user to at least create audition track for an advertiser to view, the method comprising:

presenting an audition pane on a video screen, the audition pane adapted to display a Auditions node to which the user can add new audition tracks, each audition track comprising a playing span, and at least one of an audio track, a video track, or both;

presenting a head pane on the video screen, the head pane adapted to present audition tracks;

enabling the user input to add a new audition to the audition node;

enabling the user to associate a textual description to a new audition;

enabling the user input to associate a audition track to the new audition;

enabling the user to publish the new audition to a database server with a right to view being grated to an advertiser.

### Embodiment 141

The method of Embodiment 140 further comprising providing the user with a samples node on a database server to provide prospective advertisers with samples of the user's work.

### Embodiment 142

The method of Embodiment 141 further comprising enabling the user copy a selected audition in the audition node to the samples node.

### Embodiment 143

The method of Embodiment 141 further comprising providing the user with a advertisements node on a database server, the advertisements node containing placed advertisements narrated by the user; and

enabling the user to copy a selected advertisement in the advertisement node to the samples node.

### Embodiment 144

The method of Embodiment 140 further comprising providing the user with a advertisements node on a database server, the advertisements node containing placed advertisements narrated by the user; and

providing the user with current data regarding the usage of a selected advertisement, the selected advertisement being selected by the user from the advertisement node.

### Embodiment 145

A video recorder and editor to be displayed on a video screen, the video recorder element comprising the following embodied on a computer-readable medium:

instruction sets adapted to direct a data processor to enable a user to create a metacontent track and to record audio and video data into the audio and video tracks of the metacontent track;

an instruction set adapted to direct a data processor to display a time track for inputting sync-links and allowing the sync-links to be moved around in the time track, and to display a time bar to show the current playing time of the metacontent track on the time track.

### Embodiment 146

The video recorder and editor of Embodiment 145 further comprising:

a sync-links data object to store the time locations of sync-linked items; and

an instruction set adapted to direct the data processor to receive user input to add a URL to the sync-link's track, and to update the sync-link data object to include the item and its location.

### Embodiment 147

The video recorder and editor of Embodiment 145 further comprising:

an instruction set adapted to direct the data processor to receive user input to set the end presentation time of a sync-link already on the sync-links track, and to update the location of the item's location in the sync-link data object.

### Embodiment 148

The video recorder and editor of Embodiment 145 further comprising:

an instruction set adapted to direct the data processor to enable the user to move sections of the metacontent track by moving representations of the sync-linked items.

### Embodiment 149

The video recorder and editor of Embodiment 148 further comprising:

an instruction set adapted to direct the data processor to receive user input to move a selected sync-link displayed on the sync-link track to a new location, to obtain the start and end points of the selected sync-link from the sync-links data object, to direct the video recorder/editor software to copy the video between the start and end points to a temporary buffer, to direct the video recorder/editor software to delete the video between the start and end points if the new location is before the start point, to direct the video recorder/editor software to copy the contents of the temporary buffer into the audio and video tracks at the new location, and to direct the video recorder/editor software to delete the video between the start and end points if the new location is after the end point, and to update the location of the sync-link in the track's data object and the sync-links data object.

### Embodiment 150

A method of presenting metacontent to a user involving a metabrowser, the method comprising: (a) presenting a directory pane to the user on a video screen, the directory pane adapted to display a plurality of subjects having a plurality of metacontent shows from which the user may select for presentation, and to receive a selection by the user of a metacontent show to view, each metacontent show comprising a playing span and a metacontent track, the metacontent track comprising at least one of an audio track, a video track, or both, one or more identifiers corresponding to one or more items of network-accessible information being associated or embedded within the metacontent show, each item to be displayed to the user at a corresponding location in the playing span of the metacontent track, each identifier facilitating access to its corresponding item of network-accessible information; (b) presenting a head pane to the user on a video screen, the head pane adapted to present the metacontent track of a selected metacontent show to the user; and (c) presenting a content pane to the user on a video screen, the content pane adapted to present to the user the contents of the metacontent show's corresponding to one or more items of network-accessible information, the contents of each item being presented when the playing time of the show's metacontent track is at or within the corresponding location of the item; wherein at least a portion of one of the panes of (a), (b) and (c) is overlayed onto at least a portion of one of the other panes.

### Embodiment 151

The method of Embodiment 150 wherein the method further comprises the step of: changing at least one characteristic of at least one pane of (a), (b) and (c), a characteristic being one of the position of the pane, the size of the pane, the layer level of the pane relative to other panes, and the translucency of the pane.

### Embodiment 152

The method of Embodiment 150 wherein the metacontent show further comprises a set of event commands for configuring characteristics of one or more identified panes during the playing of the show's metacontent track, at least one event command specifying at least one of the position, size, overlay layer level, and translucency of a selected pane, wherein the method further comprises the steps of reading an event command of the metacontent show and configuring the characteristics of the pane identified by an event command according to the characteristics specified by the event command.

### Embodiment 153

The method of Embodiment 150 wherein the metacontent show further comprises a set of event commands for configuring characteristics of one or more panes during the playing of the show's metacontent track, at least one event command specifying that the metacontent track be paused for a time duration, wherein the method further comprises the steps of reading an event command of the metacontent show and pausing the playing of the metacontent track of the pane identified by an event command that specifies such a pausing action.

### Embodiment 154

The method of Embodiment 150 wherein the method further comprises the step of: providing a data object for a focus node in the directory pane and receiving input from the user to establish a subscription under the focus node to a particular subject or sub-subject.

### Embodiment 155

A method of enabling a user to create metacontent shows using a metaproducer, the method comprising: (a) presenting to the user a plurality subjects in an aggregation pane on a video screen to which the user can add new metacontent shows, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information; (b) presenting to the user a head pane to on the video screen, the head pane adapted to present the metacontent track associated with the new metacontent show; (c) presenting to the user the contents of items of network-accessible information in a content pane on the video screen; (d) receiving a request from the user to add a new metacontent show to a selected subject; (e) receiving a request from the user to associate a textual description to the new metacontent show; (f) receiving a request from the user to associate a metacontent track to the new metacontent show; (g) receiving a request from the user to associate one or more corresponding items of network-accessible information to the new metacontent show, the association including an identifier for each item that facilitates access to the contents of the item over a network; (h) receiving a request from the user to associate a selected item of network-accessible information of the new metacontent show with a selected location in the metacontent track; and (i) receiving a request from the user to associate one or more event commands to the new metacontent show, at least one event command providing a value for at least one characteristic of a pane that will be used to display the new metacontent show when it is played, the at least one characteristic being one of the position of the pane, the size of the pane, the layer level of the pane relative to other panes, and the translucency of the pane.

### Embodiment 156

The method of Embodiment 150 wherein request (i) further comprises receiving a request from a user to show an event command for pausing the playing of the metacontent track at a selected time point in the playing of the metacontent track.

### Embodiment 157

The method of Embodiment 150 wherein request (i) further comprises receiving a request to associate to the new metacontent show an event command for displaying an overlay pane during a selected playing time of the metacontent show, and to receive a software object specifying the contents of the overlay pane.

### Embodiment 158

The method of Embodiment 150 wherein the method further comprises (j) presenting to the user an interface<*> control adapted to direct the data processor to receive user input to transmit a new metacontent show to a database server and an instruction set to transmit the new metacontent show to the database server.

### Embodiment 159

The method of Embodiment 150 wherein the method further comprises providing a data object for a text narrative of the new metacontent show, and receiving a request from a user to edit the narrative in the content pane, and to send a message to the Internet browser instructing it to load an editor to work on the data object for the narrative.

Accordingly, it is a broad object of several inventions of the present application to provide users with the ability to view information content in a higher form that provides depth while strengthening context and providing an overview perspective on all major media platforms.

It is another broad object of the several inventions of the present application to provide users with the ability to create metacontent and share it with others.

These and other objects of the present invention will become apparent to those skilled in the art from the following detailed description of the invention, the accompanying drawings, and the appended claims.

### BRIEF DESCRIPTION OF THE DRAWINGS

FIG. 1 is a schematic illustration of a metacontent show according to inventions of the present application.

FIG. 2 is a diagram of an exemplary personal computer platform for running Metabrowser and Metaproducer embodiments according to the present inventions.

FIG. 3A illustrates an implementation of an exemplary Metabrowser according to the present inventions.

FIG. 3B illustrates another implementation of an exemplary Metabrowser according to the present inventions.

FIG. 4 illustrates a computer program product for an exemplary Metabrowser according to the present inventions.

FIG. 5 illustrates an exemplary Metaproducer according to the present inventions.

FIG. 6 illustrates a computer program product for an exemplary Metaproducer according to the present inventions.

FIGS. 7-14 illustrate various user interfaces to an exemplary Metaproducer according to the present inventions.

FIG. 15 illustrates an exemplary system according to the present inventions.

FIG. 16 illustrates an exemplary MetaAdvertiser according to the present inventions.

FIGS. 17-18 illustrate various user interfaces to an exemplary MetaAdvertiser according to the present inventions.

FIG. 19 illustrates a computer program product for an exemplary Metaproducer according to the present inventions.

FIG. 20 illustrates an exemplary MetaAdvertiser according to the present inventions.

FIG. 21 illustrates a computer program product for exemplary MetaAdvertiser according to the present inventions.

### DETAILED DESCRIPTION OF THE INVENTIONS

The reader is referred to the above summary of the invention for a broad overview of the inventions of the present application and how they relate to one another. In the following description, numerous specific details are set forth to provide a more thorough description of the specific embodiments of the invention. It is apparent, however, that the invention may be practiced without all the specific details given below. In other instances, well known features have not been described in detail so as not to obscure the invention.

Metacontent show. As described above in the Invention Summary Section, the metacontent show is a unit of audio and/or video narration which enables a plurality of webpages to be summarized, synthesized, and aggregated in a higher form for consumption by viewers. From these metacontent shows, a Metaweb of shows can be created to store information content of all types that can be searched and viewed by millions of viewers. At present, the Web's unit of consumption is the Webpage, which provides viewers (i.e., users) the experience called “browsing.” In contrast, the Metaweb's unit of consumption is the metacontent show, which provides viewers with an intelligent browsing experience where they can get both a broad overview of the subject covered by the metacontent show, while having the opportunity to obtain more information on specific aspects of the subject when desired by interacting with its aggregated Web pages.

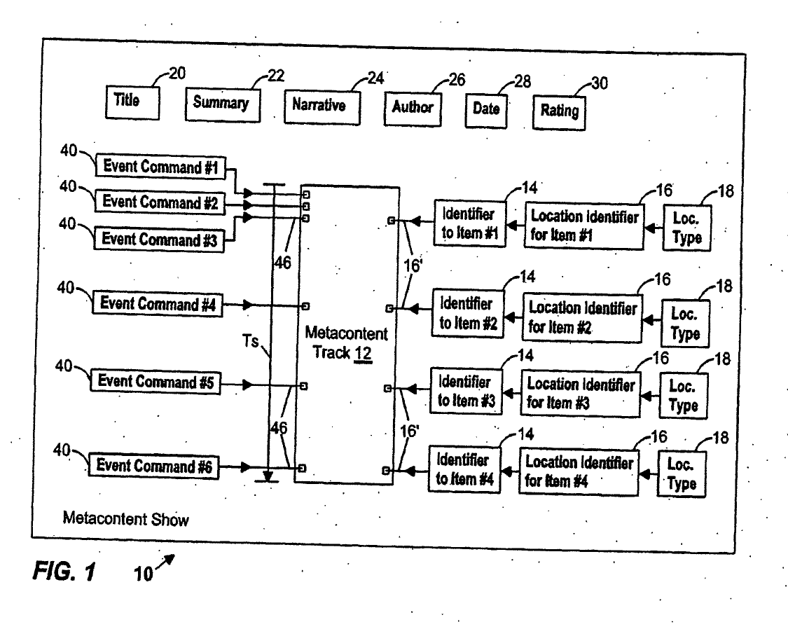

FIG. 1 is a schematic illustration of a metacontent show 10 (and also as an illustration of several exemplary data structures for it), which can be stored in a database (e.g., storage device), transmitted over a network embodied in a carrier wave by a server to a Metabrowser (i.e., presentation device), and presented to a viewer. Metacontent show 10 comprises a playing span Ts, a metacontent track 12, one or more identifiers 14 to one or more corresponding items of network-accessible information. Metacontent track 12 comprises at least one of an audio track, a video track, or both, which has a playing time equivalent to playing span Ts. Metacontent track 12 typically takes the form of a video report narrated by an expert-guide narrator (e.g., reporter). The items of network-accessible information, which are not part of a data structure for the metacontent show, can comprise blog postings, online news articles, other types of Web pages accessible over the Internet or similar network, and even other metacontent shows. Identifiers 14, which are part of a data structure for the metacontent show, facilitate access to their corresponding items, and can comprise uniform resource locators (URLs), and/or identifiers (URIs) that can be used to access the information from a database attached to a network-accessible server. As described in greater detail below, identifiers 14 are associated with, or embedded within, metacontent track 12. Metacontent show 10 is preferably presented to a viewer with metacontent track 12 being displayed in a first pane of a video screen, and the contents of the show's items of network-accessible information being displayed to the user in a second pane of the video screen, with the contents of each item being displayed at a corresponding location in the playing span Ts of the show's metacontent track 12. In this manner, the show's items are presented in a juxtaposed and synchronized manner with metacontent track 12, and their identifiers 14 are referred to herein as synchronized links, abbreviated as “sync-links.” Thus, this configuration enables viewers to get both a broad overview of the subject covered by the metacontent show, while having the opportunity to obtain more information on specific aspects of the subject when desired (i.e., “drill down”), thereby providing an intelligent browsing experience.

As will be described in greater detail below, the above panes may be displayed separately from one another on the video screen, or a pane may overlay portions of other panes, where the overlaying pane may have a selected degree of translucency from transparent to completely opaque. The panes may also be moved relative to one another during the playing of a metacontent track. During the playing of a metacontent show, the panes may be programmatically moved relative to one another, and may have their size, relative layer position, and translucency programmatically changed. In addition to programmatic movement of the panes, the user may also move the panes, change their layer position, and/or change their translucency.

The desired playing location for each item of network-accessible information can be incorporated into a data structure for the show in a number of ways, where one or more ways may be used for a metacontent show. As a first way, a location identifier 16 for each of a show's items is provided in the data structure (e.g., object) for the show. A location identifier 16 can have a variety of forms, and can be provided in the data structure in a number of ways. As a first form, location identifier 16 can comprise a text string or number representative of the desired start time, where the text string or number can indicate a time point in seconds or other division of time, or the frame number of metatrack 12. As a second form, location identifier 16 can comprise a first text string or number representative of the desired start time and a second text string or number representative of the desired end time, where each text string or number can indicate seconds or other division of time, or frame numbers of metatrack 12. As a third form, location identifier 16 can comprise a first text string or number representative of the desired start time and a second text string or number representative of the desired presentation time for the item, where each text string or number representation can indicate seconds or other divisions of time, or in frame number(s) of metatrack 12. As a fourth form, the location identifier 16 can comprise a representation of a sound, word, or phrase of the audio narration at which the corresponding item is to be displayed. During the playing of metatrack 12, the presentation device (an example of which is described below) compares the representation to the audio track to determine when to present the corresponding item. The representation may comprise a digitized sample of a portion of the audio track, an amplitude envelope of the portion of the audio track, a text string of the one or more words in the phrase, or other representation. This form of the location identifier 16 allows the producer to record the narrative of the metacontent track 12 in sections, establish the location identifiers 16 to the narrative, and then to move the sections around in the editing process without having to rework the values of the location identifiers.

Whatever form location identifier 16 takes, it may be provided in the data structure in any number of ways. As a first way, location identifiers 16 may be grouped together in an ordered array of identifiers (e.g., ordered array of numbers, strings, etc.), separate from item identifiers 14, which may be grouped together in their own ordered array. As another way, each item identifier 14 and location identifier 16 for an item may be grouped together in a smaller data-structure unit (e.g., object, or sub-object), and these units may be chained together in a linked list. An additional type parameter 18 may be added to each such unit to indicate the form of the location identifier (e.g., time, phrase, sound, amplitude envelope, digitized sample, etc.), thereby enabling various forms to be readily mixed.

As another way of incorporating the location identifier for a program into a data structure for a metacontent show, the identifier 14 for an item may be embedded into metacontent track 12 at or near the time point in playing span Ts at which the contents of the item are to be presented to the viewer. This embedding is a form of a location identifier, and the embedded location identifier is shown at 16′ in the figure. Many data structures for audio-video formats, such as MPEG-4, are composed of a plurality of data streams, each stream comprising a plurality of data packets with timing marks (e.g., frame numbers, time stamps, etc.). The data packets of these streams are stored in a common file, typically in an interleaved fashion with the data packets of all the streams for the same playing time being grouped near each other in the file. An information header is placed at the front of the common file, and it indicates the number of streams, the structure of the streams' data packets within the common file, and how the streams are to be processed and presented (e.g., played). When a media player opens the common file, the media player reads the header to determine the number of streams, how to identify the data packets for each stream in the file, and how to process the data packets to present the stream to the user. These features of the common file are known to the art, and a detailed explanation thereof is not needed for one to make and use the present inventions. The inventive aspect of one inventive data structure of the present application is that metatrack 12 comprises a streamed common file, and that identifiers 14 are embedded into the streamed common file as a new stream, called the sync-links stream, and that the embeddings provide embedded location identifiers 16′. A definition for the sync-links stream is included in the file's header. As yet another way, some video formats have key frames that enable events to be triggered when the key frame is played. In these formats, a location identifier can be embedded as a trigger of a selected key frame.

The data structure for metacontent show 10 preferably includes a title field 20, a summary field 22, a narrative field 24, an author field 26, a date field 28, and a rating field 30. Title field 20 provides a short textual description of the show which can be displayed in the directory pane of a Metabrowser (described below) to give the viewer a general idea about the content of the show. Summary field 22 is like an abstract of the show, and provides further information about the show; it can be displayed in a Metabrowser upon a request by the viewer. Narrative field 24, when available, provides a transcription of the audio track of the show; it is mainly used to enable robust searching of the content of the metacontent shows in a database, but it can be displayed in a Metabrowser upon request by the viewer. Author field 26 provides the name of the reporter/producer who created the show, and date field 28 provides the date the show was created or uploaded to a database for distribution (this field may include the hour, minute, and second of the date in a given time zone). Rating field 30 provides a rating of the show which is representative of how useful or appealing the viewing public found the show to be. When a metacontent show 10 is uploaded, its rating field 30 may be initially set to an overall rating of the author (which can be readily computed from the existing database of shows), or initially set to a predetermined value (usually in the case of a new author). From there, viewers can be allowed to rate the show as to content, production value, and/or other criteria, and these ratings can be sent to a network-accessible server which adjusts rating field 30 in real time according to a given schedule (such as periodically, or whenever a certain number of ratings are received). As explained below in greater detail, the rating in rating field 30 enables a viewer to filter out shows which do not meet his or her selected rating level.

Each of fields 20-24 preferably comprises a text object and each of fields 26-30 may be a text object or a number object (for example, the author may be assigned a unique index number to a names database). Typically, the contents of the narrative field 24 are not transmitted to the user, but may be transmitted if the user requests it. The fields 20-30 may be indexed by a database containing metacontent show 10 so that a user may be allowed to search the database for keywords, author names, dates, and ratings. Fields 20-30 can be incorporated into the show's data structure in a number of ways known to the art. As another option, some or all of this information may be embedded in metacontent track 12 in the sync-links data stream or in a separate stream (an information stream), which may be read by a Metabrowser, which is described below. Likewise, the item identifiers 14, location identifiers 16, and type parameters 18 may be stored in this information stream, or another information stream.

As a shorthand, the pane in which the metacontent track is played is referred to as the “head pane,” and the pane in which the items of network-accessible information are played is referred to as the “content pane.” In addition, as explained below, a directory pane of metacontent shows can be provided to the viewer to select shows for viewing. In premium embodiments of the present invention, during the playing of a metacontent show, the above panes can overlay one another and can be programmatically moved relative to one another, and may have their size, relative layer position, and translucency programmatically changed. To facilitate this, premium embodiments of metacontent show 10 further comprise a set of event commands 40 that can be used to direct the placement and movement of the panes, and to provide other features. Similar to item identifiers 14, event commands 40 are associated with time respective time points of metacontent track 12. Event commands 40 comprises a command identifier that indicates the event action to be done, a time value that indicates at what time the action is to be done by, and various data parameters. The event commands 40 may be embodied in any convention format, including comma-delimited text strings, and data objects. Table I below provides several exemplary event commands 40, with the data held therein show in comma-delimited form:

TABLE I
Command Identifier, Time point, Parameters . . .

Define Screen, Time=T, Width=X, Height=Y

| | |
|---|---|
| Set Pane, | Time=T, Pane=ID, Position=(X,Y), Size=(W,H), |
| | Layer=Z, Translucency=C |
| Change Pane, | Time=T, Pane=ID, Duration=D, Position=(X,Y), |
| | Size=(W,H), Layer=Z, Translucency=C |

Overlay Pane, Time=T, Pane=ID, Duration=D, Position=(X,Y),

| | |
|---|---|
| | Size=(W,H), Layer=Z, Translucency=C, Display Object |
| Track Pause, | Time=T, Pane=ID, Duration=D, Restart Object |

The first command (“Define Screen”) in Table I defines the screen dimensions on which subsequent commands will be referenced to from time point “T” and onwards. This command is usually given at the beginning (Time=0), but may be omitted if default values have been established. The second command (“Set Pane”) sets the parameters of a pane identified by “ID” to specific values at the time point indicated by value “T” (Time=T). (The head pane, content pane, and directory pane have preferably been pre-assigned respective “ID” values.) The command may set one or more of the following items: the pane's position as specified in the X,Y coordinates of the screen (“Position=(X,Y)”) (the pane's position may be taken at the lower left corner of the pane, or another preset point); the pane's size as specified by width and height in the coordinates of the screen (“Size=(W,H)”); the overlay layer for the pane as preferably specified as a number between 1 and a finite number, such as 16 (“Layer=Z”); and a translucency value as preferably specified as a number between 0 (transparent) and 1 (opaque) (“Translucency=C”). The layer numbers can be designated such that 1 indicates the top layer, the finite number (e.g., 16) indicates the bottom layer, and numbers between indicate intermediate layers. Not all of the parameters need be given by the command. If a parameter is not given in the command, the previous value is used, which may be a default value if the parameter has not been previously set.

The “Change Pane” command changes the values of selected parameters of a pane identified by “ID” starting the time point indicated by value “T” (Time=T), and changes the value to the new values provided by the command over the time duration indicated by value “D” (Duration=D). Each indicated value may be changed in linear increments over time. The pane's position, size, layer number, and translucency may be changed. Not all of the parameters need be given by the command. If a parameter is not given in the command, the value of the parameter is not changed. The “Overlay Pane” command adds a new pane to the video screen (usually temporary) at the time indicated by time “T” for the time duration indicated by duration “D.” A Pane “ID” value is provided so that subsequent command can modify the pane. The position, size, layer number, and translucency of the new pane may be specified in the same manner as indicate above. The contents to be displayed in the new pane is provided by “Display Object,” which may take any number of forms, such as HTML, XAML, MXML, scripts, graphics files, etc, and may include interactive scripts that receive input from the viewer, including commands that define an event that will terminate the display of the pane before duration D has elapsed. The intended use of “Track Pause” command is to pause the playing of the metacontent track in the head pane, but the command may be used to pause the playing or rendering of content in another pane, as identified by the pane “ID.” The command include a duration “D” for the duration of the pause, and an optional Restart Object, which a script or other code that defines an event that restarts the track.

As indicated below, event commands 40 may be read and executed by an event-handling engine in a Metabrowser described below. In addition, the event commands may be embedded within metacontent track 12 in a manner similar to location identifiers 16′. This embedding is indicated at 46 in FIG. 1.

The above embodiments are generally the more preferred embodiments of the metacontent show 10 and data structures therefor. In less preferred embodiments, the identifiers 14, 16, 16′, 40, and 46 may be encoded into the audio and/or video streams directly. For example, selected bands within the video frames (such as at the top or bottom of the frames) may contain the identifiers rather than video content, and the presentation device may be adapted to read the identifiers from these bands. The information in any one of fields 20-30 may be similarly encoded. Also, the location identifiers 16′ may be encoded as tones within the audio stream. A single tone may be used to sequence through the items, the first item being presented in the content pane in response to the first tone, the second item being presented in response to the second tone, and so on. The same may be done for time points 46.

The elements 12-46 of a data structure for a metacontent show 10 can be stored and conveyed in one or more computer-readable media, where a computer-readable medium may comprise ROM, RAM, magnetic tape, magnetic disk, optical discs, carrier waves (such as for Internet downloading), etc. As one way, a data structure may store and transmit all the elements together as a large software object, which can be downloaded in its entirety to a Metabrowser. As a second way, a data structure may store the metacontent track 12 in a separate file that can be accessed by a Metabrowser using a corresponding uniform resource locator (URL), and the remaining elements of the data structure, plus the URL of the metacontent track 12, may be stored and transmitted together as a single software object. In this case, when a Metabrowser requests the metacontent show, the software object is transmitted to the Metabrowser, and the Metabrowser accesses the metacontent track 12 with the provided URL. It may be appreciated that the narrative field may be stored in a similar way (as a URL) since it not always wanted by the viewer. This latter object may be stored and transmitted as any file type known to the art, such as a text file, an XML file, etc. As yet another way, identifiers 14, 16 or 16′, and one or more of the other elements 18-46 may be stored in metacontent track 12 and transmitted to a Metabrowser. Additional ways are possible, and the data structures for the metacontent show according to the present invention are not limited to any particular way.

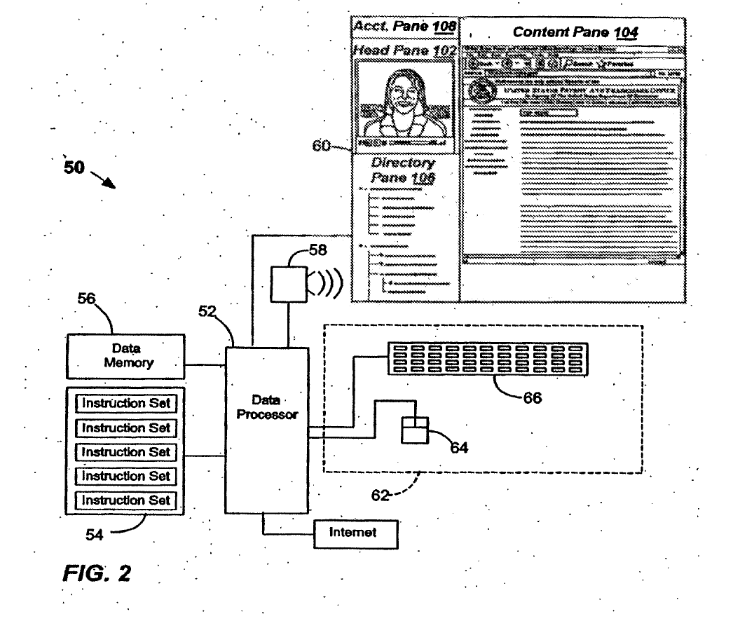

Processor and Instruction Set Basics. Before describing the Metabrowser and Metaproducer inventions of the present application, a brief tutorial description of the personal computer platform and software instruction sets is provided here for those not skilled in the software arts. An exemplary personal computer platform 50 for running Metabrowser and Metaproducer embodiments according to the present inventions is shown in FIG. 2. Computer platform 50 comprises a data processor 52, a display (e.g., video screen) 60 coupled to data processor 52 to provide visual output to a human user (e.g., viewer, producer), an audio output device 58 coupled to the data processor to provide audio to the user, a user interface 62 to receive input text and commands from the user, a data memory 56 for data processor 52, and a plurality of instruction sets embodied on a computer-readable medium 54 (e.g., memory, disc storage, carrier wave, etc.) that direct the processor to conduct various operations, as described below in greater detail. User interface 62 includes a keyboard 66, and preferably a pointer-control device 64, such as a mouse. The pointer-control device sends signals to data processor 52 to control the motion of a pointer on display 60. Data processor 52 has a connection to the Internet. The instruction sets may be downloaded through the Internet as carrier waves to processor 52.

In conventional operating systems such as Microsoft Windows and Apple's Mac OS, several instruction-set groups may be run by separate parallel processes on data processor 52 with the operating system allocating recurring slices of processing time to each of the processes in a multiplexed manner, and providing communication facilities for the processes to communicate with one another. As such, the tasks performed by each instruction-set group may be performed substantially in parallel with the tasks performed by the other instruction-set groups. A main instruction set, sometimes called a wrapper instruction set, generally sets up the parallel processes for the other instruction sets, sets up the inter-process communication facilities for the instruction sets, and sets up the graphical-user-interface (GUI) container, if needed by any of the other instruction sets. Thick-client applications and stand-alone applications sometimes use this approach.

As another general approach, conventional operating systems also enable programmers to run several instruction-set groups under one process, but with the instruction-set groups being handled by respective threads of execution. This enables the programmer to handle the communications between the instruction-set groups within the program's own environment (e.g., by using global data objects and global methods), without relying entirely upon the inter-process communication facilities of the operating system. A main instruction set (e.g., wrapper instruction set) generally sets up the process threads for the other instruction sets, sets up data objects and methods for inter-process communication facilities for the instruction sets, and sets up the graphical-user-interface (GUI) container, if needed by any of the other instruction sets. Thick-client applications, thin-client applications, and Internet-oriented applications generally use this approach. In addition, many Internet browsers, which are thin-clients, mirror this approach in the facilities they provide for plug-ins and downloaded scripts (which are instruction sets). These browsers act similarly to the main instruction set when setting up and configuring plug-ins, and have script engines that can execute separate scripts in parallel in a manner similar to having several process threads. These browsers also have API instruction sets which enable scripts and plug-ins to communicate with the browsers. In addition, plug-ins like Adobe Flash Player and Microsoft Silverlight have their own runtime environments that support the creation of objects to handle various tasks, and further support communications among objects and instruction sets through object method calls.

The allocation of instruction-set groups to respective processes or process threads enables one to use commercially-available “stock” programs and plug-ins to implement some of the instruction-set groups. Many commercially available media players, such as Microsoft Windows Media Player, and Internet browsers, such as Microsoft Internet Explorer, can operate as stand-alone processes on a personal computer, interfacing with the operating system to receive mouse commands and keystrokes from the keyboard when the media player is selected as the active window. In addition, these media players, Internet browsers, and other software programs (such as text editors), also include application program interfaces (APIs) that enable a programmer to write a program that starts an instance of the software program running on a respective process or thread, and thereafter controls the operation of the media player by providing commands and inputs to the software-program instance through the API. In both cases, the software program comprises instructions that direct data processor 52 to perform various tasks. The APIs of these software programs provide several command instructions that a programmer can invoke from a number of programming languages (e.g., C++, Java, Visual Basic, etc.). To use the media player in this dependent manner, the manufacturer typically provides a dynamic-link library (DLL) or script-language interface which comprises the instruction sets for directing the data processor to implement the software program and the APIs. The programmer creates an instruction-set group having API command instructions (such as through an editing and compilation process), and then assembles the instruction-set group with the DLL or the script-language interface of the software program to create a complete application program.

The IPTV platform (Internet Protocol Television platform) is similar to the personal computer platform, and can run thick-client, thin-client, and Internet-oriented applications. The Web TV platform (or Internet TV receiver) is somewhat more restricted in functionality when compared to the personal computer platform, and can generally run thin-client and Internet-oriented applications (e.g., Java applications, rich-Internet applications, RIAs, AJAX applications, etc.). In addition, set-top boxes (like Microsoft's IPTV edition and Apple's iTV) have functionality similar to the personal computer platform. Thus, the above tutorial descriptions generally apply to the IPTV and Web TV platforms, and to set-top boxes (STBs). It may be appreciated that some computer platforms may comprise two or more processors that are coupled together to effectively act as a single data processor. It thus should be appreciated by readers and the courts that when reference to a single data processor is made herein, that the reference and the claims also cover cases where multiple data processors are so coupled together.

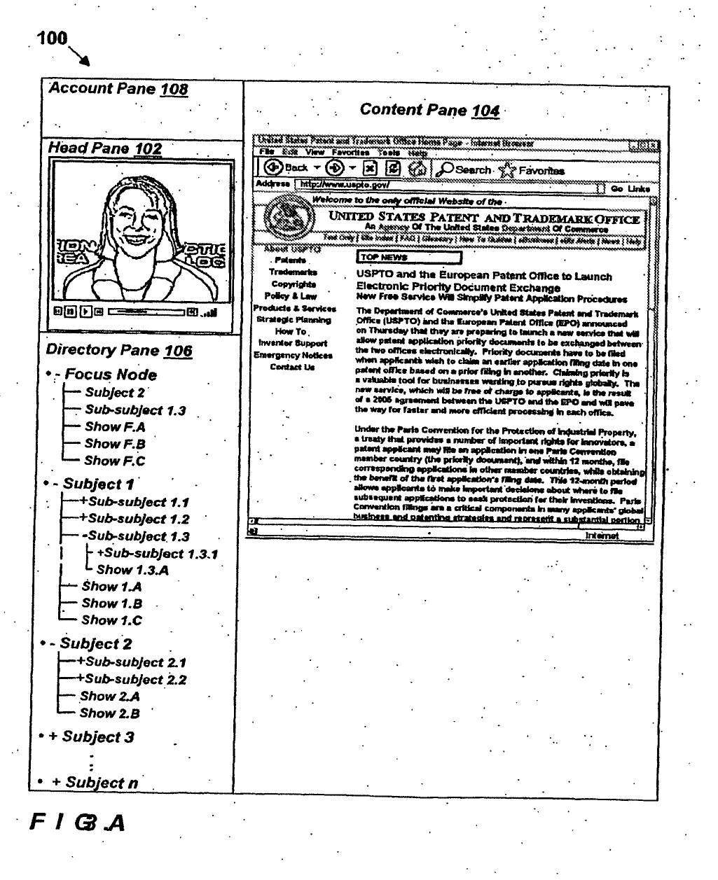

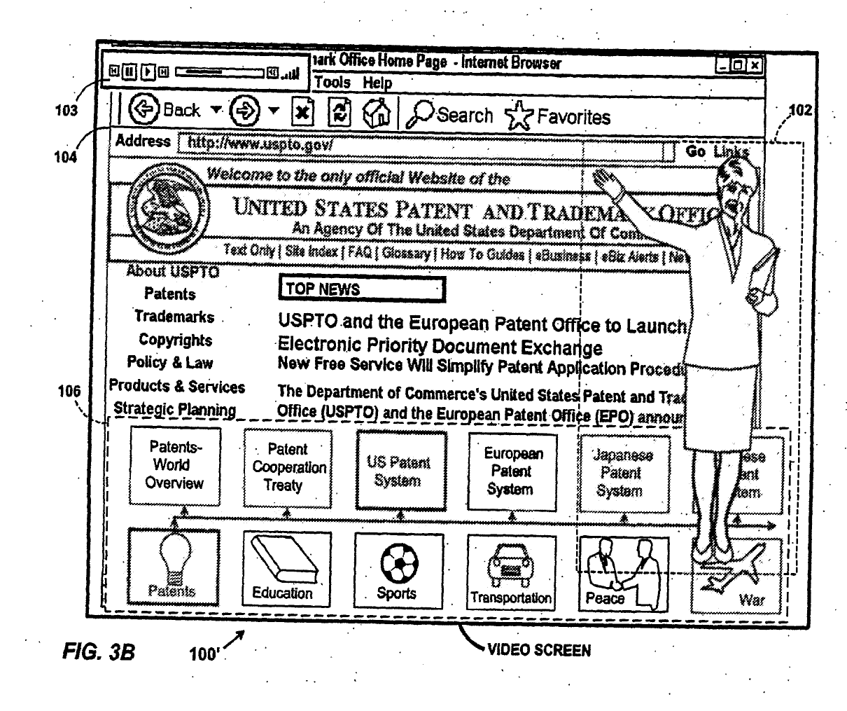

Metabrowser. A first exemplary Metabrowser 100 according to inventions of the present application is illustrated in FIG. 3A. Metabrowser 100 is a presentation application that plays metacontent shows to a user on demand on a video screen by directing a local data processor to perform various tasks, as described below. Metabrowser 100 comprises a head pane 102, a content pane 104, and a directory pane 106, each of which are software elements implemented by one or more computer instruction sets (e.g., handlers) that direct the local data processor. Metacontent track 12 (e.g., an audio-video narrative) is displayed in head pane 102 while the show's sync-linked items are displayed in content pane 104, which is preferably located under head pane 102 or next to head pane 102. The sync-linked items are displayed at the appropriate time (i.e., when the playing time of the metacontent track is at or within the corresponding location of the item), thus producing an intelligent browsing experience for the user. Metacontent shows 10 are organized by subject (topic) and sub-subject (subtopic), and displayed in directory pane 106. The metacontent shows 10 are typically stored in one or more databases, which also store the structure of the subjects and sub-subjects by which the metacontent shows 10 are listed. Directory pane 106 is adapted to receive a directory structure for the shows, and to display, according to the directory structure, the subjects and sub-subjects from which the user may select metacontent shows 10 for presentation. Directory pane 106 is further adapted to receive a selection by the user of a metacontent show 10 to view, which is then played in head pane 102 and content pane 104. The latter aspect of directory pane 106 can be implemented by an interface control (a computer instruction set) that receives the user input, and instruction sets that instruct the handler for head pane 102 to play the metacontent track of the selected metacontent show and the handler for content pane 104 to present the contents of the show's items of network-accessible information.

In preferred embodiments of Metabrowser 100, the subjects of directory pane 106 are presented as directory nodes, each with the name of its corresponding subject, which can be expanded to show their sub-subjects as child nodes when clicked on, and can be subsequently collapsed when clicked on again. To facilitate recognition of this input feature to the user, a “+” symbol may be displayed next to the subject's name to indicate that the subject is in collapsed form and can be expanded, and a “−” symbol can be displayed next to the subject's name to indicate that the subject is in expanded form and can be collapsed. All of the subjects work this way, as well as each subject's sub-subjects. When clicked and expanded, each subject or sub-subject offers the latest shows for the subject or sub-subject, plus the subject's or sub-subject's child nodes. When any of these sub-subjects (child nodes) is expanded, it too offers the latest shows followed by its own children, if any. Performing a right click (e.g., a middle-finger mouse click for left-handed mouse users) on a subject node allows the structure of the subject node to be viewed as a tree-view in content pane 104, where further information about each subject and each metacontent show can be presented to give the user more information. To watch a particular metacontent show, the user can double-click on the show's title and watch it. Each of these interactions can be implemented by a corresponding interface control adapted to receive user input to do the requested action and to direct the data processor to perform the corresponding tasks. (An interface control may be implemented by a corresponding instruction set.) These interface controls, which pertain to navigating around directory pane 106, are generally associated with directory pane 106. In the example shown in FIG. 3A, directory pane 106 is organized as a simple tree-view where each subject is its own node, and allows the viewer (e.g., consumer) to browse the various subjects and sub-subjects for metacontent shows, and to choose metacontent shows to view immediately.

In further preferred embodiments, Metabrowser 100 enables a viewer to establish a personalized focus node in directory pane 106, which is a root node, and to establish subscriptions to a plurality of subjects and sub-subjects, which are then accessed and played from the focus node. To establish a subscription to a particular subject or sub-subject, the viewer clicks onto the desired subject or sub-subject with the Shift key of the keyboard depressed, at which point a shadow duplicate of the subject or sub-subject will appear in directory pane 106, and the viewer drags the shadow duplicate to the focus node and drops it, at which point a copy of the desired subject or sub-subject is added to the focus node. The subjects and sub-subjects in the focus node may be moved around to establish a desired order from top to bottom in the focus node. The subscriptions can be stored in a file, cookie, or other equivalent data structure, located on the viewer's local computer, or in a personal account established on a network-accessible server. When the user clicks on the focus node, Metabrowser 100 accesses one or more network-accessible databases to assemble the newest metacontent shows for the subjects and sub-subjects for which subscriptions have been established, and begins to play these in the subject order established under the focus node (in other words, the latest shows for the top subject or sub-subject listed in the focus node are played, followed by the latest shows for the next subject or sub-subject listed in the focus node, and so on). The latest shows may be defined as the shows that have been added to the one or more databases within a preset time (such as 24 hours). In addition to clicking on the focus node, a viewer can click on a subject or sub-subject under the focus node to have the latest shows from that subject or sub-subject played. Also, Metabrowser 100 can be configured to start playing the latest shows in the focus node upon being started up by the user.

As indicated above, as one option, the viewer's subscriptions for the focus node can be stored in a personal account established on a network-accessible server. To facilitate this, further embodiments of Metabrowser 100 may comprise an account pane 108 that contains a software interface control that enables the user to bring up a webpage in content pane 104, which in turn enables the viewer to set up an account. Another software interface control enables the user to login into his or her account, and another software interface control enables the user log out of his or her account. When the viewer is logged in, Metabrowser 100 is able to access the server to obtain the viewer's list of subscriptions, and to thereafter present the latest shows of the subscriptions to the viewer. Metabrowser 100 can be configured to start playing the latest shows of the viewer's focus node in response to the viewer logging in, which may be done automatically.

Head pane 102, content pane 104, and directory pane 106 may be displayed separately from one another on the video screen, or one or more panes may partially or entirely overlay portions of other panes, where each overlaying pane may have a selected degree of translucency from transparent to completely opaque. During the playing of a metacontent show, the panes may be programmatically moved relative to one another, and may have their size, relative layer position, and translucency programmatically changed. In addition to programmatic movement of the panes, the user may also move the panes, change their layer position, change their size, and/or change their translucency. (The Metabrowser may include various software controls to effect this user control.) For example, head pane 102 may initially overlay portions of content pane 104 and directory pane 106 with a selected degree of translucency, and may then move over other portions of panes 104 and 106 during the playing of the metacontent track. (The playing controls associated with head pane 102 may move with head pane 104, or may be placed in a fixed location.) This enables a metacontent show to provide a seamless visual integration of the head and content panes, and enables a spokesperson in the head pane to move about the content pane to point out aspects of the contents currently displayed in the content pane. To provide further seamless visual integration, the video portion of the metacontent track may be provided as a video that only shows the form of the spokesperson. This may be accomplished by video-recording the spokesperson in front of a blue or green background screen, and thereafter processing the video track to render the visible areas of the screen transparent. When this processed video is superimposed over (or “laid over”) the content pane, the content pane can be seen through the transparent portions of the head pane's video track. As a further example to of this, directory pane 106 may have its subjects and sub-subjects displayed in icon form, and located below content pane 104 or to one side of content pane 104.

An example of this is shown by a second exemplary Metabrowser 100′ in FIG. 3B. In this configuration, content pane 104 occupies substantially all of the video screen area that is allocated to the metabrowser, directory pane 106 is disposed at the lower portion of the video screen and overlays the bottom portion of content pane 104, and head pane 102 is disposed at the right side of the video screen and overlays both of content pane 104 and directory pane 106. Head pane 102 and directory pane 106 are shown with an opacity of fully opaque (to meet patent office requirements), but each pane may have a translucency that is different from fully opaque. Head pane 102 shows a spokeswoman (speaker) pointing to features on content pane 104. Head pane 102 can move about content pane 104 so that the spokeswoman can point to various aspects on the content pane. The player controls for the head pane may move with the head pane, or may be located at a fixed location on the video screen, as is shown at 103 in FIG. 3B. As indicated above, a metacontent show can include event commands 40 to indicate the locations of the panes relative to one another, their layer order, and their translucency as a function of the playing time of the track. Metabrowser 100′ includes an event engine that reads event commands 40 and the playing time of the show's metacontent track 12, and sends messages to the handlers for the panes instructing them on the location, size, and translucency of the panes. The event engine is typically separate from the pane handlers, but may be located with any of the pane handlers, such as the hander for head pane 102 when the event commands are embedded within metacontent track 12. Directory pane 106 shows two rows of icons. The lower row shows the subjects (Patents, Education, Sports, Transportation, Peace, War), and the upper row shows the metacontent shows and sub-subjects of a selected subject along the upper row. In the example, the user has selected the Patents Icon, and the metacontent shows for that are shown in the upper row (Patents—World Overview, Patent Cooperation Treaty, U.S. Patent System, etc.). Additional layers of sub-subjects can be displayed as additional rows, which may be accessed by allowing the user to scroll upwards along the rows of icons. Also, the view may access additional subjects along a row by scrolling the row to the left or right. These scrolling operations can be implemented by corresponding software controls, which can be configured to accept any type of user input command to effect the scrolling operations.

Metabrowser 100′ may be implemented in Flash and Silverlight in the following general manner, with it being understood that several different implementations in these plug-ins are possible. A Flash Player or Silverlight player is started as a plug-in to the browser, and the plug-in sets up a runtime environment within the browser. The plug-in then sets up handlers for each of the panes, and optionally an IFrame for content pane 104. In addition, the graphics display engine for the plug-in is configured to assign the panes to respective display layers to allow the panes to be overlaid in a desired manner (typically the head pane is the top layer, the directory pane is the middle layer, and the content pane is the bottom layer). In one implementation, the object handler for content pane 104 receives indications of which web pages are to be loaded, and instructs the Internet browser by message to load the indicated web pages. In this case, the plug-in configures itself as an overlay to the internet browser, which sets the content pane 104 as the bottom layer, and preferably sets up an IFrame in the browser for content pane 104, and instructs the browser to render the indicated web pages in the IFrame. As described below, a sync-links engine is preferably used to provide indications of the web pages to be shown in content pane 104. The handler for content pane 104 preferably has an object method that can be called by the sync-links engine, or other instruction sets (such as the event engine described below), to provide the handler with an indication of which web page or file to load. As another approach of displaying content pane 104, the handler for content pane 104 can include software to display the web pages itself on the screen, and may provide many of the navigational features of an Internet browser. In this case, the handler for content pane 104 assembles the graphical information to be displayed, and provides the information to the plug-in's graphics display engine to display on the video screen at a selected layer level and selected degree of translucency.

The handler for directory pane 106 can comprise a set of simple graphical-user-interface controls that operate over a selected area of the display screen, and are generally described below in greater detail. The handler for directory pane 106 typically assembles the graphical information to be displayed, and provides it to the plug-in's graphics display engine to display on the video screen at a selected layer level and selected degree of translucency.

The handler for head pane 102 can include instructions that read the metacontent track, that provide frames of audio and video to the plug-in's graphics display engine to be displayed on the video screen at a selected layer level and selected degree of translucency, and that generate a playing time indication (e.g., current frame number) that can be accessed by the sync-links engine and the event engine. The handler for pane 102 can also include software controls to display the play buttons (103 in FIG. 3B) for head pane 102 on the video screen. Also, the handler includes an object method call to enable the sync-links engine (and/or the event engine) to obtain the current playing time of the metacontent track, and an object method call to enable the handler for directory pane 106 or another instruction set to provide it with an indication of the metacontent track to play. The current playing time indication can be generated by multiplying the current frame number by the display period for a frame (i.e., the inverse of the frame rate), or can be generated by obtaining current time from the computer's system clock at the start of the metacontent track, and by periodically subtracting this value for the current time of the clock to generate a value for the current playing time. In this case, the method also includes obtaining the clock's current time when the pause button is pressed, computing the playing time up until the pressing of the pause button, and then restarting the process again with the previous playing time added to the current playing time.

The event engine, when used in premium embodiments of the present inventions, reads the show's event commands 40, and sends messages to the pane handlers and the plug-in's graphics display engine at appropriate time points in the playing time to effect the changes in the pane parameters indicated by the event commands. An embodiment of this is described below in greater detail.

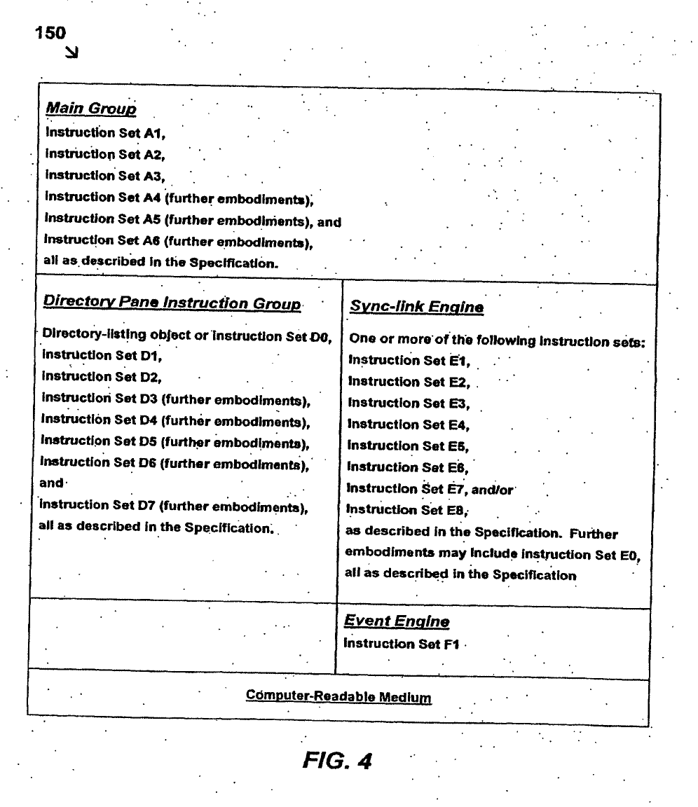

Exemplary instruction sets for Metabrowser 100 can be implemented in any known code forms, including scripts and plug-ins, and may be implemented on a personal computer, IPTV receiver, Internet TV receiver, and the like. In one preferred embodiment, Metabrowser 100 is implemented as a Flash or Silverlight application loaded by accessing a particular uniform resource locator with a browser over the Internet (which has been advertised, or otherwise made available, to the public, e.g., www.wayv.com). The Flash or Silverlight application may then initiate the downloading of additional script, data, XAML/MXML, code, and content files, some of which may include portions of metacontent shows. FIG. 4 shows an exemplary implementation of Metabrowser 100, in the form of a computer-program product 150. Product 150 is provided on a computer-readable medium that is downloaded into an Internet browser as a Flash or Silverlight application. Product 150 interacts with the Internet browser and directs it to perform various tasks, which in turn are accomplished by directing data processor 50 to perform various tasks. Product 150 can use the Internet browser itself to render webpage content for content pane 104, while handling itself the implementation of head pane 102, directory pane 106, and optionally the account pane 108. The Internet browser has an API interface that enables product 150 to access information about the browser and to control various aspects of the browser's operation. As indicated above, plug-ins like Flash Player and Silverlight establish run-time environments within the Browser, and can be configured to use object handlers (such as written in instructions or scripts) to handle each of the panes. The object handler for head pane 102 acts as a media player for the metacontent tracks displayed in the head pane. Product 150 comprises a main control that comprises:
(A1) an instruction set that directs Flash Player, Silverlight, or other equivalent application to allocate a screen area for the panes, passing user input in this area to the main control; to allocate processing time to the instruction sets of product 150; and to enable communications between the Internet browser and the instruction sets of product 150. In preferred embodiments, these instructions set up an IFrame or div tag in the Flash Player or Silverlight for content pane 104, and direct the browser to render web-page code (e.g., HTML, XML) in that IFrame or div tag.
(A2) an instruction set to start an instance of a media player to implement head pane 102, where the media-player instance is controllable through a respective application program interface (API). This media player may be a plug-in provided by a software company (e.g., Windows Media Player, Flash Player, Silverlight, etc.), or a customized plug-in available from the server from which product 150 is downloaded, and need not be part of product 150.
(A3) an instruction set to handle user inputs provided to the main control by Flash Player, Silverlight, or other equivalent application, and to pass the inputs to the instruction sets implementing the head pane (e.g., media player) and/or the directory pane (these instruction sets are described below).
   In preferred embodiments, these instruction sets (along with other instruction sets described below) can be provided in the form of HTML, XAML, MXML, Actionscript, C#, Visual Basic, or any other .NET language, to configure the Internet browser and establish a plug-in instance of Flash Player or Silverlight to implement the panes with object handlers, as described above. In a less preferred way, which follows conventional AJAX programming methods, the above instruction sets (along with other instruction sets described below) can be provided in the form of HTML instructions that direct the browser to create one or more IFrames for panes 102, 106 and 108, and script instructions (e.g., Java-Script) that direct the browser to load any needed plug-ins, to start the instance of a media player for the head pane, and to set up the input handling and communications between software components.

For directory pane 104, computer-program product 150 comprises a data object holding a directory listing of metacontent shows or an instruction set D0 that directs data processor 50 to request and receive a directory listing of metacontent shows from one or more network-accessible database servers. Product 150 further comprises:
(D1) an instruction set that directs data processor 50 to display the listing in the screen area for directory pane 104.
(D2) an instruction set that directs data processor 50 to receive user input to play a selected metacontent show 10, to access a database to obtain a data object for the selected metacontent show 10, to send a message to the media player for head pane 102 (which may be sent through an API or object method call) instructing the media player to access the file for the show's metacontent track 12 and start playing the track, and to send a message to a Sync-links engine (described below) with the show's identifiers 14, 16, and type parameters 18, if these components are not embedded in the metacontent track. In premium embodiments of the present inventions, this instruction set also directs data processor 50 to obtain the show's event commands 40 and to send a message to the event engine to start the processing of command events 40. As described in greater detail below, in premium embodiments of the present inventions, the sync-link engine, or a portion thereof, may be implemented by the event engine.
   The directory pane instructions may be run by the main control element or as an entity (e.g., directory handler) under the main control element or a plug-in (such as the case when Flash Player or Silverlight is used). In some implementations, the portion of instructions of set D2 which accesses the data object for the selected metacontent show may be done in tandem with instruction set D0, where the directory listing includes URLs to the metacontent tracks of the shows in the directory listing. Instruction sets D0-D2 can be written by one of ordinary skill in the software arts without undue experimentation in view of this disclosure. The sync-links engine can comprise one or more of the following instruction sets:
(E1) an instruction set that directs data processor 50 to monitor the playing time of the media player implementing head pane 102, and to send a message to the handler for content pane 104 instructing it to load the item identified by each identifier 14, as received from instruction set D2, when the playing time of the media player is at or within the location for the item, or a second or so beforehand (e.g., two seconds beforehand, or some other preset time duration to account for the browser's delay in fetching the page). The playing time can be monitored by periodically sending a request message to the player (such as through the player's API or object method call) requesting the current playing time (this may be done by requesting the player's status object, or by an object method call). More preferably, the monitoring can be done by sending a request message to get the current playing time before the item is to be loaded into the content page, and computing a time duration between the time point when the item is to be displayed and the current time. The instruction set may then wait this computed time duration (such as by setting a software countdown interrupt), and then send the message to load the item when the duration has elapsed. If the handler for content pane 104 is the Internet browser, the message to load the item may be sent through the browser's API. If the handler is an object in Flash Player or Silverlight, the message may be sent by an object method call. In premium embodiments of the present inventions, this instruction set may be implemented by the above-described event engine, where the sync-links are treated like command events. An exemplary instruction set for the event engine is described below.
(E2) an instruction set that directs data processor 50 to decode the sync-links stream from the metacontent track 12 for identifiers 14 and 16′ to items of network-accessible information, and to send a message to the handler for content pane 104 instructing it to load the item identified by each identifier 14, the message being sent substantially at the time indicated by the embedded location identifier 16′, or a second or so beforehand (e.g., two seconds beforehand, or some other preset time duration to account for the browser's delay in fetching the page).
(E3) an instruction set that directs data processor 50 to detect key-frame trigger events for identifiers 14 from the metacontent track 12, and to send a message to the handler for content pane 104 instructing it to load the item identified by each identifier 14, the message being sent substantially when the trigger event occurs.
(E4) an instruction set that directs data processor 50 to compare the audio track for a match to one or more previously digitized samples of the audio track, each previously digitized sample being provided as a location indicator 16 and being associated with a corresponding item identifier 14, and when a match to a digitized sample is found, to send a message to the handler for content pane 104 instructing it to load the item identified by the corresponding item identifier 14.
(E5) an instruction set that directs data processor 50 to compare the audio track for a match to one or more amplitude envelopes previously made from the audio track, each amplitude envelope being provided as a location indicator 16 and being associated with a corresponding item identifier 14, and when a match to an amplitude envelope is found, to send a message to the handler for content pane 104 instructing it to load the item identified by the corresponding item identifier 14.
(E6) an instruction set that directs data processor 50 process the audio track through a voice-recognition engine that generates a stream of text words representative of the narrative words spoken in the audio track, to compare the stream of text words for a match to one or more phrases previously associated with corresponding item identifiers 14, each phrase being provided as a location indicator 16, and when a match to a phrase is found, to send a message to the handler for content pane 104 instructing it to load the item identified by the corresponding item identifier 14. Stock voice-recognition engines are commercially available, and are provided with corresponding API instruction sets that enable the voice-recognition engines to be controlled by other instruction sets.
(E7) an instruction set that directs data processor 50 to compare the audio track for a match to one or more preset durations of sound tones or silence, each such duration being previously associated with corresponding item identifiers 14, and when a match to a preset duration is found, to send a message to the handler for content pane 104 instructing it to load the item identified by the corresponding item identifier 14. The present durations may be predefined, or definitions thereof may be provided as location indicators 16.
   In each of instruction sets E1-E7, if the handler for content pane 104 is the Internet browser, messages to it may be sent through the browser's API; if the handler is an object handler in Flash or Silverlight, messages may be sent by an object method call. Each of instruction sets E1-E7 can be written by one of ordinary skill in the software arts without undue experimentation in view of this disclosure. Instruction set E1 is typically implemented as its own entity running under the main control of product 150, but can be implemented with the instructions for directory pane 106 (the directory handler), or as a wrapper that encapsulates the media player of head pane 102. Each of Instruction sets E2-E7 can be implemented as a wrapper that encapsulates the media player for head pane 102, or as a separate entity, that reads the metacontent track in parallel with the media player of head pane 102 (which can be done through a common buffer for the metacontent track), and that sends the messages to the Internet browser to load items into content pane 104. In this implementation, the monitoring instructions of instruction set E1 may be added. Another way of implementing Instruction sets E2-E7 is to include them in a customized plug-in media player, which is started by the Internet browser. (In such a case, each of Instruction sets E2 and E3 can be included into the media player by modifying the code to include these instruction sets so that they can be involved in the parsing of the data streams; and each of Instruction sets E4-E7 can be included by modifying the code to include these instruction sets so that they can access the digitized values of the audio track.) Thus, instead of having instruction sets E2-E7, computer-program product 150 may comprise an instruction set E8 that directs the Internet browser to load the customized plug-in media player, which can send messages to the Internet browser to load the items specified by identifiers 14.

To implement the event engine in premium embodiments, computer-program product 150 can comprise instruction set F1 that is adapted to direct the data processor to read the show's event commands 40, to monitor the playing time of the metacontent track, and to send messages to the pane handlers and the plug-in's graphics display engine at appropriate time points in the playing time to effect the changes in the pane parameters indicated by the event commands. To do this, instruction set F1 can direct data processor 50 to periodically obtain the current playing time of the show's metacontent track 12 in head pane 102 to determine when to send the messages. However, this approach uses more of the resources of data processor 50 than needed. In preferred embodiments, instruction set F1 direct data processor 50 to process the event commands 40 that are to occur within the first several milliseconds of the metacontent track (these event commands usually configure the panes before playing). Then, instruction set F1 directs data processor 50 to processes each subsequent event command one at a time, using the following steps: (1) read the next event command 40; (2) create a timer event for sending a message to the appropriate pane to effect the event command, wherein the timer event is set to fire (expire) at a fixed time duration from its creation; (3) wait for the timer event to fire (this can be done with low impact on processor 50; and (4) send the message when the timer event fires (expires), and reiterate these steps to process the next event command. The fixed time duration of the timer event can be computed as the difference between the time point when event is to occur and the time point when the timer event is created, both time points being related to the playing time of the metacontent track. The timer event may be set as a countdown interrupt, and the event engine may “sleep” during the countdown, and then be woken up by the interrupt. This minimizes the impact on processor 50's resources. Instruction set E1 for the sync-links engine may be incorporated with instruction set F1, where the sync-links normally processed by instruction set E1 are treated like command events.

To handle the “Overlay Pane” event command, instruction set F1 can be further adapted to direct the data processor to create a new pane handler to handle the overlay pane (which can be done when the timer event for the command is created), and to pass the configuration parameters and display object to the newly created handler for rendering when the event timer for the command expires. The display object may include a software object to receive user input and to terminate the overlay pane before the time duration indicated by the “Overlay Pane” event command. This software object is executed by the data processor to terminate the overlay pane. To handle the “Track Pane” event command, instruction set F1 can be further adapted to direct the data processor to send a message to the handler of the identified pane to pause the track when the event timer for the command expires. The message can include a software restart object that instructs the handler on when or what conditions to restart the track. This software object is executed by the data processor to restart the track.

To implement the features of the directory pane and the above-described focus node in further preferred embodiments of Metabrowser 100 and computer-program product 150, the instructions for directory pane 106 can further comprise the following instruction sets:
(D3) An interface control (e.g., instruction set) that directs data processor 50 to receive user input (e.g., right-click, or middle-finger mouse click for left-handed mouse users) to display a selected subject node in the content pane and to display the contents of the selected subject node in the content pane. In the case that the Internet Browser handles the content pane, this interface control may direct the data processor to create a representation (e.g., file or object) of a tree-view of the selected subject node, and to send a message to the API of the Internet Browser instructing the Internet Browser to load the created file. In the case that a Flash object or Silverlight object handles the content pane, this interface control can send the representation to the object using an object method call. In turn, the handler may pass the file to an IFrame of the browser for rendering, or may have the file rendered within the plug-in environment.
(D4) an interface control (e.g., instruction set) and additional instructions that directs data processor 50 to receive a user input requesting the latest metacontent shows for a selected subject or sub-subject, to request and receive one or more listings from one or more databases of new metacontent shows within a preset period of time for the selected subjects or sub-subjects, and to display the one or more listings under the selected subjects or sub-subjects in directory pane 106.
(D5) an instruction set to create a data object for the focus node and an interface control (e.g., instruction set) that directs data processor 50 to receive user input (e.g., drag and drop) to establish a subscription under the focus node to a particular subject or sub-subject.
(D6) an interface control (e.g., instruction set) and additional instructions that directs data processor 50 to receive a user input requesting the presentation of the latest metacontent shows of the focus node, to request and receive one or more listings from one or more databases of new metacontent shows within a preset period of time for subjects and sub-subjects established under the focus node, and to display the one or more listings under the focus node in directory pane 106.

In further preferred embodiments, each of Metabrowsers 100, 100′ and product 150 further comprises a software interface control (instruction set D7) that presents the user with the option of establishing an interest level for a subscription. This may be presented to the viewer in the form of a moveable slide bar, which ranges through a plurality of numbers, such as 1 through 10. When an interest level is established, only those metacontent shows whose ratings satisfy the user's interest level are presented in the focus node. Once the software interface control (instruction set D7) receives an interest level for a particular subscription from the viewer, it can send it to the server holding the personal account information of the user (if an account has been established), or it can store it in a cookie, file, or similar data structure on the viewer's local computer. Then, when directory pane 106 constructs the tree view of the subscriptions and shows of the focus node (instruction sets D6), it sends a request to the database server with the interest levels that have been established, and the database server only sends a listing of those latest shows whose rating fields 30 satisfy the viewer's interest level. If an interest level has not been established for a subscription, the server returns all of the latest shows for that subscription. The interest level can be configured as a qualification level, which means only those shows whose ratings are at or above the established interest level are shown. The interest level can also be configured to reflect the viewer's interest in the subject of a subscription, with the highest interest level indicating that the viewer wants to view all shows in a subscription regardless of rating, and the lowest interest level indicating that the viewer only wants to view the highest rated shows. In this regard, the interest level and the rating field 30 are inversely related. As an example, if both the interest level and the value of the rating field 30 range on a scale of 1 to 10, the shows having a rating field 30 with a value equal to or greater than the quantity (11—interest level) would be played to the user. Either way, only those metacontent shows of a subscription whose ratings satisfy the viewer's interest level for the subscription are shown.

The subjects listed in directory pane 106 can be stored on different servers. In which case, directory pane 106 can be configured to consult a main server to obtain information indicating where each subject is stored (instruction sets D1, D3, and D4). Directory pane 106 can then access servers to obtain the directory structure of each subject (that is, the various sub-subject nodes), and listings for at least some of the shows of the subject (such as the latest shows) (instruction sets D1, D3, and D4). Each listing for a show includes its title, which gives the viewer an idea of what the show is about, and at least a unique identifier which allows various elements of Metabrowser 100 to access the show's data structure stored in the database (instruction sets D2-D6). In some implementations, the listing may include the URL to the show's metacontent track 12, as well as the sync-link identifiers 14 and 16. Typically, the fetching of information of the subjects' directory structure and the listing of the shows can be done on an incremental basis to decrease response time and reduce the amount of information transmitted and processed. For example, the directory structure of a subject or sub-subject and the listing of shows there under can only be sought from the database servers when the viewer click on the subject or sub-subject to expand it. This incremental approach can be readily handled by Flash, Silverlight, and AJAX programming techniques. Instruction sets D1-D7 can be written by one of ordinary skill in the software arts without undue experimentation in view of this disclosure.

Further Metabrowser Features. In further preferred embodiments of Metabrowser 100, the playing of the metacontent track is paused when the user clicks on a hyperlink displayed in content pane 104. The metabrowser computer program product 150 can further comprise an instruction set A4 in the main control that directs data processor 50 to detect an activation of a hyperlink in the content pane 104, and to send a message to the media player (e.g., pane handler) that implements head pane 102 instructing it to pause the playing of the track. To detect the activation of the hyperlink, instruction set A4 can send an initial message to the Internet browser or plug-in handler to set a trap for hyperlink activation that generates a message to the main control, and/or to the rest of the instructions of set A4. Instead of doing this for the activation of hyperlinks in Content Pane 104, instruction set A4 may be configured to direct data processor 50 to detect any mouse click in the Content Pane 104 and to send the pause message to the media player in response. The metabrowser computer program product 150 can further comprise an instruction set A5 in the main control that directs data processor 50 to detect entry of a new URL in the address box of content pane 104, and to send a message to the media player (e.g., pane handler) that implements head pane 102 instructing it to pause the playing of the track. To detect the entry of the new URL in the address box, instruction set A5 can send an initial message to the Internet browser to set a trap for the entry that generates a message to the main control, and/or to the rest of the instructions of set A5. Each of instruction sets A4 and A5 can further comprise instructions that direct processor 50 to pause the execution of instruction sets E1 and F1 if they are active. These instructions enable the user to pause the presentation of the metacontent track while he or she browses the item and drills down to get more information. These instruction sets can be constructed by those of ordinary skill in the software art without undue experimentation in view of the present disclosure.

Once the user is finished browsing in the content pane, he or she may return to the presentation of the metacontent track by clicking on the play button of the media player instance. In preferred embodiments, head pane 102 further comprises an instruction set A6 that directs data processor 50 to detect the clicking of the play button, and in response, instructs data processor 50 to resume the execution of instruction sets E1 and F1, if they had been previously active prior to the pause in play, and to instruct instruction sets E2-E7 to cause the reloading of the current information item. To detect the activation of the play button, instruction set A6 can send an initial message to the media player to set a trap for the clicking of the play button, where the trap generates a message to the main control, and/or to the rest of the instructions of set A6. The construction of these instruction sets can be done by those of ordinary skill in the software art without undue experimentation in view of the present disclosure.

Pre-Fetching items. Further embodiments of Metabrowser 100 and computer-program product 150 obtain the contents of the information items of a show before the items are to be displayed to the user. The contents of an item may be obtained a second or so before it is to be displayed, and the contents of several items (at least two or more) may be obtained at a playing time of the metacontent track which is prior to the times indicated in the items' location identifiers. The first feature may be implemented by incorporating a pre-fetch offset time into the sync-link engine, which would comprise few additional instructions to the instruction sets of the engine. The first and second features may be implemented in product 150 by including instruction sets within the Internet browser to establish a plurality of buffers to hold the contents of respective web pages (e.g., items), and when receiving a command to load a requested page, to first check the buffers for the requested page before accessing the Internet to obtain the requested page. The API instruction sets for the browser would be modified to include instructions that would receive a request to load the requested pages into their respective buffers. Then, each of the sync-link instruction sets E1-E7 can include a further instruction set that directs data processor 50 to send a message to the Internet browser instructing the browser to load one or more items identified by identifiers 14 in respective buffers prior to the times indicated in the items' location identifiers. This instruction set is denoted as Instruction Set E0 in FIG. 4. The construction of these instruction sets can be done by those of ordinary skill in the software art without undue experimentation in view of the present disclosure. The message described above may be sent though an API call or object method call, depending upon the software implementation.

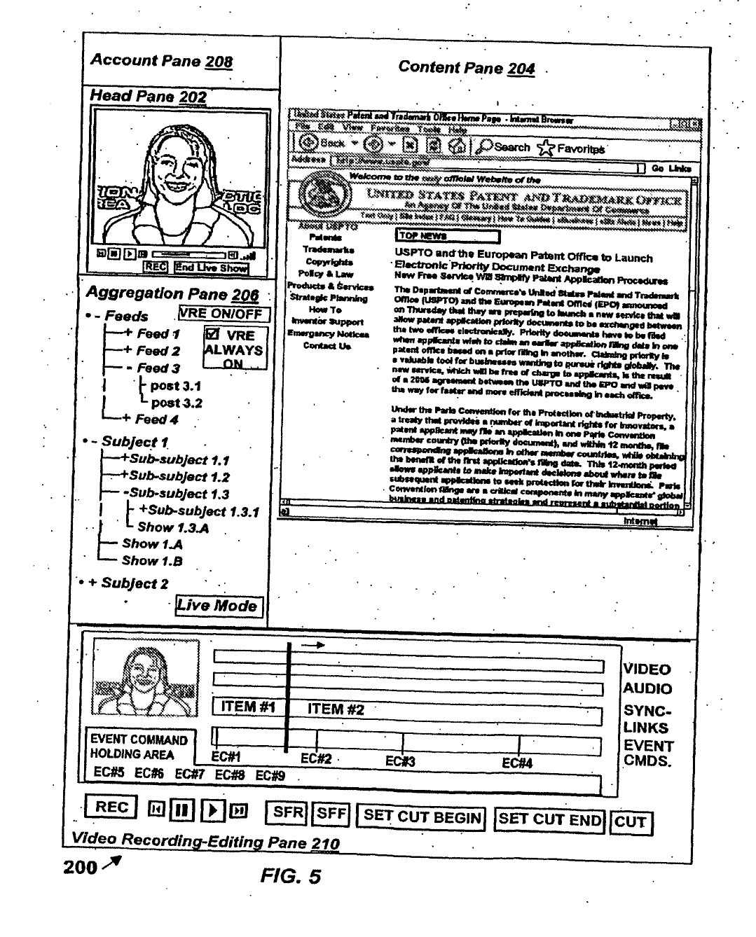

Metaproducer. An exemplary Metaproducer 200 according to inventions of the present application is illustrated in FIG. 5. Metaproducer 200 is an application that enables users (e.g., expert guides, content producers) to create metacontent shows by directing a local data processor to perform various tasks, as described below. Metaproducer 200 provides a head pane 202 similar to head pane 102, a content pane 204 similar to content pane 104, and an aggregation pane 206 that has aspects in common with directory pane 106 but has significant differences. Each of panes 202, 204, and 206 are software elements implemented by corresponding computer instruction sets embodied on a computer-readable medium that are adapted to direct the local data processor to do various tasks, as described below in greater detail. Before describing the instruction sets and these tasks, an overview of Metaproducer 200 is provided.

Aggregation pane 206 provides a control point for research and aggregating content (e.g., web pages), creating sync-links and setting sync-links in the production of a metacontent show, including the setting of sync-links during a live performance (as described below). It offers a metacontent producer (e.g., reporter) a tree-view whose major nodes provide access to a set of RSS feeds (“Feeds” in the figures), and a list of subjects for which the producer has previously produced shows, as well as other subjects available from the show database(s). In typical usage, a producer browses the web Feeds, searches the Internet, and searches other metacontent shows for items the producer wants to discuss in aggregate into a new metacontent show. Having found the items, the producer writes a narrative text using his/her own authoring tools or the authoring tool supplied in Metaproducer 200 to synthesize, summarize, and provide a perspective overview of the information contained in the aggregated items. The producer can then record himself/herself reading the narrative to create a metacontent track 12 (the recording may be just an audio track or both audio and video tracks), can edit the metacontent track 12, using the tools of his or her choice, then associate the metacontent track 12 with identifiers 14 and 16 (or 16′) (i.e., sync-linking the items) using aggregation pane 206. Also by using aggregation pane 206, the producer can further assemble these components with other field data for the show to create a new metacontent show 10, and can then upload the new metacontent show 10 to a database server, where it can be stored and distributed to viewers. Content pane 204 displays to the producer RSS feed pages and other Internet web pages that the producer selects to view, and can also provide a facility for the producer to create and edit his narrative. Head pane 202 enables the producer to preview the metacontent track, and, in combination with aggregation pane 206 or other software elements, enables the producer to sync-link the items with the metacontent track 12. The new metacontent show can also be viewed with head pane 202 and content pane 204. For producing premium metacontent shows, Metaproducer 200 facilities users to add command events to the metacontent show to control the properties of the head pane, content pane, and directory pane during playback, and to enable the additional features described above.

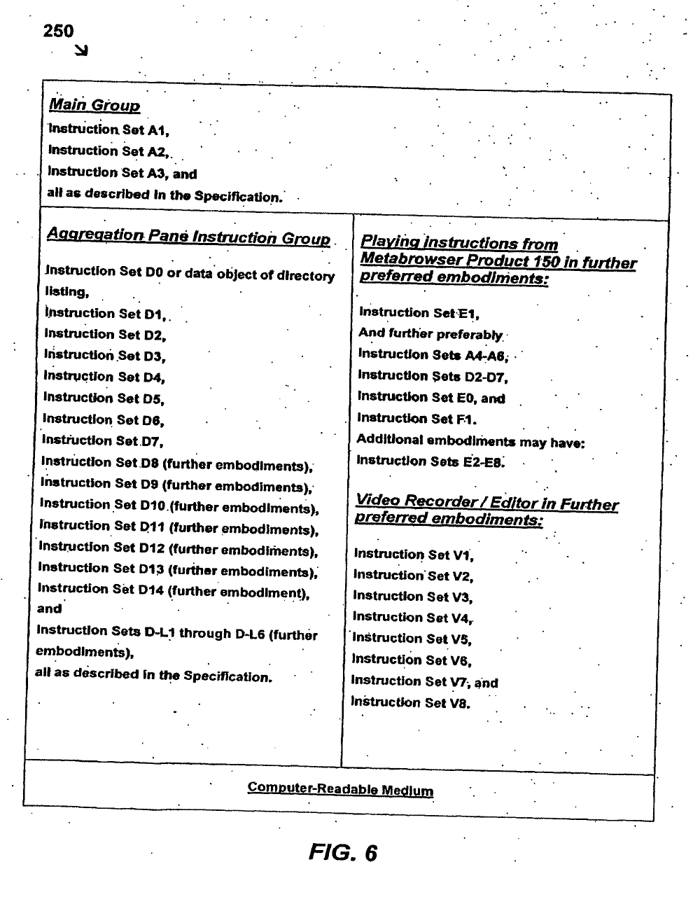

The instruction sets of Metaproducer 200 can be implemented in any known code forms, including scripts and plug-ins, and may be implemented on a personal computer, IPTV receiver, Internet TV receiver, set-top boxes, and the like. As a preferred embodiment, Metaproducer 200 is implemented as a Flash or Silverlight application loaded by accessing a particular uniform resource locator with a browser over the Internet (which has been advertised, or otherwise made available, to the public, e.g., www.wayv.tv). FIG. 6 shows an exemplary implementation of Metaproducer 200, in the form of a computer program product 250. Product 250 is provided on a computer-readable medium that can be downloaded to a computer as a Flash or Silverlight application. After downloading, the product is installed in a browser and resides as executable code on the user's computer. (While currently less preferred, product 250 can comprise a set of webpage scripts downloaded to an internet browser). Product 250 interacts with the Internet browser and directs it to perform various tasks, which in turn are accomplished by directing data processor 50 to perform various tasks. In the same manner as Metabrowsers 100 and 100′, product 250 preferably uses the Internet browser itself to render webpage content for content pane 204, while while handling itself the implementation of the head pane 202, directory pane 206, and optionally the account pane 208. The Internet browser has an API interface that enables product 250 to access information about the browser and to control various aspects of the browser's operation. Product 250 comprises a main control providing:
(A1) an instruction set that directs the Internet browser to allocate a screen area for the panes, and optionally for a video recorder/editor (VRE) pane 210, with the Silverlight plug-in passing user input in this area to the main control; to allocate processing time to the instruction sets of product 250; and to enable communications between the Internet browser and the instruction sets of product 250. In preferred embodiments, these instructions set up an IFrame or div tag for content pane 204, and direct the browser to render web-page code (e.g., HTML, XML) in that IFrame or div tag.
(A2) an instruction set to start an instance of a media player to implement head pane 202, where the media player is controllable through a respective application program interface (API). This media player may be a plug-in provided by a software company (e.g., Windows Media Player, Flash Player, Silverlight, etc.), or a customized plug-in available from the server from which product 250 is downloaded, and need not be part of product 250.
(A3) an instruction set to handle user inputs provided to the main control by the Internet browser, Flash or Silverlight, and to pass the inputs to head pane (e.g., media player), the directory pane instruction sets (described below), and the VRE pane instruction sets, if used (described below).
   These instruction sets (along with other instruction sets described below) can be provided in the form of HTML, XAML, MXML, Actionscript, C#, Visual Basic, or any other .NET language, to configure the Internet browser and establish a plug-in instance of Flash Player or Silverlight to implement the panes with object handlers, as described above. In a less preferred way, which follows conventional AJAX programming methods, the above instruction sets (along with other instruction sets described below) can be provided in the form of HTML instructions that direct the browser to create one or more IFrames for panes 202, 206 and 208, and script instructions (e.g., Java-Script) that direct the browser to load any needed plug-ins, to start the instance of a media player for the head pane, and to set up the input handling and communications between software components.

For aggregation pane 204, computer-program product 250 comprises a data object holding a directory listing of metacontent shows, or comprises an instruction set D0 that directs data processor 50 to request and receive a directory listing of metacontent shows from one or more network-accessible database servers. Product 250 further comprises:
(D1) an instruction set that directs data processor 50 to display the listing in the screen area for aggregation pane 204;
(D2) an interface control (e.g., instruction set) that directs data processor 50 to receive user input to add a new metacontent show to a selected subject;
(D3) an interface control (e.g., instruction set) that directs data processor 50 to receive user input to associate a textual description to a new metacontent show;
(D4) an interface control (e.g., instruction set) that directs data processor 50 to receive user input to associate a metacontent track with the new metacontent show;
(D5) an interface control (e.g., instruction set) that directs data processor 50 to receive user input of one or more corresponding items of network-accessible information that are to be associated with the new metacontent show, the association including an identifier for each item that facilitates access to the contents of the item over a network;
(D6) an interface control (e.g., instruction set) that directs data processor 50 to receive user input to associate a selected item of network-accessible information of the new metacontent show with a selected location in the metacontent track;
(D7) an interface control (e.g., instruction set) that directs data processor 50 to receive user input to transmit a new metacontent show to a database server and an instruction set to transmit the new metacontent show to the database server.
   In further embodiments of Metaproducer 200, the group of instruction sets for aggregation pane 204 preferably further comprises:
(D8) An interface control (e.g., instruction set) that directs data processor 50 to receive user input to establish access to a feed (e.g., RSS feed) of a selected information source on the aggregation pane 204;
(D9) an instruction set that directs data processor 50 to receive listings of posts of the established feeds from one or more network-accessible servers, each listing including at least the title of the post and a network identifier (e.g., URLs) to the post, and to display the feeds and post listings in the screen area for aggregation pane 204;
(D10) An interface control (e.g., instruction set) that directs data processor 50 to receive user input to load a selected post of a feed in content pane 204, and to send a message to the API instruction sets of content pane 204 instructing it to load the selected post, the message including a network identifier for the selected post.
   These instruction sets can be readily implemented by one of ordinary skill in the software art without undue experimentation in view of the above description and the further descriptions below. Further exemplary implementations of some of the instruction sets are described below. Also described below are further embodiments of aggregation pane 206 that comprise further instruction sets. The directory pane instructions may be run by the main control element or as an entity (e.g., directory handler) under the main control element.

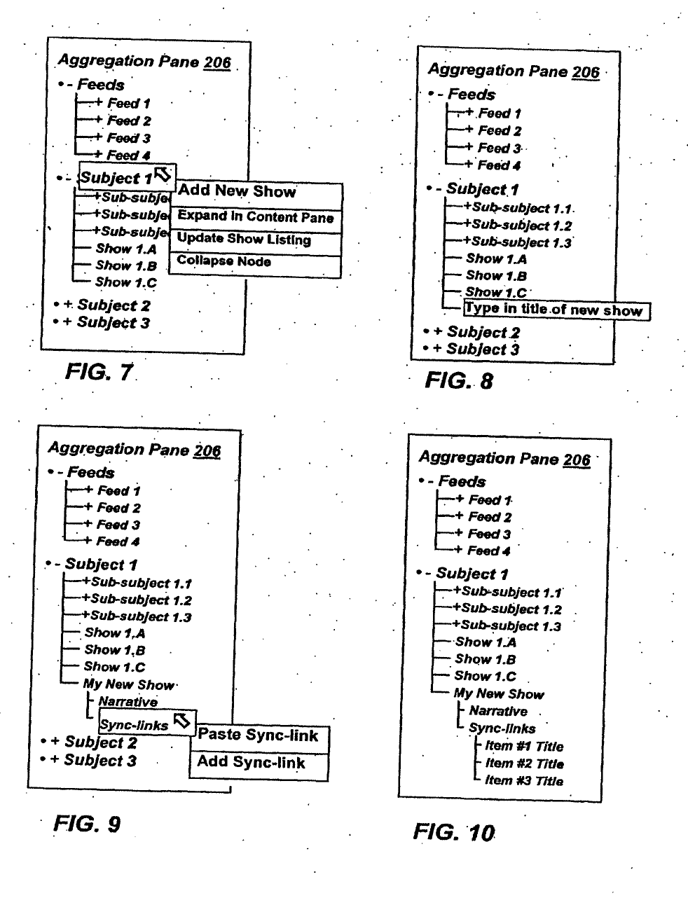

A description of an exemplary way of creating a new metacontent show is now described, with reference to the above instruction sets. The producer first finds a subject or sub-subject node in which to place the new metacontent show by browsing the subject and sub-subject nodes in the aggregation pane. Referring to FIG. 7, the producer performs a right click on the desired subject node to bring up a menu of commands, and then the producer chooses the “Add New Show” command with a mouse click (right click or left click). Referring to FIG. 8, as a result, a data object for the new show is provided in the memory space for Metaproducer 200 (called the “Show Data Object”), and a new child node appears representing the show offering the producer a textbox with a default title (“Type in title of new show”). The tasks of presenting the command menu shown in FIG. 7, receiving the producer's mouse click, creating the Show Data Object, and of establishing the node for the new show are directed by Instruction Set D2, which can be implemented by conventional GUI interface controls.

Aggregation Pane 206 can use a data object (e.g., data structure) to store the node information of the feeds and subjects displayed in the pane, and the incorporation of the new node for the new show is readily handled by augmenting the data object to include a new node that designates the node as a new show. This data object is referred to herein as the “Directory Data Object.” The text box with the default title (shown in FIG. 8) is left in a state whereby the producer can type a new title for the new show at this point. Referring to FIG. 9, after the producer enters a title in the text box and thereafter hits the “Enter” button, the show node is renamed (in this case “My New Show”), the Show Data Object is updated to include the title, and two new child nodes called “Narrative” and “Sync-links List” appear for the new show under the show's node. Also, two data objects for the Narrative and the Sync-links List are provided within the memory space for Metaproducer 200. These tasks are directed by Instruction Set D3, which can be implemented by GUI interface controls, plus additional instructions to further augment the Directory Data Object, to update the Show Data Object, and to create the data objects for the Narrative and the Sync-links List.

When the producer performs a left-click (e.g., index-finger mouse click for left-handed users) on the Narrative node, a text editor is loaded into content pane 204 that enables the producer to compose text, which is stored in the Narrative's data object in substantially a real-time manner as additions, deletions, and corrections are made. After composing some of the narrative, the producer may want to search some of the feed posts to get further information for the narrative; in this case, the producer can perform a left-click on a feed post to open its contents up in content pane 204, with the text of the Narrative being already saved in the Narrative's data object. To enable the producer to jump back and forth between the narrative and posts, the narrative may be opened up in a new tab of the content pane while the posts are maintained in one or more previously created tabs. After browsing some posts and/or internet sites, the producer may return to the narrative by performing an left-click on the Narrative's node or tab, at which time the text editor is reloaded into content pane 204 (if not already present in a browser tab) or the Narrative's browser tab is brought to the foreground, with the composed text being in the state the producer last left it. To provide the editor in this manner, product 250 may comprise an instruction set D11 that has an interface control that directs data processor 50 to receive user input to edit the Narrative in Pane 204, and to send a message to the API of the Internet browser instructing it to load a script editor or plug-in editor that works on the Narrative data object directly.

The Sync-links node and Sync-links data object are empty when first created. As the producer composes the narrative and browses the feed posts, Internet, and other metacontent shows, the producer can add information items to the Sync-links node and data object by in number of ways. As a first way, the URL in the address box of Content Pane 204 is copied into the operating system's clipboard by the producer with the control-C command of the operating system, and thereafter the contents of the clipboard are pasted into the Sync-links node by the user performing a right-click on the node to display a context menu, and by the selecting the “Paste Sync-link” option, as illustrated in FIG. 9. The pasted URL, which is the item identifier 14 for the added information item, is then added to the sync-links data object, which may comprise an array of text strings to store URLs, and may additionally comprise a second array of text strings to store descriptive titles of the information items. (The sync-links data object also comprises objects to store the location identifiers for the sync-link items; as described above, the location identifiers can have a plurality of forms.) Also, a new child node is added under the Sync-links node, with all or a portion of the URL (or descriptive title) of the added item being displayed as the child node's name, as shown in FIG. 10. The tasks of providing the displayed context menu, receiving the producer's input to paste a URL from the clipboard, adding the URL to the sync-link data object, and of augmenting the Directory Data Object to include a child node for the added item can be directed by Instruction Set D3, using conventional GUI interface controls and data object handling instructions. As another way of associating information items to the new show as Sync-links, the addition of a Sync-link can be done by dragging URLs from the address textbox of Content Pane 204 and dropping them into the Sync-links node. The tasks for this way can also be directed by Instruction Set D3, using GUI interface controls and data object handling instructions. As a third way, the producer performs a right click on the node to display a context menu shown in FIG. 9, and selects the “Add Sync-link” option. This brings up a dialog box which allows the user to type in the text of the item's URL (and optionally the title of the item), or to click a button to use the URL of the item currently being displayed in Content Pane 204. Instruction Set D3, as indicated above, can include a conventional GUI interface control to present this menu and receive the producer's selection, and can include another GUI control interface to present the dialog box. If the producer selects the button to use the item currently displayed in Content Pane 204, Instruction set D3 sends a request message to the API of the Internet browser asking for the URL address (and optionally title) of the item currently being displayed. Regardless of how the URL address (and optionally title) is obtained, Instruction set D3 includes instructions to add the URL to the sync-link data object, and to augment the Directory Data Object to include a child node for the added item, as described above. Instruction Set D3 may implement one or all three ways, and may also implement other ways. The above ways enable a producer to easily browse feeds and websites for information items and associate them to the new metacontent show, all possible while composing the narrative.

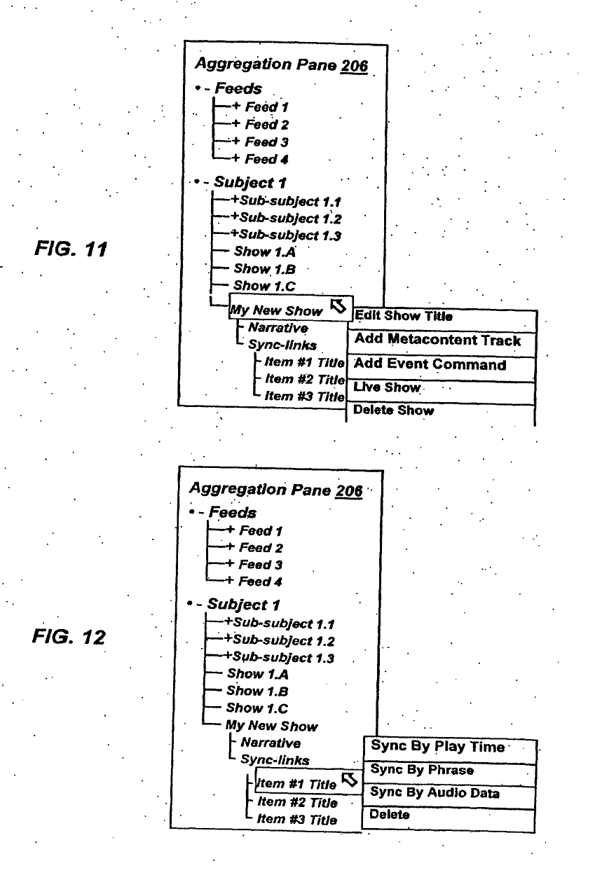

When the narrative is complete, the producer records himself or herself reading the narrative to generate a raw metacontent track, and then edits the raw metacontent track as needed with production tools chosen by the producer. When the editing is complete, the producer can perform a right click on the new show in the Aggregation Pane and choose the “Add Metacontent Track” command, as shown in FIG. 11. A dialog box is then displayed to “upload” (i.e., associate) the data file for the Metacontent track, the dialog box having a text field for the path to the data file, a conventional “Browse” button that enables the producer to search the file system on the local computer for the desired data file and select it, and an Add button to add the file. In response to providing a file name and clicking the Add button, the file name (including its directory path on the local computer) is added to the Show Data Object. The metacontent track will be uploaded to a database server in a subsequent step, along with other data for the new metacontent show. The tasks for this can be directed by Instruction Set D4, using GUI interface controls and data object handling instructions. Instruction Set D4 then preferably sends API request message to the API for Head Pane 202 to set the media player's current play file to the added metacontent track, and to display the first frame of the track.

At this point, after the metacontent track 12 is done and the item identifiers 14 for the Sync-links have been created, the producer can view metacontent track 12, and set the location identifiers 16 or 16′ to sync-link the information items in the Sync-link list (node). To do this, the producer can play metacontent track 12 in head pane 202 (using the play button in pane 202), pause the track at a time which a particular information item is to be initially presented in Content Pane 204 (using the pause button in pane 202), and then perform a right click on the item to be synchronized. This click brings up a context menu shown in FIG. 12. The producer then clicks (index-finger or middle-finger) on the “Sync By Play Time” command to set the start presentation time of the selected item (Item #1 shown in FIG. 12), which is stored in the Sync-links data object. The end presentation time of the selected item will be the end of metacontent track 12 or the start presentation time of the next item in the playing time, whichever occurs first. The tasks for this are directed by Instruction Set D6 using GUI interface controls and data object handling instructions. To get a representation of the playing time of metacontent track 12 (either as a frame number or a playing time in seconds or sub-division thereof), instruction Set D6 includes instructions to send an API request message or an object method call to the media player handling Head Pane 202 to obtain the representation of the current playing time of the track, which in this example has been paused by the producer at the desired syncing point. This representation is used to construct the location identifier 16 for the item in any of the ways described in the above section on the metacontent show. In addition to storing the item identifiers 14 and location identifiers 16, the Sync-link data object can also store type parameters 18 which indicate the format of the location identifier. In the case where an item is sync-linked using the “Sync By Play Time” command, the type parameter 18 is set to indicate that the location identifier 16 is in the form of a desired playing time. It should be pointed out that the producer need not pause the playing of the metacontent track 12 to sync-link the item since this API request message or object method call can be issued while the media player is playing. However, pausing metacontent track 12 enables the producer to set the synchronization point more precisely. Also, the instruction sets enable the producer to perform the synchronization step again if the producer is not happy with the first synchronization point (the rewind button of the head pane enables the producer to go backwards in the track, if necessary).

Instruction Set D6 may implement the additional way of synchronizing the information by a text representation, which can be selected by the use with the “Sync By Phrase” command shown in FIG. 12. In preferred embodiments, before the producer clicks on this command, he or she selects the text phrase in the narrative using the text selection function of the text editor. With the text selected, the producer then right-clicks on the desired sync-links node and selects the “Sync By Phrase” option. When this option is selected, Instruction Set D6 directs data processor 50 to send a message to the API of the text editor requesting the selected text. When the text phrase is obtained, Instruction Set D6 directs data processor 50 to add the text phrase as a location identifier 16 to the Sync-link data object, along with the type parameter 18 for the item being set to indicate a text phrase. In less preferred embodiments, Instruction Set D6 directs the data processor 50 to present a dialog box to the producer to obtain a text phrase. Instruction Set D6 may also implement the additional way of synchronizing the information by using audio data, which can be selected by the producer with the “Sync By Audio Data” command shown in FIG. 12. When this option is selected, Instruction Set D6 directs the data processor 50 to present a dialog box to the producer to obtain the name (including directory path) of a file that has the audio data to synchronize to, and to obtain the format of the data file (e.g., digitized sample, amplitude envelope information). (The audio data is representative of a portion of the audio track by which to set a location in the metacontent track for the selected item.) The dialog box may also include the option to select a preset sound tone or a preset duration of silence. Instruction set D6 then directs data processor 50 to update the Sync-link data object according to the producer's selection. The above additional tasks directed by Instruction Set D6 can be implemented using GUI interface controls and data object handling instructions.

Once the information items have been sync-linked, the producer may preview the new show by double clicking on it and playing it in Head Pane 202 and Content Pane 204. In this way, Metaproducer 200 can work substantially the same way as Metabrowser 100, and can use the same instruction sets used by Metabrowser 100 to play metacontent shows (e.g., Instruction sets E0, E1, A4-A6), as configured to take the data needed to present the show from the Show Data Object and the Sync-links Data Object. For this, product 250 can have an instruction set D12 set that directs data processor 50 to receive user input to play the new metacontent show 10, to send an API message or object method call to the media player handing head pane 202 instructing the media player to access the file for the new show's metacontent track 12 and start playing the track, and to send a message to a Sync-links engine (Instruction Set E1) with the Show's identifiers 14, 16, and type parameters 18. To provide the producer with additional features of the Metabrowser, the following additional instruction sets from product 150 can be included in product 250: A4-A6, E1, D2-D7, and E2-E8, as indicated in the left column of FIG. 6.

When using product 250 to produce premium metacontent shows, the user can add event commands to the metacontent show to control the properties of the head pane, content pane, and directory pane during playback, and to enable the additional features described above. Each event command is created by receiving input from the user, such as through the exemplary dialog box shown in FIG. 14, and each created command can be stored in an Event-Commands Data Object. (The dialog box can be accessed by clicking on the “Add Event Command” tab shown in FIG. 11.) The exemplary dialog box shown in FIG. 14 enables the user to select the desired command type (by clicking the checkbox next to the name of the command type), such as one of those listed in the above Table I, and to fill in the parameters for the event command. The user typically uses a Define Screen command at the beginning of the metacontent show to provide the width and height of the screen area that the subsequent event commands will reference their characteristics. These values are provided in arbitrary units. When a Metabrowser receives the Define Screen command, it preferably resizes its screen area to match the aspect ratio inherently provide in the Width and Height values, and then scales the position and size values of the other event commands against these values. The Define Screen command may be called several times during a metacontent show. (Instruction set F1 of Metabrowser product 150, which was described above, includes instructions that direct the data processor to perform the resizing and scaling tasks.)

Each listing for a command in FIG. 14 has a place to enter the time (typically in seconds) at which the event command is to occur in the playing time of the metacontent track. The listing for each command, except for the Define Screen command, has a place to enter the Pane ID, where the letter “H” is used to indicate the head pane, “C” is used to indicate the content pane, and “D” is used to indicate the directory pane. With the Overlay Pane command, the user can create an overlay pane, and assign it a numeric name, typically a value from 1 to 16. These numbers many also be used in the Pane ID field of the other commands to change the characteristics of the overlay pane after it is created. The listing for each command, except for Set Pane and Define Screen, has a field to enter a time duration (typically in seconds) over which the command is to occur. The listing for each command, except for Define Screen and Track Pause, has fields to enter the location of the pane (typically upper left-hand or lower left-hand corner), and the size of the pane, all of which may be in the arbitrary units used in the prior Define Screen command. The listing for these commands also has a field to enter an overlay Layer number and a Translucency value, the latter of which can vary between 0 (translucent) and 1 (opaque). Typically, there are 16 overlay layers, and the Layer number can take a value between 1 (top) and 16 (bottom). The listing for the Overlay Pane command has a button labeled “Attach Display Object.” A user click on this button brings up a conventional file dialog box where the user can enter, or browse for, the file or URL that has the object that will be rendered in the overlay pane. In a similar manner, the listing for the Track Pause command has button labeled “Attach Restart Object”. A user click on this button brings up a conventional file dialog box where the user can enter, or browse for, the file or URL that has the object that will be used to define the conditions under which the track is restarted. Finally, at the bottom of the dialog box shown in FIG. 14, are two actions buttons: “Add Event Command” and “Cancel.” A user click on the former button will add the information on the dialog box as a new event command in the Event Command Data Object. A user click on the latter button will cancel out of the dialog box without creating an event command.

To obtain the event commands from the user in the above manner, product 250 can have an instruction set D14 that directs data processor 50 to provide the dialog box of FIG. 14 to the user, to receive input from the user via the dialog box, and to update the Event Command Data Object to include the new event command. Once an event command is entered, it can be displayed as an icon on an event-command time line in video recording-editing pane 210. From there, the user may move the start time of an event command by moving it, and may edit the event command by double clicking on it, which may then bring up the dialog box shown in FIG. 14, with the event command's current settings being shown in the dialog box. If the user creates an event command without time point at which the event is to occur, an icon representation of the event command is placed in a special holding area of VRE pane 210, as shown in FIG. 5 (“Event Command Holding Area”). From there, the user can drag the icon and place it on the event command track at a desired time point. Product 250 may also include instruction set F1 of Metabrowser product 150 so that the producer can view the metacontent show with the additional effects of the command events.

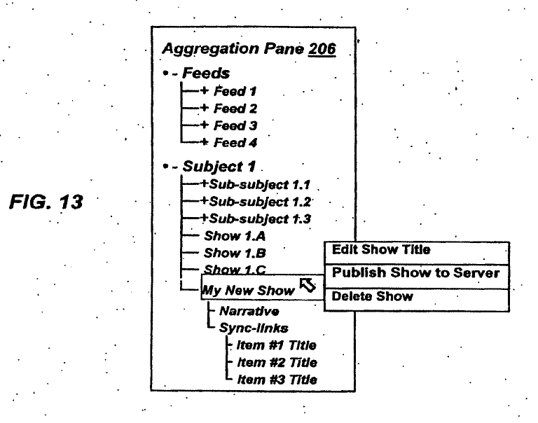

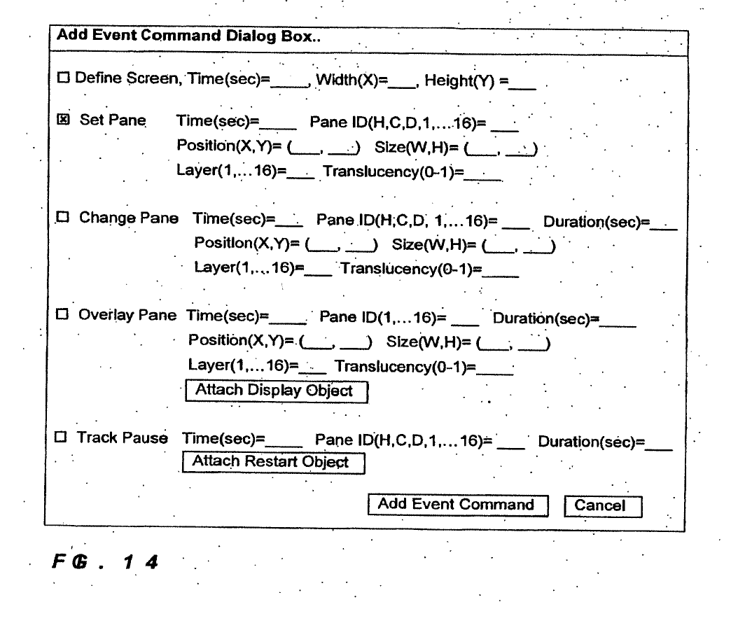

Once the producer is satisfied with the new show, he or she can upload it by performing a right-click on the node for the new show to bring up a menu of commands as shown in FIG. 13, and selecting the “Publish Show to Server” command. This input feature is provided by Instruction Set D7 using a GUI interface control. Upon receiving the producer's instruction to do so, Instruction Set D7 comprises instructions to transmit the contents of the Show Data Object, the Sync-links Data Object, the Narrative Data Object, the producer's name (Author), an indication of the Subject or Sub-subject under which the new show was placed, and metacontent track 12 to a predetermined server using any conventional Internet communication protocol, such as file transfer protocol, e-mail, etc. In addition, in the production of premium metacontent shows, Instruction Set D7 also comprises instructions to transmit the Event-Commands Data Object. Instruction Set D7 may place the contents of these items in a data object for a metacontent show 10 (as illustrated in FIG. 1) before transmitting them to the sever. Instruction Set D7 may also include instructions to present a dialog box enabling the producer to select a database to publish to, and to provide user login information for that data base, if needed. The dialog box may also include an option to add an abstract for the new Show (which can be placed in field 22 of the data structure shown in FIG. 1), and another option to embed the item identifiers 14 in the metacontent track with embedded location identifiers 16′. The embedding may be done by a software utility invoked by Instruction Set D7, or done by the sever (in which case Instruction Set D7 can include a message to the server to perform this task if it is not automatically done by the server).

It may be appreciated that the instruction sets of computer-program product 250 can be repackaged into a thick-client embodiment, which does not have to be downloaded into an Internet browser and run by the Browser. The thick-client embodiment has a wrapper that does the essential communication functions and user input handling done by the Internet browser for Product 250. In addition, the wrapper defines a container for the panes, starts an instance of an Internet browser in Content Pane 204, an instance of a media player to handle Head Pane 202, and starts the directory instruction sets in the directory pane, and handles instruction sets A4-A6 itself.

Further Metaproducer Features. In further embodiments of Metaproducer 200, a video recorder and editor (VRE) facility is provided in a pane 210 of the video screen to enable the producer to create a metacontent tracks and sync-link items to it. VRE Pane 210 is preferably located below content pane 204 and aggregation pane 206, and can be hidden from view and brought into view by a click of a button (the “VRE ON/OFF” button). This enables the viewing area of content pane 204 and aggregation pane 206 to be maximized when the VRE is not being used. To speed up quick show creation, which is a further feature described below, an option box is included in the aggregation pane that allows the producer to always have VRE Pane 210 open upon startup of MetaProducer 200. When clicked, the software control for this box stores a start-up profile parameter which MetaProducer 200 looks at upon startup. VRE Pane 210 may comprise a commercially-available non-linear editor made available as a plug-in, script code, compiled Actionscript or managed .NET code, with an API instruction set that has been modified to include a track for sync-links, a track for event commands, an area to hold event commands that have not been synchronized to the metacontent track, the ability to place and move an information item on the sync-links track during the recording and editing process, and the ability to place and move an event command in on the event-command track. VRE Pane 210 enables sync-linking to become part of the video production process, and for video production to become part of the content research and aggregation process. With VRE Pane 210, the video does not have to be recorded and edited in advance, enabling easier and more fluid (i.e., free-flowing) metacontent development. After opening up VRE Pan 210, it opens upon to a blank show. The producer can load any one of his or her metacontent shows that have not been published (e.g., a new show) into the VRE pane for editing by performing a single left-click of the mouse on the un-published show. As the producer locates content on the Web, he or she can video record comments extemporaneously, and drag and drop URLs for the items onto the recording timeline at just the right place. The items can be deleted from the sync-links track, and their start and stop times adjusted. As the sync-linked items are added, deleted, and adjusted for playing time, the Sync-links Object and directory object are updated to reflect the changes.

VRE Pane 210 may comprise conventional edit buttons. Starting at the far left of the pane, the “REC” button enables the producer to record video from a camera/microphone set-up (e.g., “web cam”) that is common to personal computers. This is a toggle button that records audio and video into a working file at the location of the time bar (the thick vertical line across the three tracks) when the button is depressed, and stops recording when pressed to reset. The time bar may be moved around to insert audio and video into previously recorded sections. The next four buttons enable the producer to play the recorded video in a manner conventional to media players so that he or she can review the video and decide where to place items for sync-linking. These four buttons are: rewind, pause, play, and fast forward. The next two buttons enable the producer to step through the video one frame at a time in the reverse direction by pressing the “SFR” button, and in the forward direction by pressing the “SFF” button. These two buttons move the time bar by one frame with each click, and enable finer control over where the producer can add sync-links, insert new video (with the record button), and delete or move previously recorded video. The next three buttons enable the producer to mark sections of video for deletion or copying. To cut a section of video, the producer positions the time bar to the start of the deletion, and click the “Set Cut Begin” button, which marks the beginning of the deletion. The producer then moves the time bar to the end of the deletion, and clicks the “Set Cut End” button. The producer then clicks the cut button to delete the marked section of video. The marked section is taken out of the video, and placed in a temporary buffer. The producer can then move the time bar to another location in the video and type a Control-V (paste) command at the keyboard, and have the video in the temporary buffer inserted at the time bar. This enables the producer to easily move sections of video. The producer can also copy a marked section of video into the temporary buffer without deleting it by typing a Control-C (copy) command at the keyboard, and then paste the copied video at a desired location. The instruction sets for performing the above tasks are provided by the commercially-available code.

Sync-links may be added to the sync-links track in a number of ways. As a first way, the producer may record some narrative, which causes the time bar to advance from left to right along the time line. The producer may then stop the recording process, and drag-and-drop an item's URL to the sync-links track, to the left side of the time bar, which then associates the sync-link with the recorded narrative. Then, the producer can right click on the sync-link in the sync-link track to bring up a context menu which, as one option, enables the producer to set the end presentation time of the sync-link to the time indicated by the time bar. This will allow the producer to record additional narrative for a second sync-link, and then add the second sync-link just to the right of the first sync-link by the using the same drag-and-drop procedure. As a second way of adding sync-links, the producer may first drag-and-drop an item's URL to the sync-links track, to the right side of the time bar, and then record some narrative. To add a second sync-link, the producer stops the recording with the time bar at the end of the video for the first sync-link, then drags-and-drops a second item's URL to the sync-links track, to the right side of the time bar, and then records some narrative regarding the second item. In this case, the addition of the second item automatically sets the end presentation of the first item. For narrative that has already been recorded, the producer may add sync-links with the above steps, but using the play and pause buttons rather than the record button. Computer-program product 250 may further comprise the following instruction sets to provide VRE Pane 210 and interface to it:
(D13) An interface control (e.g., instruction set) that directs data processor 50 to receive user input to open a selected metacontent show in VRE Paine 210, and in response thereto to send a message to the Video Recorder/Editor through its API to save the file it has been editing and to open to the selected metacontent show for editing;
(V1) an instruction set that modifies the Video Recorder/Editor to include a graphical presentation of the sync-links track that is integrated with the time bar, including a data structure to record additions, changes, and deletions of URLs to the track;
(V2) an interface control (e.g., instruction set) that directs data processor 50 to receive user input to add a URL to the sync-link's track at a selected location, to update the track data object to include the sync-link, to update the sync-link's data object to include the item and its location, and to update the directory data object to include a new item in the sync-links node.
(V3) an interface control (e.g., instruction set) that directs data processor 50 to receive user input to set the end presentation time of a sync-link already on the track, to update the location of the sync-link in the track's data object and the sync-link's data object.
   These instruction sets may be constructed by one of ordinary skill in the software arts in view of the preset specification without undue experimentation.

In a similar manner, the user may move the start time of an event command by moving its icon representation on VRE Pane 210, either within the event command track, or between the event command track and the holding area. The user may also edit an event command by double clicking on it, which may then bring up the dialog box shown in FIG. 14, with the event command's current settings being shown in the dialog box. Computer-program product 250 may further comprise the following instruction sets to provide VRE Pane 210 and interface to it:
(V5) an instruction set that modifies the Video Recorder/Editor to include a graphical presentation of the event-commands track that is integrated with the time bar, and an event command holding area;
(V6) an instruction set that accesses the Event Command Data Object and displays, on the event-commands track, icon representations of those event commands that have their time values set, and displays, in the holding area, icon representations of those event commands that do not have their time values set;
(V7) an instruction set that receives a user input (e.g., drag and drop) to move an icon representation of an event command, either within the event-command track or between the holding area and the event-command track, and to update the time value of the moved event command and to update the icon representation on the VRE pane (which can be done by invoking instruction set V6);
(V8) an instruction set that receives a user input (e.g., double mouse click on the icon representation) to edit an event command, and to receive user input to edit the event command (which can be done by invoking instruction set D14);
   These instruction sets may be constructed by one of ordinary skill in the software arts in view of the preset specification without undue experimentation.

In further embodiments incorporating VRE Pane 210, the producer may move sections of video by moving the sync-link items. For example, the producer may right-click on Item #2 in the sync-links track, and drag it to the left of Item #1 in the track. This causes the locations of the sync-links to be swapped, and also causes the corresponding sections of audio, video, and command events to be swapped. This feature enables the producer to rearrange the video according to the sync-links. Computer-program product 250 may further comprise the following instruction sets to provide this feature:
(V4) an interface control (e.g., instruction set) that directs data processor 50 to receive user input to move a selected sync-link displayed on the sync-link track to a new location, either the beginning of the track, the end of the track, or a boundary between two other sync-links, to obtain the start and end points of the selected sync-link from the sync-links data object, to direct the video recorder/editor software (such as through its API) to copy the video between the start and end points to a temporary buffer, to direct the video recorder/editor software (such as through its API) to delete the video between the start and end points if the new location is before the start point, to direct the video recorder/editor software (such as through its API) to copy the contents of the temporary buffer into the audio and video tracks at the new location, and to direct the video recorder/editor software (such as through its API) to delete the video between the start and end points if the new location is after the end point, and to update the location of the sync-link in the track's data object and the Sync-links data object, and to update the time values of the event commands that are affected by the move operation.
   These instruction sets may be constructed by one of ordinary skill in the software arts in view of the preset specification without undue experimentation.

Quick Create Mode. In making his inventions, the inventor has recognized that many producers will get ideas for metacontent shows while doing regular browsing in an Internet browser. For instance, the producer may navigate to a webpage and suddenly realize that it can be used in the metacontent show that he or she has in progress. It would be highly effective if the producer could quickly start up the MetaProducer with that webpage already loaded in the content pane ready for sync-linking to the show. As a further feature in further embodiments of MetaProducer 200, MetaProducer 200 can be quickly started up from the regular Internet browser with a special button located on the browser's tool bar. This button, when clicked by the user, loads the plug-in (or script) for MetaProducer 200, while maintaining the current webpage in the content pane. Then the producer click on the “VRE ON/OFF” button to display VRE Pane 210 if it is not already display, and then clicks on the show to load it in VRE Pane 210. Thus, with two or three mouse clicks, the producer is above to record narrative related to the webpage and sync-link to it. To implement this, MetaBrowser Product 250 can further comprise an Instruction Set A4 that directs the Internet browser (via processor 50) to add a user set control to the main tool bar of the Browser, if not already added, wherein the user start control directs the Internet browser to load computer program product 250 (preferably as a plug-in).

Live Mode. As a further feature in further embodiments of MetaProducer 200, a Live Mode is provided whereby a producer can webcast a Live metacontent show to a group of consumers, including the provision of sync-links. A “Live Show” context menu choice, which is shown in FIG. 13 as “Live Show,” is provided in the aggregation pane for every new show which does not yet have video associated with it. Sync-links are assumed to be complete and this is the responsibility of the producer. Prior to conducting the webcast, the producer arranges the sync-links in the order they will be discussed. When the Live Show menu choice is selected, head pane 202 is reconfigured to include controls for live webcasting (which may be done by removing the conventional media player and replacing it with a webcasting player), including as a minimum a Record button and an End Live Show button, and brings up a dialog box enabling the producer to configure the webcast over a selected Internet channel, or two selected Internet channels (one for the webcast, and the other for the transmission of sync-links). Also as a result of the producer choosing the Live Show context menu choice, Aggregation Pane 206 is reconfigure as a simple list of sync-links. Meanwhile, consumers of the webcast are signing onto the webcast using their Metabrowsers. The show begins when the producer clicks the Record button in the Head Pane. During the webcast, the producer clicks any of the sync-links at anytime to broadcast its URL to all participating webcast clients, which then display the pages corresponding to the URL in the Content Pane of their respective MetaBrowsers. All of the client Content Panes are simultaneously updated. The sync-links may be embedded in the webcast transmission in a separate “sync-links” stream (which was described above) or may be transmitted on a second Internet channel, or both approaches may be done. The webcast may be recorded at a central server or by MetaProducer 200 itself. In the latter case, a file is created to store the webcast video and its sync-links. In either case, the sync-links array corresponding to the Live Show (i.e., the new show that was selected for Live Show) is updated each time the producer clicks on a sync-link during broadcast. When the producer is finished, he or she clicks on the “End Live Show” button in the Head Pane. The Live Show is now a new metacontent show, and may be published to the server and viewed in the same way as regular metacontent shows.

Computer program product 250 may include the following additional instruction sets to implement Live mode:
(D-L1) An interface control (e.g., instruction set) that directs data processor 50 to receive user input to enter Live Mode for a selected new show, and in response thereto reconfigures head pane 202 to include controls for live webcasting, to initiate the webcast over a first selected Internet broadcast channel for the video, and optionally a second selected Internet broadcast channel for the sync-links, and to reconfigure aggregation pane 206 to show the list of sync-links of the selected show;
(D-L2) An interface control (e.g., instruction set) that directs data processor 50 to receive user input to select an item in the sync-links list as a live sync-link, embed the item's item identifier 14 (e.g., the item's URL) in a sync-links stream of the webcast transmission and/or transmit the item's item identifier 14 over the second Internet broadcast channel (if used), and to update the sync-links node and sync-links data structure for the selected new show;
(D-L3) An interface control (e.g., instruction set) that directs data processor 50 to receive user input to end the Live Show.
   These instruction sets can be constructed by those of ordinary skill in the software art without undue experimentation in view of the present disclosure.

To receive a live metacontent webcast, Metabrowser 100 enables the consumer to view a live webcast in the usual way, by double-clicking its node in the Directory Pane. The node will have associated with it an icon designating the show as a live show. Once this is done, if the show is already underway, the media player in head pane 102 will begin playing from the first Internet broadcast channel. If the sync-links are embedded in the webcast, then instruction set E2 will find them and cause them to be displayed in content pane 104. If the show is not yet underway, the consumer will wait until the show begins. Start time for the show will be clearly listed in the Head Pane. If sync-links are not embedded in the webcast, Metaproducer 100 will monitor the second Internet broadcast channel for message containing item identifiers 14 (e.g., URLs). The viewer may exit the live show webcast in the usual way, by clicking the Stop button in the Head Pane or by closing the Metabrowser. The Metabrowser computer program product 250 may include the following additional instruction sets to implement the reception of the metacontent webcast:
(D-L4) An interface control (e.g., instruction set) that directs data processor 50 to receive user input to connect to a Live Webcast on a first selected Internet broadcast channel for the video, and optionally a second selected Internet broadcast channel for the Sync-links, and in response thereto directs the media player to play from the first selected Internet broadcast channel;
(D-L5) an instruction set that directs data processor 50 to monitor the second Internet broadcast channel, if active, for messages containing item identifiers 14, and to send a message to the API of the Internet browser instructing the Internet browser to load a item identified by an item identifier 14 received over the second Internet broadcast channel in response to the item identifier being received;
(D-L6) An interface control (e.g., instruction set) that directs data processor 50 to receive user input to exit from the Live Show.
   These instruction sets can be constructed by those of ordinary skill in the software art without undue experimentation in view of the present disclosure.

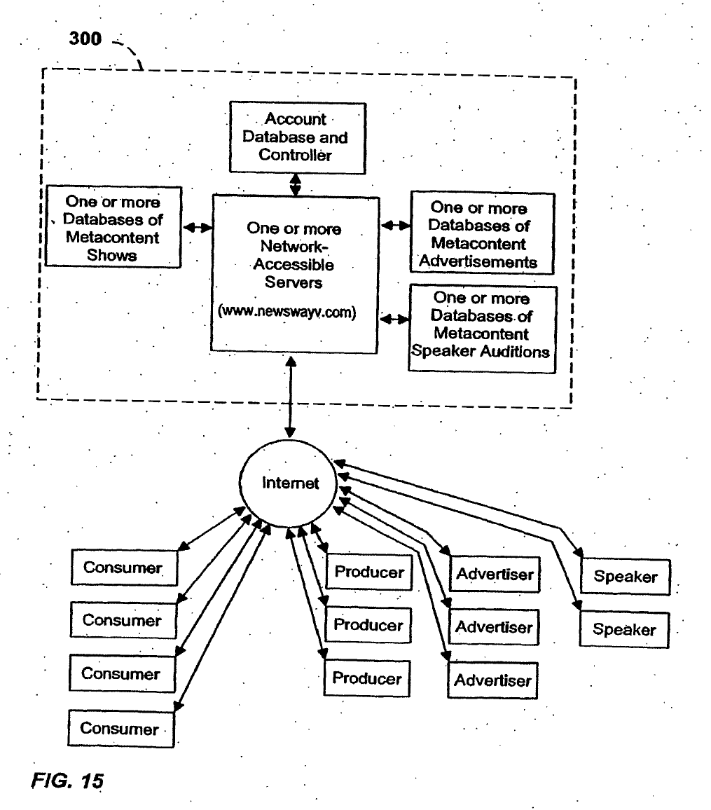

Distribution. An exemplary system invention of the present application is illustrated at 300 in FIG. 15. System 300 enables producers to publish metacontent shows that they have created, and enables consumers to view published metacontent shows. System 300 comprises one or more databases adapted to store metacontent shows in an organized structure of subjects and sub-subjects, and one or more network-accessible servers that provide metacontent shows to consumers via the Internet, and accept new metatcontent shows from producers via the Internet. Each of the servers is preferably accessed by a publicly known URL, such as www.wayv.tv, which presents an information home page. In preferred embodiments, the home page comprises a Silverlight or Flash Player embodiment of Metabrowser 200, with the content pane being loaded with additional information about the system, and how to obtain enhanced embodiments of the Metabrowser, and how to become a producer, advertiser, and speaker. From this home page, a user (e.g., consumer) can download a plug-in version of computer-program product for a Metabrowser 100, such as a plug-in version of product 150, by navigating to a sub-page of the site. Also from the home page, a user can register as a producer and download a computer-program product for a Metaproducer 200, such as product 250, by navigating through appropriate sub-pages of the site. Likewise, a user can register as an advertiser and download a computer-program product for a MetaAdvertiser 400, such as product 450 (both of which are discussed below), by navigating through appropriate sub-pages of the site. Also, a user can register as a Speaker and download a computer-program product for a MetaSpeaker 500, such as product 550 (both of which are discussed below), by navigating through appropriate sub-pages of the site.

As indicated above, metacontent shows may be rated by consumers. To implement this, System 300 may append to the end of each metacontent show a sync-link to a rating webpage where consumers can provide their feedback on the show. The consumer may rate the show according to one or more criteria, and click on a “Submit” button to send the results to one of the servers. A server can then take the results and update the rating field 30 for the show. In an exemplary embodiment, three separate sliders appear on this page covering the narrative (the writing), the delivery (the producer), and the content (the sync-links). The rating feature may also be implemented by a script instruction set that adds a ratings box to the video screen, such as in Head Pane 102, that enables a consumer to send a rating for a metacontent show after it is presented. The script accepts the user's rating, accesses data objects in the metabrowser to determine the identity of the show that was just played, and sends the user's ratings to a server along with the identity of the show.

System 300 can be further adapted to generate revenue by presenting advertisements, which can be in the form of short metacontent shows, to consumers prior to presenting their selected shows. Each such advertisement may comprise a ten second video shown in the Head Pane with one or two sync-linked items displayed in the content pane. To implement this instruction set D2 of Metabrowser product 150 (FIG. 4) includes instructions to receive two metacontent shows from the server, one being an advertisement selected by the server and the other being the requested show, and to play the two shows in successive order (the advertisement being played first). Instruction set D2 can include an instruction to monitor the playing time of the media player to detect the end of the advertisement (and to then start the second show) and may optionally include instructions that direct the media player to disable its fast forward, pause, and stop button. System 300 may comprise one or more databases that store metacontent advertisements, the databases being coupled to the systems servers. To assist advertisers in making their metacontent advertisements, a modified version of Metaproducer 200, called MetaAdvertiser 400, is made available to them through the web site. After registering as an advertiser, installing MetaAdvertiser 400 (such as by using a MetaAdvertiser computer-program product 450), and logging into the server, an advertiser is provided with a node to store his or her own metacontent ads. In further embodiments, System 300 can make the work of several independent spokespersons, referred to hereafter as speakers, available to advertisers. Through system 300, an advertiser can view the work of these speakers by reviewing sample metacontent ads or video clips called auditions. The advertiser can then pay a speaker to record a ten second video presentation, which the advertiser can use as the metacontent track of the metacontent advertisement. MetaAdvertiser 400, product 450, and the facilities provided for speakers are described below in greater detail.

System 300 includes one or more databases to store metacontent advertisements, and one or more databases to store metacontent speaker auditions and finished tracks, which are described in greater detail below. System 300 further comprises an account database and controller that manages users accounts (consumers, producers, advertisers, and speakers), and allows users to establish and update their accounts, and to login and log out of their accounts (which may be done through the account panes presented to the users). In addition, the Account Database and Controller is adapted to schedule metacontent Ads for display to consumers, collect revenues from the presentation of the metacontent advertisements, and to compute the portions of revenues to be distributed to the producers of the metacontent shows and the speakers based on how many times their shows or ads are viewed.

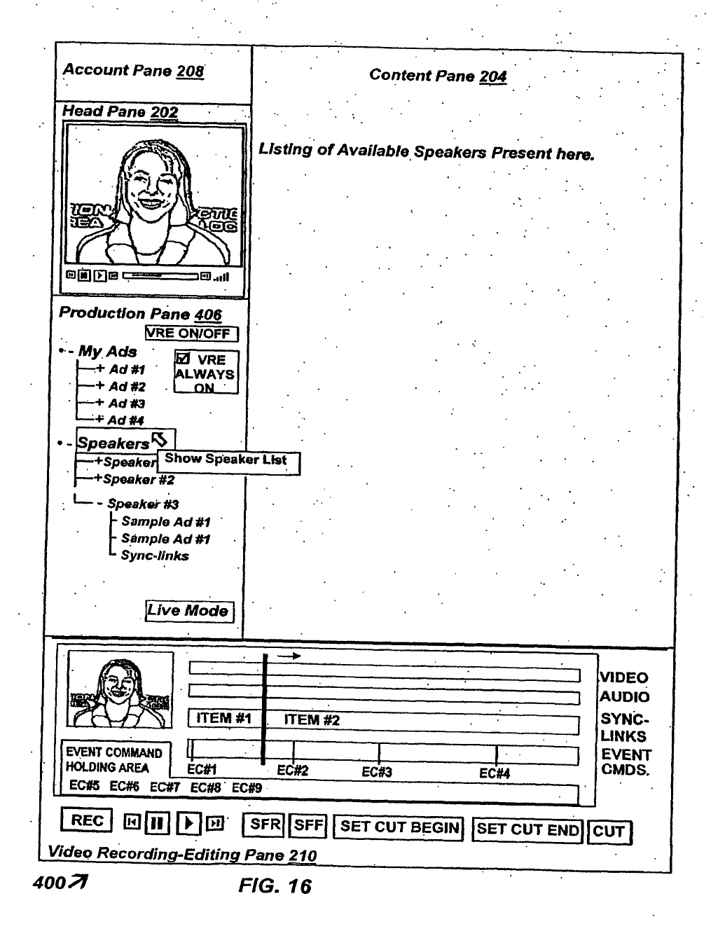

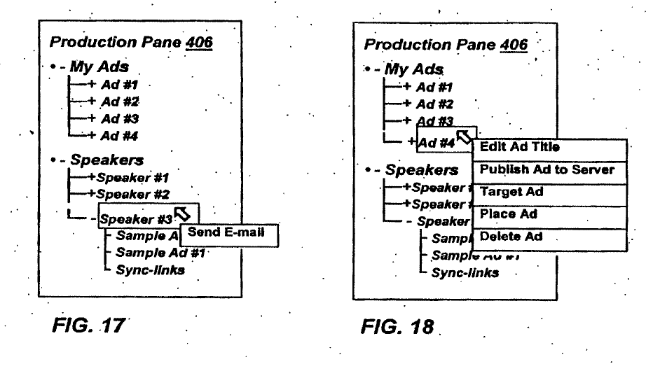

MetaAdvertiser. MetaAdvertiser 400, which is shown in FIG. 16, may be viewed as a modified version of MetaProducer 200. MetaAdvertiser 400 has the same head pane 202, content pane 204, and account pane 208 as MetaProducer 200, but has a production pane 406 in place of an aggregation pane 206. However, production pane 406 and aggregation pane 206 share many of the same functionalities, and mainly differ in the content of what is presented in their panes. In the production pane 406 of MetaAdvertiser 400, which is illustrated in FIG. 16, the advertiser is presented with two main nodes called “MyAds” and “Speakers,” instead of the subjects and focus nodes presented to the producer in aggregation pane 206. The MyAds node contains a directory listing of the advertiser's published ads, as well as those under development, and allows him or her to add a new Ad to the node in the same way the producer adds a new metacontent show to a subject node. Thus, the MyAds node has the same functionality as the subject node. The Speakers node contains a directory listing of all the speakers the advertiser has used previously in his or her ads. Each speaker is allocated a sub-node under the Speakers node. When the Speaker node is right-clicked a context menu appears offering a single choice, Show Speaker List, which displays a complete list of speakers in the Content Pane allowing advertisers to watch speaker auditions (This is illustrated in FIG. 16). These auditions are short metacontent shows or ads offering one or two sync-linked items. Once the advertiser has decided on a speaker, he or she drags and drops the speaker from the Speaker List to the Production Pane, where it appears as a new child node under the Speakers node. At this point, the advertiser can send a message to the speaker containing the prospective ad narrative requesting that the speaker produce a video based on the narrative and deliver it back to the advertiser. (The context menu for this is shown in FIG. 17.)

MetaAdvertiser 400 has the same features and functionality for creating Metacontent Ads as MetaProducer 200 has for creating Metacontent Shows, the principle difference being that the word “Ad” is used instead of “Show.” In addition, the Advertiser can go through the same steps to create a metacontent Ad as the producer does to create a metacontent show, with the exception that the Advertiser can have a spokesperson create the metacontent track. In this regard, MetaAdvertiser 400 can include an additional feature (and instruction set for product 450) to enable an advertiser to right-click on a Speaker's node to display a context menu, which provides the option to send the Speaker a message. This is shown in FIG. 17. With this feature, the Advertiser can contact the Speaker with a prospective text narrative for the Ad and a proposal for price and delivery. Speakers can be paid based on the number of times the advertisement is show, or a flat fee, or a combination of both approaches.

Once an advertiser obtains a metacontent track for the new ad, the advertiser can sync-link webpages to the metacontent track in the same way that a producer sync-links webpages to a new metacontent show. The webpages sync-linked to the ad can showcase aspects of a product or business, and can provide purchase information and links to the advertiser's website. Once a new metacontent ad is finished, MetaAdvertiser 400 provides the advertiser with the option to publish the new ad to the Advertisement Database of system 300, where it is kept so that it can be run on a basis determined by the advertiser. This feature of MetaAdvertiser 400 is shown in the context menu in FIG. 18, and is similar to the “Publish Show to Server” command feature of MetaProducer 200 (FIG. 13). The Metacontent Advertisement Database and Account Database and Controller of System 300 coordinate to associate the Advertiser's metacontent Ads with his or her account. In addition, context menu in FIG. 18 allows the advertiser to “Target the Ad,” and to “Place the Ad.” Choosing “Target the Ad” from an ad node's context menu displays the Target page in the Content Pane, allowing the advertiser to set the target consumer profile for the Ad. The target page, may for example, allow the Advertiser to set the Subjects and sub-subjects of the Consumers' directory in which the Ad will play, and to set the target audience parameters, which generally include age, gender, geographical location (e.g., zip code), and occupation. Once completed, the Advertiser clicks a “submit” button and the Target information is sent to a database of metacontent advertisements in system 300 to be stored along with the Ad. When the Ad is placed and run, System 300 distributes the Ad when the consumer's profile and the Subject/Sub-subject of the clicked story match the Ad's target profile. Choosing “Place the Ad” from an ad node's context menu (FIG. 18) launches a standard Shopping Cart experience in the Content Pane, preferably modified by the addition of a processing step to verify the Ad's target audience as done by the “Target the Ad” command, or to establish the Ad's target audience if it has not already be done using the “Target the Ad” command. The Ad is generally sold in lots of 1000 views, but additional numbers may be provided to the Advertiser for purchase.

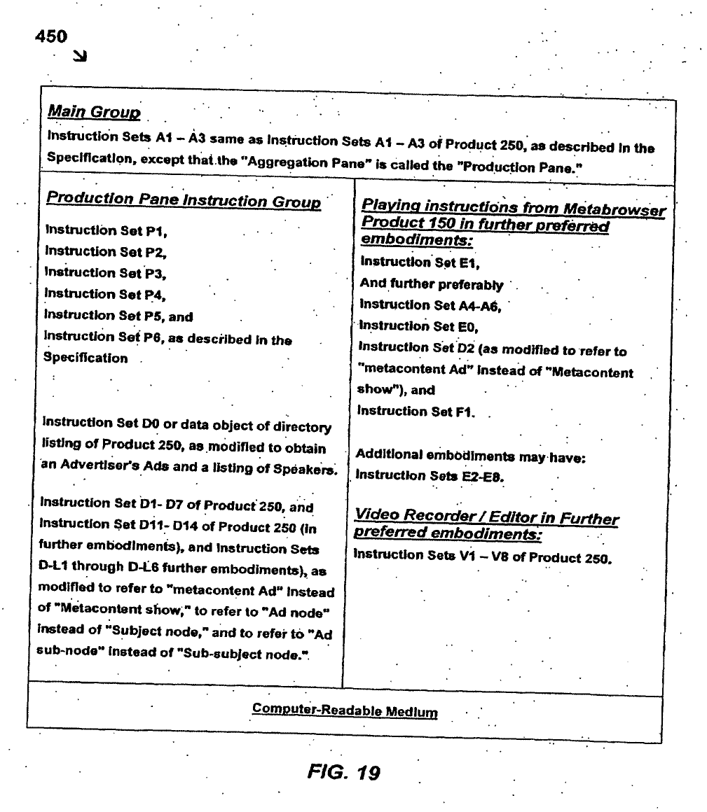

An exemplary computer program product 450 for MetaAdvertiser 400 is shown in FIG. 19. It has substantially the same instruction sets as Metaproducer Product 250, except that Instruction Sets D8-D10 are not needed, and has some instruction sets that are not found in Product 250. Product 450 comprises Instruction Sets A1-A3, which are the same as Instruction Sets A1-A3 of Product 250, as described in the Specification, except that the “Aggregation Pane” is called the “Production Pane.” Product 450 further comprises Instruction Set D0 or the data object of directory listing of Product 250, as modified to obtain an Advertiser's Ads and a listing of Speakers. Product 450 further comprises Instruction Sets D1-D7, of Product 250, and in further embodiments Instruction Sets D11-D14, and D-L1 through DL-6, of Product 250, all such Instruction Sets as modified to refer to “metacontent Ad” instead of “Metacontent show,” to refer to “Ad node” instead of “Subject node,” and to refer to “Ad sub-node” instead of “Sub-subject node.” Product 450 further comprises the following instruction Sets:
(P1) An interface control (e.g., instruction set) that directs data processor 50 to receive user input to view a list of available speakers in Content Pane 204, and in response send an request for the speakers list to a server, to receive the Speakers List from the server, and to display the Speakers List in Content Pane 204;
(P2) An interface control (e.g., instruction set) that directs data processor 50 to receive user input to copy, preferably via drag and drop, a selected available Speaker from the Speaker list displayed in Content Pane 204 to the Speakers node of Production Pane 406 as a new node under the Speakers node;
(P3) An interface control (e.g., instruction set) that directs data processor 50 to receive user input to send a text message to a selected speaker in the Speakers node, and in response provide a dialog box for the user to enter the text of that message and send it to the selected speaker;
(P4) An interface control (e.g., instruction set) that directs data processor 50 to receive user input to transmit a new metacontent ad to a database server and an instruction set to transmit the new metacontent ad to the database server (Modified Instruction D7);
(P5) An interface control (e.g., instruction set) that directs data processor 50 to receive user input to request from a server a webpage allowing the user to set the target consumer profile for a selected metacontent Ad, and to receive and display the requested webpage in Content Pane 204;
(P6) An interface control (e.g., instruction set) that directs data processor 50 to receive user input to request from a server a webpage allowing the user to place a selected metacontent ad in a stream of metacontent ads distributed by one or more servers to a plurality of consumers, and to receive and display the requested webpage in Content Pane 204.
   To obtain the listing for MyAds, product 450 may comprise a data object holding a directory listing of the user's metacontent advertisements present on a server or an instruction set adapted that directs the data processor to request and receive a directory listing of the user's metacontent advertisements from one or more network-accessible database servers. In a similar manner, to obtain the listing for the Speakers node, product 450 may comprise a data object holding a directory listing of the user's Speakers node present on a server or an instruction set adapted that directs the data processor to request and receive a directory listing of the user's Speaker node from one or more network-accessible database servers. These instruction sets can be constructed by those of ordinary skill in the software art without undue experimentation in view of the present disclosure. Further embodiments of Product 450 may include the VRE instruction sets V1-V8 of Product 250 for the Video Recorder/Editor, and the following instruction sets of Product 150 for the playing of metacontent shows: A4-A6, E1-D8, F1, and D2, where instruction Set D2 is modified to refer to “metacontent Ad” instead of “Metacontent show.”

MetaSpeaker 500, shown in FIG. 19, enables prospective speakers, generally people with appealing faces and voices, to produce and post sample and audition videos for metacontent advertisers and producers to evaluate, and to produce and deliver finished, publishable metacontent tracks for advertisers and producers. Using MetaSpeaker 500, speakers can submit samples containing a video narrative sync-linked to a Content page for subsequent display on the Speaker List, which is viewable in MetaAdvertiser 400 and MetaProducer 200.

MetaSpeaker 500 may be viewed as a modified version of MetaProducer 200. MetaSpeaker 500 has the same head pane 202, content pane 204, account pane 208, and optionally VRE pane 210 as MetaProducer 200, but has an audition pane 506 in place of an aggregation pane 206. However, audition pane 506 and aggregation pane 206 share many of the same functionalities, and mainly differ in the content presented in their panes. In audition pane 506 of MetaSpeaker 500, the speaker is presented with three main nodes called “My Samples,” “My Auditions,” and “MyAds” instead of the subjects and focus nodes presented to the producer in aggregation pane 206. A Speaker may place audition samples and/or actual ads that he or she has produced in the “MySamples” node, which is made available to advertisers and producers through the Speaker nodes in MetaAdvertiser 400 and MetaProducer 200, respectively. In typical embodiments, a speaker can place a finite number of sample ads and auditions (e.g., generally a total of five) in this node, and move them around to provide a desired order (ranking). Actual ads employing the speaker may be added to the MySample node by dragging them up from the MyAds node and dropping them into the MySample node. The MyAuditions node contains a directory listing of the speaker's auditions for an advertiser, and allows the speaker to add a new audition to the node in the same way the producer adds a new metacontent show to a subject node in MetaProducer 200. Thus, the MyAuditions node has the same functionality as the subject node. Generally, the speaker provides an advertiser with an audition in response to a request for work from the advertiser. Once the speaker finishes the audition, he can provide it to the advertiser with a publishing command in MetaSpeaker 500. Once an audition is actually used in an Ad by an Advertiser, it is displayed in the Speaker's MyAds node; this is generally the way the MyAds node is populated. The Speaker can click on the MyAds node to expand it to show a list of the Ads. Clicking on and Ad node results in the display of current data regarding the Ad in the Content Pane, which generally includes how many views it has received, and how many click-throughs (i.e., the number of times users have clicked the hyperlinks in the Ad's content pane), and how much compensation is due to the Speaker if the Speaker and Advertiser have previously agreed to compensate the Speaker based on the number of ad views. This information is tracked by System 300 and provided to the Speaker as a webpage downloaded from System 300.

MetaSpeaker 500 has the same features and functionality for creating metacontent tracks as MetaProducer 200 has for creating metacontent tracks, the principle difference being that the tracks are called auditions in the case of speakers and later become part of metacontent ads if used by an advertiser, whereas in Metaproducer the tracks become part of metacontent shows. In addition, the Speaker can go through the same steps to create a new audition under the MyAuditions Node as the producer does to create a new track.

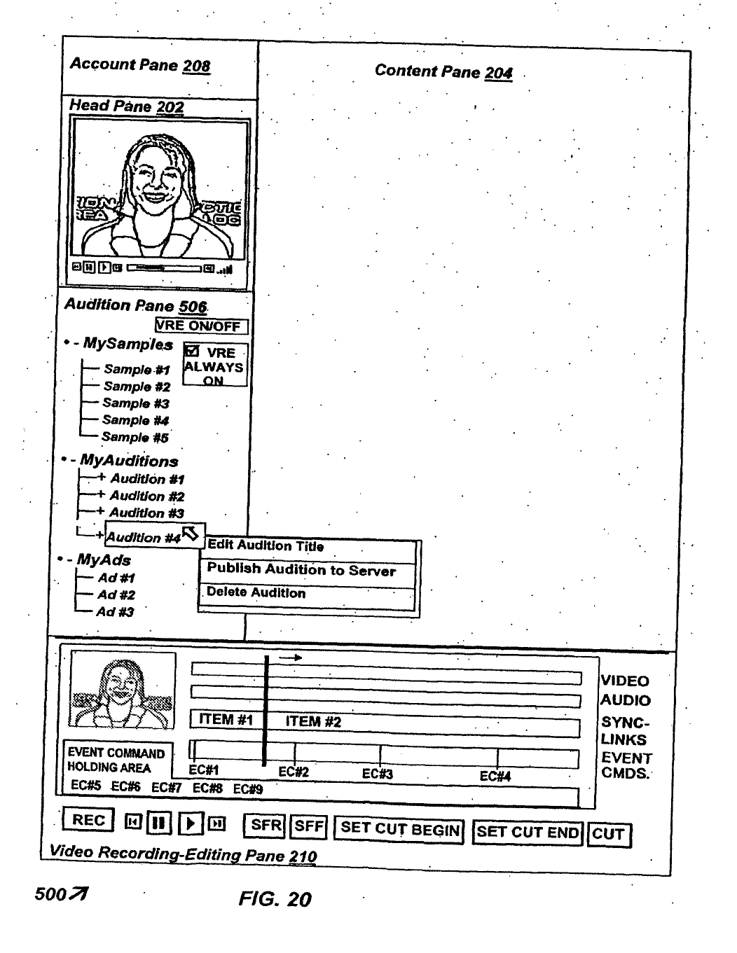

Once a new metacontent audition is finished, MetaSpeaker 500 provides the speaker with the option to publish the new audition to the server (e.g., system 300), which stores the new audition as a corresponding MyAuditions node for the speaker in System 300's data base for Speaker Auditions. System 300 provides the speaker with the ability to grant rights to an advertiser to view particular auditions in the speaker's MyAuditions node. The publication feature of MetaSpeaker 500 is shown in the context menu in FIG. 20, and is similar to the “Publish Show to Server” command feature of MetaProducer 200 (FIG. 13). The Metacontent Speaker Samples Database and Account Database and Controller of System 300 coordinate to associate the Speaker's metacontent auditions and samples with his or her account.

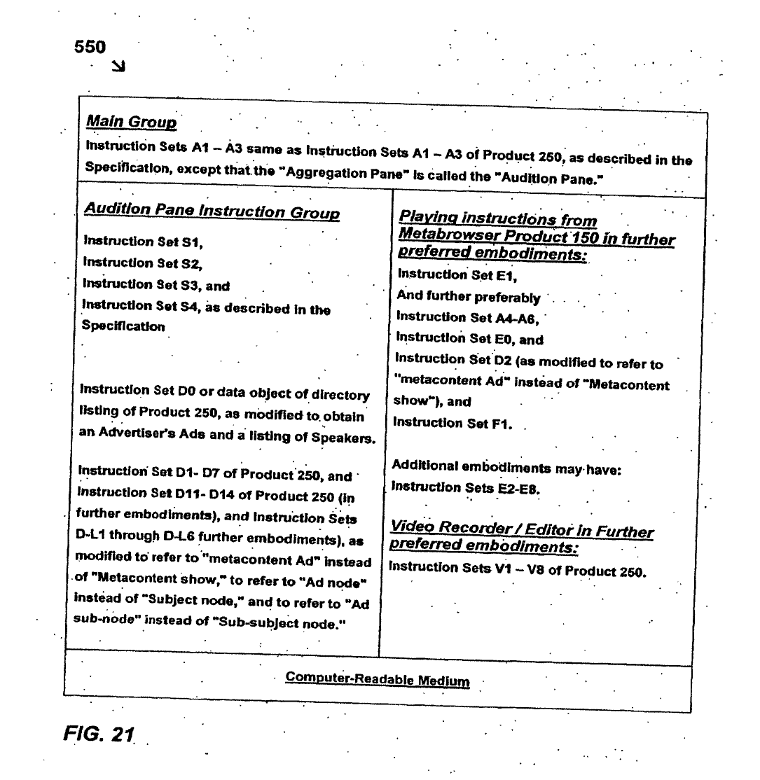

An exemplary computer program product 550 for MetaSpeaker 500 is shown in FIG. 21. It has substantially the same instruction sets as Metaproducer Product 250, except that Instruction Sets D8-D10 are not needed, and has some instruction sets that are not found in Product 250. Product 550 comprises Instruction Sets A1-A3, which are the same as Instruction Sets A1-A3 of Product 250, as described above, except that the “Aggregation Pane” is called the “Audition Pane.” Product 550 further comprises Instruction Set D0 or the data object of directory listing of Product 250, as modified to obtain a speaker's auditions and samples. Product 550 further comprises Instruction Set D1-D7 of Product 250, and in further embodiments Instruction Sets D11-D14, and D-L1 through DL-6, of Product 250, all such Instruction Sets as modified to refer to “metacontent sample” instead of “metacontent show,” to refer to “MySamples node” instead of “Subject node,” and to refer to “MySamples sub-node” instead of “Sub-subject node.” This enables a speaker to create new Samples that have information items Sync-linked to metacontent tracks in the same way that producers create metacontent shows. Product 550 further comprises the following instruction Sets:
(S1) An interface control (e.g., instruction set) that directs data processor 50 to receive user input to copy a selected audition in the MyAuditions node to the MySamples node, and in response send an request to a server to make the requested copy and to update the display of the MySamples node;
(S2) An interface control (e.g., instruction set) that directs data processor 50 to receive user input to copy a selected ad in the MyAds node to the MySamples node, and in response send an request to a server to make the requested copy and to update the display of the MySamples node;
(S3) An interface control (e.g., instruction set) that directs data processor 50 to receive user input to transmit a new metacontent audition to a database server and an instruction set to transmit the new metacontent audition to the database server, the interface control including the option to grant a selected advertiser permission to view the new metacontent audition (Modified Instruction D7);
(S4) An interface control (e.g., instruction set) that directs data processor 50 to receive user input to request from a server a webpage providing the user with current data regarding the usage of a selected ad, the selected Ad being selected by the user from the MyAds node.
   To obtain the listing for MyAds, product 550 may comprise a data object holding a directory listing of the user's metacontent advertisements present on a server or an instruction set adapted that directs the data processor to request and receive a directory listing of the speaker's metacontent advertisements from one or more network-accessible database servers. In a similar manner, to obtain the listing for the MySamples node, product 550 may comprise a data object holding a directory listing of the user's Speakers node present on a server or an instruction set adapted that directs the data processor to request and receive a directory listing of the user's Speaker node from one or more network-accessible database servers. These instruction sets can be constructed by those of ordinary skill in the software art without undue experimentation in view of the present disclosure. Further embodiments of Product 550 may include the VRE instruction sets V1-V8 of Product 250 for the Video Recorder/Editor, and the following instruction sets of Product 150 for the playing of metacontent shows: A4-A6, E1-D8, F1, and D2, where instruction Set D2 is modified to refer to “metacontent audition” instead of “metacontent show.”

Account Panes. The account panes 108 and 208 may be implemented by conventional interface controls that direct a processor to receive user inputs to login and to logout, and to in response direct the Internet browser to request and load corresponding web pages from system 300 that enable users to perform these functions. When logged in, users are allowed access to their personal account data, producers are allowed to publish metacontent shows, advertisers are allowed to publish, target, and place metacontent ads, and speakers are allowed to publish auditions, make samples available, etc.

Methods of the present application. It may be appreciated that System 300 and components 10, 100, 200, 400, and 500 enable a broad range of methods to be practices. One exemplary method comprises providing access to a website where producers can produce and post metacontent shows, and providing an organizational structure of subjects (e.g., topics) and sub-subjects (e.g., subtopics) within and to which metacontent shows can be posted by producers. The exemplary method may further comprise providing consumers with access to metacontent shows where the organizational structure of subjects and sub-subjects can be viewed in a first pane of a video screen, where the metacontent track of a selected show is presented in a second pane of the video screen, and where each show's item of network-accessible information is presented in a third pane of the video screen when the playing time of the show's metacontent track is at or within the corresponding temporal location of the item. Further exemplary methods of this invention further comprise providing producers with the ability to create web pages on which they can aggregate items and other information, and to refer to these web pages as items in their metacontent shows. Yet further exemplary methods of this invention further comprise presenting metacontent advertisements to consumers, collecting revenues from the presentation of the advertisements, and distributing portions of the revenues to the producers and speakers.

Additional methods are provided in the presentation of information and options done by each of Metabrowser 100, Metaproducer 200, Metaadvertiser 400, and Metaspeaker 500.

While the present inventions have been particularly described with respect to the illustrated embodiments, it will be appreciated that various alterations, modifications and adaptations may be made based on the present disclosure, and are intended to be within the scope of the present inventions. While the inventions have been described in connection with what are presently considered to be the most practical and preferred embodiments, it is to be understood that the present inventions are not limited to the disclosed embodiments but, on the contrary, is intended to cover various modifications and equivalent arrangements included within the scope of the appended claims.

1. A Metabrowser for presenting metacontent to a user, the metabrowser comprising: a first instruction set embodied on a computer-readable medium adapted to direct a data processor to present a directory pane on a video screen, the directory pane adapted to display a plurality of subjects having a plurality of metacontent shows from which the user may select for presentation, and to receive a selection by the user of a metacontent show to view, each metacontent show comprising a playing span and a metacontent track, the metacontent track comprising at least one of an audio track, a video track, or both, one or more identifiers to one or more corresponding items of network-accessible information being associated or embedded within the metacontent show, each item to be displayed to the user at a corresponding location in the playing span of the metacontent track, each identifier facilitating access to its corresponding item of network-accessible information; a second instruction set embodied on the computer-readable medium adapted to direct a data processor to present a head pane on the video screen, the head pane adapted to present the metacontent track of a selected metacontent show to the user; and a third instruction set embodied on the computer-readable medium adapted to direct a data processor to present a content pane on the video screen, the content pane adapted to present to the user the contents of the metacontent show's corresponding one or more items of network-accessible information, the contents of each item being presented when the playing time of the show's metacontent track is at or within the corresponding location of the item; and
wherein one of the above instruction sets is further adapted to direct the data processor to overlay at least a portion of one of the panes over at least a portion of one of the other panes.

2. The Metabrowser of claim 1 wherein the second instruction set is further adapted to direct the data processor to overlay at least a portion of the head pane over at least a portion of one of the other panes.

3. The Metabrowser of claim 1 further comprising an instruction set adapted to direct the data processor to change at least one characteristic of at least one pane, a characteristic being one of the position of the pane, the size of the pane, the layer level of the pane relative to other panes, and the translucency of the pane.

4. The Metabrowser of claim 1 wherein the metacontent show further comprises a set of event commands for configuring characteristics of one or more identified panes during the playing of the show's metacontent track, at least one event command specifying at least one of the position, size, overlay layer level, and translucency of a selected pane, wherein the product further comprises: a fourth instruction set adapted to direct the data processor to read an event command of the metacontent show and to configure the characteristics of the pane identified by an event command according to the characteristics specified by the event command.

6. The Metabrowser of claim 1 wherein the metacontent show further comprises a set of event commands for configuring characteristics of one or more panes during the playing of the show's metacontent track, at least one event command specifying that the metacontent track be paused for a time duration, wherein the product further comprises: a fourth instruction set adapted to direct the data processor to read an event command of the metacontent show and to pause the playing of the metacontent track of the pane identified by an event command that specifies such a pausing action.

7-35. (canceled)

36. A method of presenting metacontent to a user, the method comprising: (a) presenting to the user a plurality of subjects each having a plurality of metacontent shows from which the user may select for presentation, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information; (b) receiving a request from the user to select a metacontent show for presentation; (c) presenting to the user the metacontent track of the selected metacontent show in a head pane disposed in an area of a video screen; and (d) presenting to the user the contents of the metacontent show's corresponding one or more items of network-accessible information in a content pane disposed in an area of the video screen, the contents of each item being presented when the playing time of the show's metacontent track is at or within the corresponding location of the item; and wherein at least one of steps (c)-(d) overlays at least a portion of its pane over at least a portion of the other pane.

37. The method of claim 36 wherein at least a portion of the head pane overlays at least a portion of one of the other panes.

38. The method of claim 36 wherein to at least one characteristic of at least one pane is changed during the presentation of a metacontent show, a characteristic being one of the position of the pane, the size of the pane, the layer level of the pane relative to other panes, and the translucency of the pane.

39. The method of claim 36 further comprising displaying an overlay pane during a metacontent show for a period of time.

40. The method of claim 36 further comprising displaying a representation of the contents of a selected subject in the content pane in response to a user input.

48. A metaproducer for enabling a user to create metacontent shows, the metaproducer comprising the following components embodied on a computer-readable medium: (a) an instruction set adapted to direct a data processor to present an aggregation pane on a video screen, the aggregation pane adapted to display a plurality of subjects to which the user can add new metacontent shows, each metacontent show comprising a playing span and a metacontent track within the playing span, the metacontent track comprising at least one of an audio track, a video track, or both, one or more identifiers to one or more corresponding items of network-accessible information being associated or embedded within the metacontent track, each item to be displayed to the user at a corresponding location in the playing span of the metacontent track when the show is presented, each identifier facilitating access to its corresponding item of network-accessible information; (b) an instruction set adapted to direct the data processor to present a head pane on the video screen, the head pane adapted to present the metacontent track associated with the new metacontent show; (c) an instruction set adapted to direct the data processor to present a content pane on the video screen, the content pane adapted to present the contents of items of network-accessible information; (d) an instruction set adapted to direct a data processor to receive user input to add a new metacontent show to a selected subject; (e) an instruction set adapted to direct a data processor to receive user input to associate a textual description to the new metacontent show; (f) an instruction set adapted to direct a data processor to receive user input to associate a metacontent track to the new metacontent show; (g) an instruction set adapted to direct a data processor to receive user input of one or more corresponding items of network-accessible information that are to be associated to the new metacontent show, the association including an identifier for each item that facilitates access to the contents of the item over a network; (h) an instruction set adapted to direct a data processor to receive user input to associate a selected item of network-accessible information of the new metacontent show with a selected location in the metacontent track; and (i) an instruction set adapted to direct a data processor to receive user input to associate one or more event commands to the new metacontent show, at least one event command providing a value for at least one characteristic of a pane that will be used to display the new metacontent show when it is played, the at least one characteristic being one of the position of the pane, the size of the pane, the layer level of the pane relative to other panes, and the translucency of the pane.

49. The metaproducer of claim 48 wherein instruction set (i) is further adapted to direct a data process or receive a user input to associate to the new metacontent show an event command for pausing the playing of the metacontent track at a selected time point in the playing of the metacontent track.

50. The metaproducer of claim 49 wherein instruction set (i) is further adapted to direct a data process to receive a user input for at least one of: (1) a time duration for the pause event command, and (2) a software restart object specifying the conditions on which the playing of the metatcontent track is to be restarted.

51. The metaproducer of claim 48 wherein instruction set (i) is further adapted to direct a data process or receive a user input to associate to the new metacontent show an event command for displaying an overlay pane during a selected playing time of the metacontent show, and to receive a software object specifying the contents of the overlay pane.

52. The metaproducer of claim 48 further comprising: (j) an interface<*> control adapted to direct the data processor to receive user input to transmit a new metacontent show to a database server and an instruction set to transmit the new metacontent show to the database server.

53-149. (canceled)
